(19) United States
(12) Patent Application Publication
(10) Pub. No.: US 2015/0003809 A1
(43) Pub. Date: Jan. 1, 2015

(54) CONTENT RECEIVING DEVICE, CONTENT RECEIVING METHOD AND DIGITAL BROADCAST TRANSMITTING AND RECEIVING SYSTEM

(71) Applicants: Masayuki Matsuda, Tokyo (JP); Takashi Toyomura, Tokyo (JP); Takatoshi Shirosugi, Tokyo (JP); Shinichi Murakami, Tokyo (JP); Shinichi Obata, Tokyo (JP)

(72) Inventors: Masayuki Matsuda, Tokyo (JP); Takashi Toyomura, Tokyo (JP); Takatoshi Shirosugi, Tokyo (JP); Shinichi Murakami, Tokyo (JP); Shinichi Obata, Tokyo (JP)

(21) Appl. No.: 14/373,412

(22) PCT Filed: Feb. 1, 2012
(86) PCT No.: PCT/JP2012/000654

§ 371 Date: Jul. 21, 2014

(51) Int. Cl. G11B 27/28; G11B 27/10; G06K 9/00; H04N 5/91; H04N 9/80

(52) U.S. Cl. CPC G11B 27/28; H04N 5/91; H04N 9/80; G06K 9/00268; G11B 27/105
USPC 386/248

(57) ABSTRACT

Provided is a technology related to digital broadcast that effectively uses metadata.

A content receiving device for receiving broadcast waves includes: a receiving unit which receives the broadcast waves; an input unit which inputs a user input; a recording unit which records content included in the broadcast waves on a recording medium; and a control unit, and in the content receiving device, character facial data to be information enabling identification of faces of characters of the content is included in the broadcast waves, and the control unit generates searching facial data to be information enabling identification of faces of persons, on the basis of information input to the input unit, and controls recording of the content on the recording medium, on the basis of the searching facial data and the character facial data.

### TECHNICAL FIELD

The present invention relates to a content receiving device, a content receiving method, and a digital broadcast transmitting and receiving system.

### BACKGROUND ART

In the related art, as described in PTL 1, when a variety of information of units of segments are transmitted, a plurality of segments is collectively processed and is transmitted and any segment is selected from received signals and is demodulated at a receiver side.

### CITATION LIST

### Patent Literature

PTL 1: JP 2000-216748 A

### SUMMARY OF INVENTION

### Technical Problem

PTL 1 describes that a variety of information are transmitted in units of segments at a transmission side and any segment is selected therefrom and is demodulated at a reception side.

However, PTL 1 does not describe an information association between segments in which a variety of information of a plurality of segment units is associated and transmitted and the segments are selected and demodulated according to an association at the receiver side. In addition, PTL 1 does not mention the possibility of the service effectively using metadata in a system for performing an accumulation type content distribution, assuming the information association.

The invention has been made in view of the above-described circumstances and an object of the invention is to provide a technology related to digital broadcast effectively using metadata.

### Solution to Problem

In order to resolve the above-described problems, for example, configurations described in claims are adopted. The present application is a content receiving device for receiving broadcast waves, including: a receiving unit which receives the broadcast waves; an input unit which inputs a user input; a recording unit which records content included in the broadcast waves on a recording medium; and a control unit, wherein character facial data to be information enabling identification of faces of characters of the content is included in the broadcast waves, and the control unit generates searching facial data to be information enabling identification of faces of persons, on the basis of information input to the input unit, and controls recording of the content on the recording medium, on the basis of the searching facial data and the character facial data.

### Advantageous Effects of Invention

According to the invention, a technology related to digital broadcast effectively using metadata can be provided.

### BRIEF DESCRIPTION OF DRAWINGS

FIG. 1 is a block diagram illustrating a configuration of a digital broadcast transmitting and receiving system according to a first embodiment of the present invention.

FIG. 2 is a block diagram illustrating a configuration of a digital broadcast transmitting device according to the first embodiment of the present invention.

FIG. 3 is a block diagram illustrating a configuration of multimedia signal generation according to the first embodiment of the present invention.

FIGS. 4(a) and 4(b) are diagrams illustrating an embodiment of a segment configuration of a digital broadcast transmission signal transmitted by a digital broadcast transmitting device according to the present invention.

FIG. 5 is a diagram illustrating an embodiment of a segment configuration of a digital broadcast transmission signal transmitted by a digital broadcast transmitting device according to the present invention.

FIG. 6 is a block diagram illustrating configurations of modulating/encoding units 212 and 222 to be main blocks according to the present invention.

FIG. 7 is a block diagram illustrating, configurations of frame configuring units 214 and 224 to be main blocks according to the present invention.

FIG. 8 is a diagram illustrating a frame configuration of a digital broadcast transmission signal transmitted by a digital broadcast transmitting device according to the present invention.

FIG. 9 is a diagram illustrating a TMCC signal configured by a TMCC signal configuring unit 603 to be a main block according to the present invention.

FIG. 10 is a diagram illustrating a TMCC signal configured by a TMCC signal configuring unit 603 to be a main block according to the present invention.

FIG. 11 is a diagram illustrating a TMCC signal configured by a TMCC signal configuring unit 603 to be a main block according to the present invention.

FIG. 12 is a diagram illustrating a TMCC signal configured by a TMCC signal configuring unit 603 to be a main block according to the present invention.

FIG. 13 is a diagram illustrating a TMCC signal configured by a TMCC signal configuring unit 603 to be a main block according to the present invention.

FIG. 14 is a diagram illustrating a TMCC signal configured by a TMCC signal configuring unit 603 to be a main block according to the present invention.

FIG. 15 is a diagram illustrating a TMCC signal configured by a TMCC signal configuring unit 603 to be a main block according to the present invention.

FIG. 16 is a diagram illustrating an embodiment of a service configuration of a digital broadcast transmission signal transmitted by a digital broadcast transmitting device according to the present invention.

FIGS. 17(a) and 17(b) are diagrams illustrating an embodiment of a segment configuration of a digital broadcast transmission signal transmitted by a digital broadcast transmitting device according to the present invention.

FIGS. 18(a) to 18(c) are diagrams illustrating an embodiment of pilot information of a digital broadcast transmission signal transmitted by a digital broadcast transmitting device according to the present invention.

FIG. 19 is a block diagram illustrating a configuration of a digital broadcast receiving device according to a second embodiment of the present invention.

FIG. 20 is a diagram illustrating a digital broadcast transmission signal received by a digital broadcast receiving device according to the present invention.

FIG. 21 is a block diagram illustrating a configuration of a demodulating/decoding unit 1905 to be a main block according to the present invention.

FIG. 22 is a block diagram illustrating another configuration of the demodulating/decoding unit 1905 to be the main block according to the present invention.

FIG. 23 is a flowchart illustrating a reception operation of a digital broadcast receiving device according to the present invention.

FIG. 24 is a diagram illustrating a reception operation of a digital broadcast receiving device according to the present invention.

FIGS. 25(a) to 25(c) are diagrams illustrating a reception operation of a digital broadcast receiving device according to the present invention.

FIG. 26 is a diagram illustrating an embodiment of a service configuration of a digital broadcast transmission signal transmitted by a digital broadcast transmitting device according to a third embodiment of the present invention.

FIGS. 27(a) and 27(b) are diagrams illustrating an embodiment of a segment configuration of a digital broadcast transmission signal transmitted by a digital broadcast transmitting device according to the present invention.

FIGS. 28(a) to 28(c) are diagrams illustrating an embodiment of pilot information of a digital broadcast transmission signal transmitted by a digital broadcast transmitting device according to the present invention.

FIG. 29 is a flowchart illustrating a reception operation of a digital broadcast receiving device according to a fourth embodiment of the present invention.

FIG. 30(a) is a diagram illustrating a reception operation of a digital broadcast receiving device according to the present invention.

FIG. 30(b) is a diagram illustrating a reception operation of a digital broadcast receiving device according to the present invention.

FIG. 31 is a diagram illustrating an embodiment of a service configuration of a digital broadcast transmission signal transmitted by a digital broadcast transmitting device according to a fifth embodiment of the present invention.

FIG. 32 is a diagram illustrating an embodiment of a segment configuration of a digital broadcast transmission signal transmitted by a digital broadcast transmitting device according to the present invention.

FIG. 33 is a diagram illustrating an embodiment of pilot information of a digital broadcast transmission signal transmitted by a digital broadcast transmitting device according to the present invention.

FIG. 34 is a flowchart illustrating a reception operation of a digital broadcast receiving device according to a sixth embodiment of the present invention.

FIG. 35 is a diagram illustrating a reception operation of a digital broadcast receiving device according to the present invention.

FIG. 36 is a diagram illustrating an embodiment of pilot information of a digital broadcast transmission signal transmitted by a digital broadcast transmitting device according to a seventh embodiment of the present invention.

FIG. 37 is a flowchart illustrating a reception operation of a digital broadcast receiving device according to an eighth embodiment of the present invention.

FIGS. 38(a) and 38(b) are diagrams illustrating an embodiment of a segment configuration of a digital broadcast transmission signal transmitted by a digital broadcast transmitting device according to a ninth embodiment of the present invention.

FIG. 39 is a diagram illustrating an embodiment of pilot information of a digital broadcast transmission signal transmitted by a digital broadcast transmitting device according to the present invention.

FIG. 40(a) is a diagram illustrating an embodiment of pilot information of a digital broadcast transmission signal transmitted by a digital broadcast transmitting device according to the present invention.

FIG. 40(b) is a diagram illustrating an embodiment of pilot information of a digital broadcast transmission signal transmitted by a digital broadcast transmitting device according to the present invention.

FIG. 41 is a diagram illustrating another embodiment of a segment configuration of a digital broadcast transmission signal transmitted by a digital broadcast transmitting device according to the present invention.

FIG. 42 is a block diagram illustrating an example of a configuration of multimedia signal generation according to the first embodiment of the present invention.

FIG. 43 is a flowchart illustrating a reception operation of a digital broadcast receiving device according to the present invention.

FIG. 44 is a flowchart of another example illustrating a reception operation of a digital broadcast receiving device according to the present invention.

FIG. 45 is a diagram illustrating an example of a process flow until accumulation type broadcast content is carried on a broadcast TS, in a transmission operation of a digital broadcast transmitting device according to the present invention.

FIG. 46 is a diagram illustrating an example of a process flow until accumulation type broadcast content is extracted from a broadcast TS, in a reception operation of a digital broadcast receiving device according to the present invention.

FIG. 47 is a diagram illustrating a screen display example of the case of extracting a region of a person from a temporary stop screen of video, in a digital broadcast receiving device according to the present invention.

FIG. 48 is a diagram illustrating a configuration example of a searching facial data management table in a digital broadcast receiving device according to the present invention.

FIG. 49 is a diagram illustrating an example of internal components of transmitted character facial data, in a transmission operation of a digital broadcast transmitting device according to the present invention.

FIG. 50 is a diagram illustrating an example of the case of making an accumulation reservation using searching facial data and character facial data, in a digital broadcast receiving device according to the present invention.

FIG. 51 is a diagram illustrating a configuration example of an accumulation reservation management table in a digital broadcast receiving device according to the present invention.

FIG. 52 is a diagram illustrating a display example of a distribution scheduled content list when an accumulation reservation of content in which character facial data exists is made using searching facial data in a digital broadcast receiving device according to the present invention.

FIG. 53 is a diagram illustrating a configuration example of an accumulation content management table when content in which character facial data exists is accumulated using searching facial data in a digital broadcast receiving device according to the present invention.

FIG. 54 is a diagram illustrating a display example of an accumulation content list when content in which character facial data exists is accumulated using searching facial data in a digital broadcast receiving device according to the present invention.

FIG. 55 is a diagram illustrating a relation of searching facial data and a searching facial data management table in a digital broadcast receiving device according to the present invention.

FIG. 56 is a diagram illustrating an example of a process for converting character metadata as accumulation type content into a file, in a transmission operation of a digital broadcast transmitting device according to the present invention.

FIG. 57 is a diagram illustrating an example of internal components of transmitted character metadata, in a transmission operation of a digital broadcast transmitting device according to the present invention.

FIG. 58 is a diagram illustrating a configuration example of an accumulation content management table when content is accumulated in a digital broadcast receiving device according to the present invention.

FIG. 59 is a diagram illustrating a display example of the case of registering searching facial data when a user searches content, in a digital broadcast receiving device according to the present invention.

FIG. 60 is a diagram illustrating an example of the case of extracting specific content from accumulation completed content using searching facial data and character facial data, in a digital broadcast receiving device according to the present invention.

### DESCRIPTION OF EMBODIMENTS

Hereinafter, embodiments of the present invention will be described in detail with reference to the drawings. In the drawings, same reference numerals refer to same or corresponding portions. In addition, the present invention is not limited to examples illustrated in the drawings.

### First Embodiment

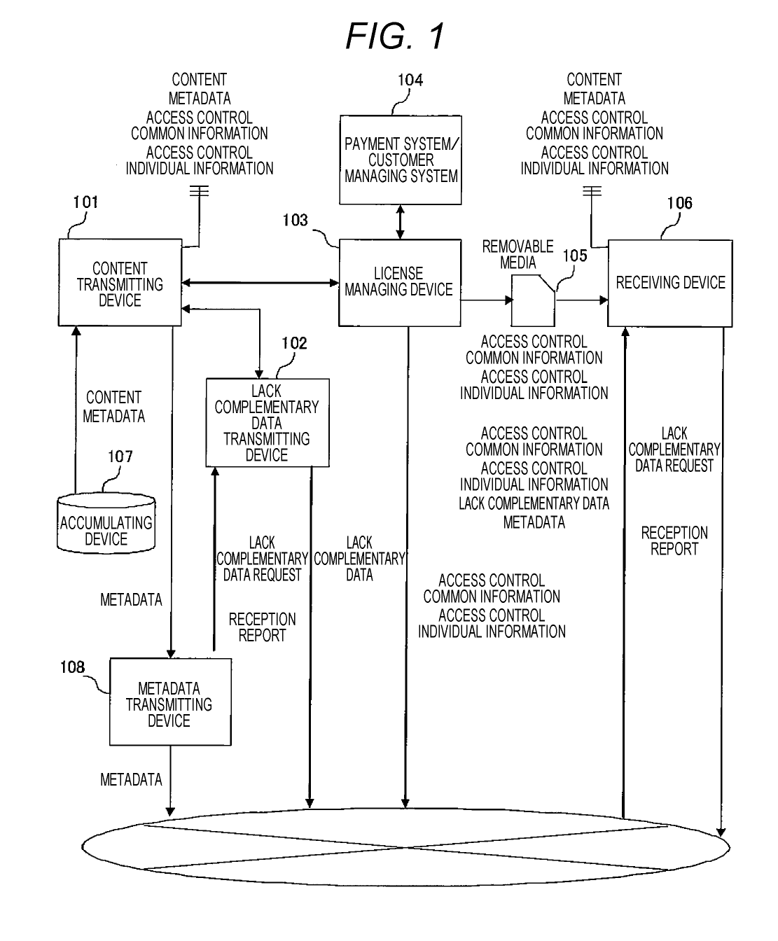

FIG. 1 is a block diagram illustrating a system configuration of a digital broadcast distribution in a first embodiment of the present invention. 101 denotes a content transmitting device, 102 denotes a lack complementary data transmitting device, 103 denotes a license managing device, 104 denotes a payment system/customer managing system, 105 denotes removable media, 106 denotes a receiving device, 107 denotes an accumulating device, and 108 denotes a metadata transmitting device.

Distributed content and metadata in which information regarding the content is stored are stored in the accumulating device 107 and are registered in the content transmitting device 101 for a distribution. The registered content and metadata are transmitted from the content transmitting device 101 through a broadcast wave, together with access control common information and access control individual information. The metadata may be transmitted from the metadata transmitting device 108 through communication as well as the broadcast wave.

Information regarding viewing possibility or impossibility is managed by the license managing device 103 and the payment system/customer managing system 104 and the access control common information and the access control individual information are supplied to the content transmitting device 101. The access control common information and the access control individual information may be transmitted from the content transmitting device 101 through the broadcast wave and may be distributed from the license managing device 103 through the communication. In addition, in the content transmitting device 101, the access control common information and the access control individual information may be stored in the removable media 105 and may be directly delivered or may be sold through a store to be delivered to a user.

The lack complementary data transmitting device 102 has a function of transmitting data to restore the lack, in the case in which the content distributed by the broadcast wave has the lack when the receiving device 106 receives the content. The lack complementary data transmitting device 102 transmits the lack complementary data through the communication, according to a lack complementary data request from the receiving device 106. After the reception of the lack complementary data is completed, the receiving device 106 transmits a reception report to the lack complementary data transmitting device.

In FIG. 1, all of the content transmitting device 101, the lack complementary data transmitting device 102, the license managing device 103, the payment system/customer managing system 104, the accumulating device 107, and the metadata transmitting device 108 are described as separate devices. However, a device having a plurality of functions may be provided and the present invention is not limited to a configuration of FIG. 1.

In the digital broadcast according to the present invention, real-time broadcast and push-cast broadcast are distributed. The real-time broadcast is a streaming type distribution and is a service for reproducing content of a broadcast wave while receiving the broadcast wave. Meanwhile, the push-cast broadcast is a download type distribution and is a service for reproducing content of a broadcast wave at any timing after the broadcast wave is received.

In the case of the real-time broadcast, the content transmitting device 101 transmits all of the content, the metadata, the access control common information, and the access control individual information through the broadcast wave. The content transmitting device 101 previously acquires the access control common information and the access control individual information from the license managing device 103 to transmit the access control common information and the access control individual information. The receiving device 106 separates/extracts the content, the metadata, the access control common information, and the access control individual information from the broadcast wave and decodes the content using the acquired access control common information and access control individual information.

In addition, the access control individual information does not need to be transmitted in the case of free broadcast or the like.

In addition, the access control individual information may be distributed from the license managing device 103 through a network or the removable media 105, from the viewpoint of effectively using a broadcast band. In this case, the receiving device 106 needs to obtain the access control individual information in advance before receiving the content.

In the case of the push-cast broadcast, the content transmitting device 101 transmits all of the content, the metadata, the access control common information, and the access control individual information through the broadcast wave. The content transmitting device 101 previously acquires the access control common information and the access control individual information from the license managing device 103 to transmit the access control common information and the access control individual information. The receiving device 106 separates/extracts the content, the metadata, the access control common information, and the access control individual information from the broadcast wave and decodes the content using the acquired access control common information and access control individual information.

In addition, the access control individual information does not need to be transmitted in the case of the free broadcast or the like.

In addition, in the case of the push-cast broadcast, because the reception and the reproduction of the content are separated in time, the metadata, the access control common information, and the access control individual information do not need to be transmitted through the broadcast wave at the same time as the content. The metadata may be distributed from the metadata transmitting device 108 through the network. The access control common information and the access control individual information may be distributed from the license managing device 103 through the network or the removable media 105. The receiving device 106 needs to obtain the access control individual information through the network or the removable media 105 until the content is reproduced.

In addition, because the reception and the reproduction of the content are separated in time, the content transmitting device 101 may repetitively transmit specific content several times in a certain time zone.

When the content received by the receiving device 106 through the broadcast wave has a lack, the lack complementary data may be transmitted to restore the content accumulated in the receiving device 106. When the receiving device 106 determines that the accumulated content has a lack, the receiving device 106 transmits a lack complementary data request to the lack complementary data transmitting device 102 through the network. The lack complementary data transmitting device 102 transmits the lack complementary data to the receiving device 106 through the network, according to the lack complementary data request. The receiving device 106 receives the lack complementary data, attempts to restore the accumulated content, and transmits a reception report to the lack complementary data transmitting device 102 through the network.

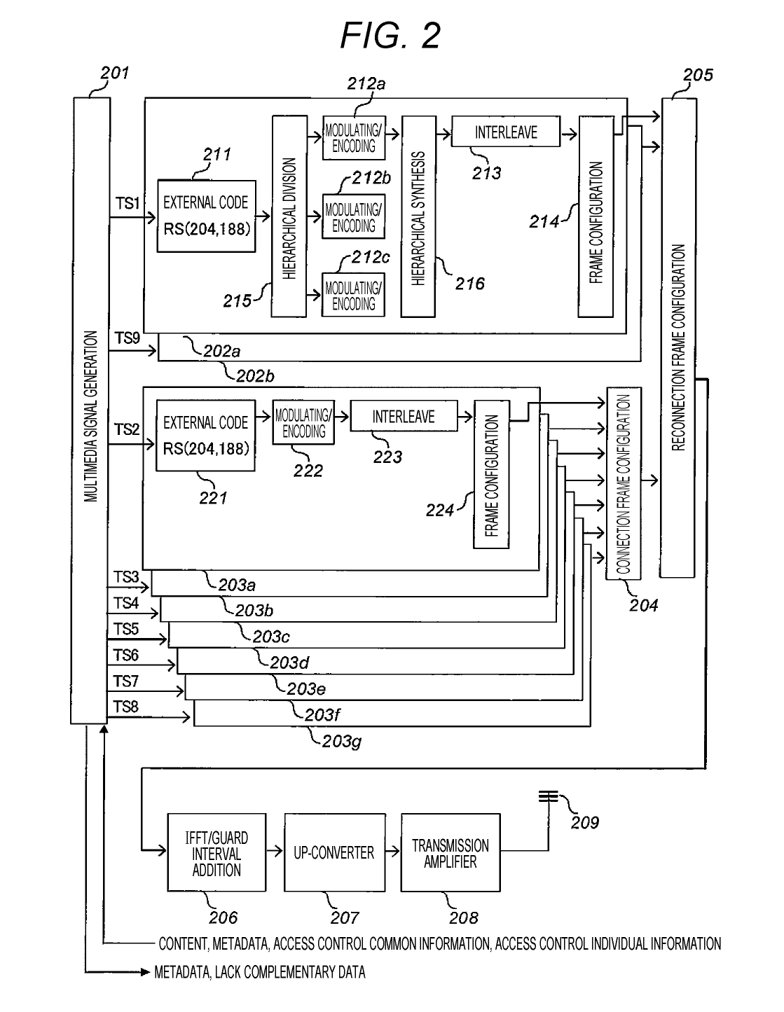

FIG. 2 is a block diagram illustrating a detailed internal configuration of the content transmitting device 101. In this digital broadcast method, after a plurality of MPEG-2 transport streams (hereinafter, referred to as the TS) is subjected to a transmission path encoding process, respectively, the plurality of MPEG-2 transport streams is collectively converted into orthogonal frequency division multiplexing (OFDM) transmission signals including a plurality of subcarriers by inverse fast Fourier transform (IFFT) and the OFDM transmission signals are transmitted as broadcast waves.

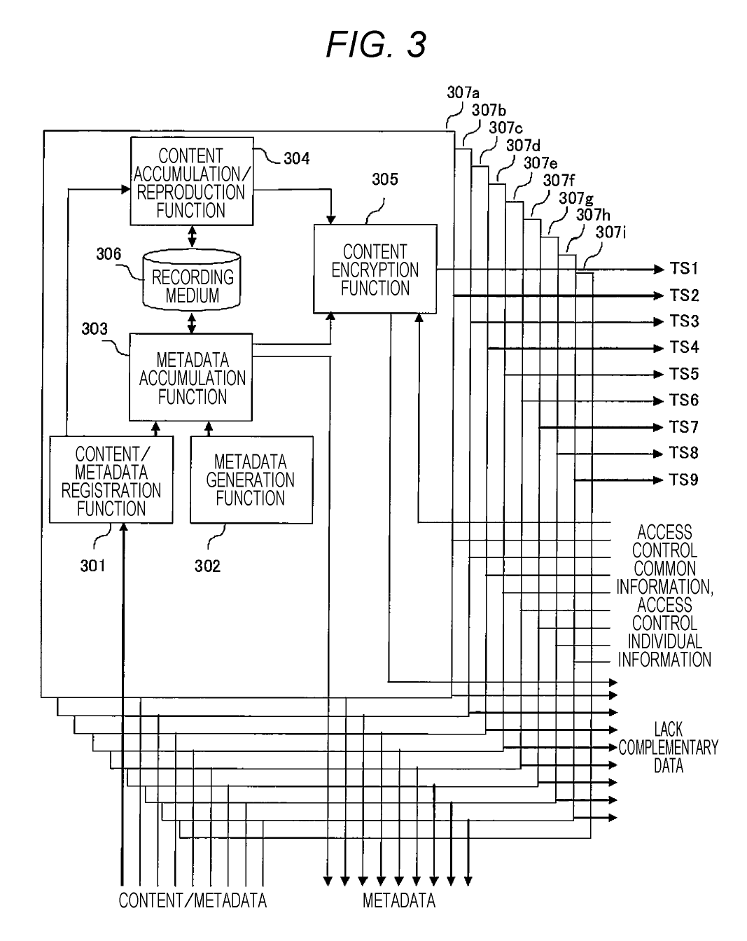

FIG. 3 is a block diagram illustrating a detailed internal configuration of multimedia signal generation 201. 301 denotes a content/metadata registration function, 302 denotes a metadata generation function, 303 denotes a metadata accumulation function, 304 denotes a content accumulation/reproduction function, 305 denotes a content encryption function, and 306 denotes a recording medium.

The content and the metadata that are supplied from the outside of the content transmitting device 101 are registered by the content/metadata registration function 301. The registered content and metadata are stored in the recording medium 306 by the content accumulation/reproduction function 304 and the metadata accumulation function 303, respectively. Metadata regarding the transmission or the license of the content is generated by the metadata generation function 302 and is stored in the recording medium 306 by the metadata accumulation function 303. The stored content and metadata are encrypted by the content encryption function 305 and are output as streams.

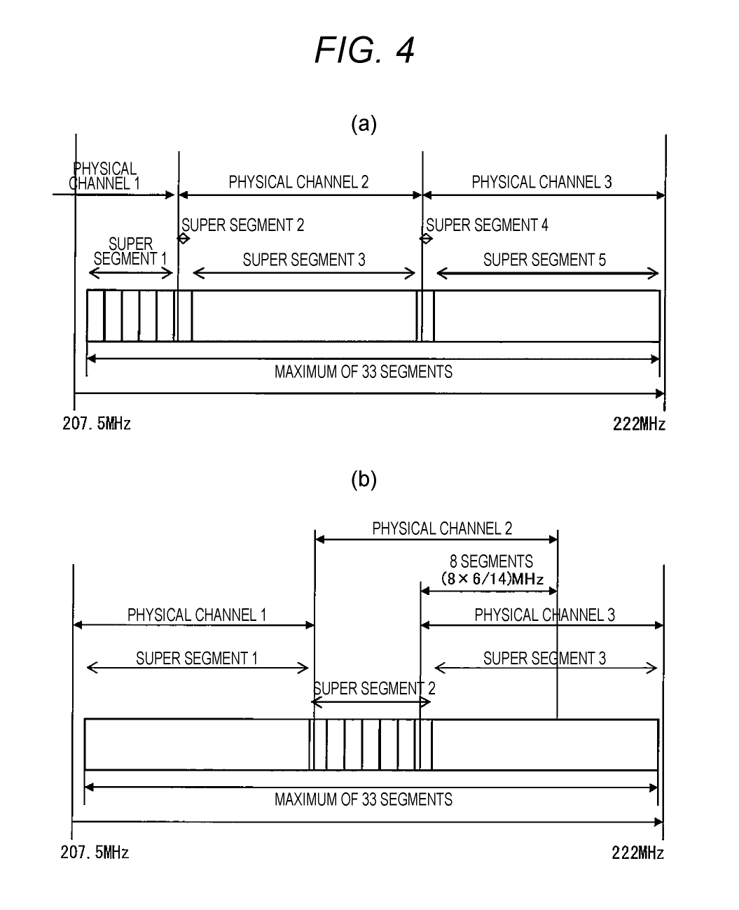

In addition, FIGS. 4(a) and 4(b) illustrate an embodiment of a segment configuration of a digital broadcast transmission signal transmitted by a digital broadcast transmitting device according to the present invention. First, FIGS. 4(a) and 4(b) will be described.

The digital broadcast transmission signal is based on a segment connection transmission method in terrestrial multimedia broadcast performed by a broadcast station using electric waves (a VHF-High band) of frequencies from 207.5 MHz to 222 MHz. This is based on a transmission method of terrestrial digital television broadcast and a transmission method of terrestrial digital audio broadcast.

An OFDM segment of the digital broadcast transmission signal is configured by connecting (hereinafter, referred to as the connected OFDM segment),

(1) OFDM segments of the 13-segment format based on the transmission method of the terrestrial digital television broadcast (type A super segments) and
(2) segments obtained by connecting 14 or less OFDM segments of the 1-segment format based on the transmission method of the terrestrial digital audio broadcast (type B super segments). Here, one segment has a bandwidth obtained by dividing equally a channel bandwidth of 6 MHz of the terrestrial television broadcast by 14. In addition, the connected OFDM segment includes one or more type A super segments by all means.

In a frequency band to which the digital broadcast is allocated, a physical channel of the bandwidth of 6 MHz is assumed, similar to the terrestrial television broadcast. At this time, a transmission spectrum of each super segment is arranged on any one physical channel. In addition, a frequency position of the physical channel may be defined by overlapping a partial band. In this case, a frequency bandwidth of an overlapped portion becomes an integral multiple of 6/14 MHz.

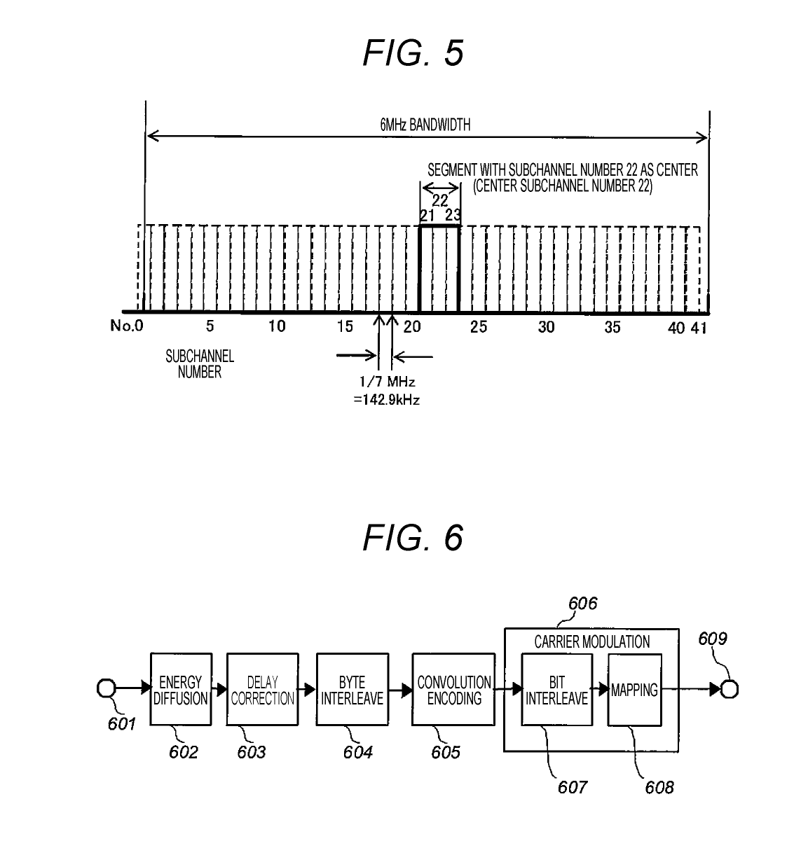

In addition, subchannels are defined for a frequency in the physical channel as illustrated in FIG. 5. The subchannel is a virtual channel of a bandwidth of 1/7 MHz and 0 to 41 are numbered for every tuning step to be 1/7 MHz in the physical channel bandwidth of 6 MHz.

An example of a relation between a subchannel number and a segment is illustrated in FIG. 5. FIG. 5 illustrates an example of one segment of a center subchannel number 22. One segment is configured by subchannels 21, 22, and 23. The segments are arranged to override the physical channel with respect to the subchannel numbers 0, 1, and 41 in the 1-segment format. In addition, the segments can be represented by a center subchannel number of a center segment (segment number #0) of the thirteen segments in the case of the 13-segment format.

When the allocated frequency bandwidth is 14.5 MHz, a maximum segment number of the connected OFDM segment is 33. In this case, the physical channels and the super segments illustrated in FIGS. 4(a) and 4(b) are considered.

In FIG. 4(a),

a physical channel 1: 204 to 210 MHz,

a physical channel 2: 210 to 216 MHz, and

a physical channel 3: 216 to 222 MHz are illustrated as “a physical channel start frequency to a physical channel end frequency” and

a super segment 1: type B (five 1-segments), physical channel 1, and center subchannel numbers {28, 31, 34, 37, and 40} (range [27 to 41]),

a super segment 2: type B (one 1-segment), physical channel 2, and center subchannel number {1} (range [0 to 2]),

a super segment 3: type A (one 13-segment), physical channel 2, and center subchannel number {22} (range [3 to 41]),

a super segment 4: type B (one 1-segment), physical channel 3, and center subchannel number {1} (range [0 to 2]), and

a super segment 5: type A (one 13-segment), physical channel 3, and center subchannel number {22} (range [3 to 41]) are illustrated.

At this time, a center frequency that becomes a channel selection frequency of the super segment 1 and the center subchannel number 28 is 208 MHz.

Likewise, a center frequency that becomes a channel selection frequency of the super segment 1 and the center subchannel number 31 is (208+ 3/7) MHz,

a center frequency that becomes a channel selection frequency of the super segment 1 and the center subchannel number 34 is (208+ 6/7) MHz,

a center frequency that becomes a channel selection frequency of the super segment 1 and the center subchannel number 37 is (209+ 2/7) MHz,

a center frequency that becomes a channel selection frequency of the super segment 1 and the center subchannel number 40 is (209+ 5/7) MHz,

a center frequency that becomes a channel selection frequency of the super segment 2 and the center subchannel number 1 is (210+ 1/7) MHz,

a center frequency that becomes a channel selection frequency of the super segment 3 and the center subchannel number 22 is (213+ 1/7) MHz,

a center frequency that becomes a channel selection frequency of the super segment 4 and the center subchannel number 1 is (216+ 1/7) MHz, and

a center frequency that becomes a channel selection frequency of the super segment 5 and the center subchannel number 22 is (219+ 1/7) MHz. That is,

channel selection frequency=(start frequency of physical channel in which super segment is arranged+center subchannel number× 1/7)MHz. [expression 1]

In addition, in FIG. 4(b),

a physical channel 1: 204+(8× 6/14) to 210+(8× 6/14) MHz,

a physical channel 2: 210+(8× 6/14) to 216+(8× 6/14) MHz, and

a physical channel 3: 216 to 222 MHz are illustrated and

a super segment 1: type A (one 13-segment), physical channel 1, and center subchannel number {22} (range [3 to 41]),

a super segment 2: type B (seven 1-segments), physical channel 2, and center subchannel numbers {1, 4, 7, 10, 13, 16, and 19} (range [0 to 20]), and

a super segment 3: type A (one 13-segment), physical channel 3, and center subchannel number {22} (range [3 to 41]) are illustrated.

At this time, a center frequency that becomes a channel selection frequency of the super segment 1 and the center subchannel number 22 is (210+ 4/7) MHz.

Likewise, a center frequency that becomes a channel selection frequency of the super segment 2 and the center subchannel number 1 is (213+ 4/7) MHz,

a center frequency that becomes a channel selection frequency of the super segment 2 and the center subchannel number 4 is 214 MHz,

a center frequency that becomes a channel selection frequency of the super segment 2 and the center subchannel number 7 is (214+ 3/7) MHz,

a center frequency that becomes a channel selection frequency of the super segment 2 and the center subchannel number 10 is (214+ 6/7) MHz,

a center frequency that becomes a channel selection frequency of the super segment 2 and the center subchannel number 13 is (215+ 2/7) MHz,

a center frequency that becomes a channel selection frequency of the super segment 2 and the center subchannel number 16 is (215+ 5/7) MHz,

a center frequency that becomes a channel selection frequency of the super segment 2 and the center subchannel number 19 is (216+ 1/7) MHz, and

a center frequency that becomes a channel selection frequency of the super segment 3 and the center subchannel number 22 is (219+ 1/7) MHz.

In the example of FIG. 4(a), because physical channels of 10, 11, and 12 channels of current VHF are used, there is an effect that compatibility with a channel selecting unit of a current television receiver is good. In the example of FIG. 4(b), because the 13-segment format is arranged on both ends of the allocated band, there is an effect of frequency interleave, even though interference is received from the outside of the allocated band. Therefore, there is an effect that it is difficult to receive the interference.

Next, an operation of the digital broadcast transmitting device of FIG. 2 will be described.

201 denotes a multimedia signal generating unit, 202 denotes a 13-segment format encoding unit, 203 denotes a 3-segment format encoding unit, 204 denotes a connection frame configuring unit, 205 denotes a reconnection frame configuring unit, 206 denotes an inverse fast Fourier transform (hereinafter, referred to as the IFFT)/guard interval adding unit, 207 denotes an up-converter unit, 208 denotes a transmission amplifier unit, and 209 denotes an antenna.

In addition, 211 denotes a Reed-Solomon (RS) encoding unit, 215 denotes a hierarchical division unit, 212 denotes a modulating/encoding unit, 216 denotes a hierarchical synthesis unit, 213 denotes an interleave unit, and 214 denotes a frame configuring unit and these elements configure the 13-segment format encoding unit 202. The modulating/encoding unit 212 has three systems of a, b, and c.

In addition, 221 denotes a Reed-Solomon (RS) encoding unit, 222 denotes a modulating/encoding unit, 223 denotes an interleave unit, and 224 denotes a frame configuring unit and these elements configure the 1-segment format encoding unit 203.

In the digital broadcast transmitting device of FIG. 2, the 13-segment format encoding unit 202 has two systems of a and b and the 1-segment format encoding unit 203 has seven systems of a, b, c, d, e, f, and g and a connected OFDM segment of 33 segments (13×2+7) is configured.

A detailed configuration of the modulating/encoding units 212 and 222 is illustrated in FIG. 6.

601 denotes an input from a previous step, 602 denotes an energy diffusing unit, 603 denotes a delay correcting unit, 604 denotes a byte interleave unit, 605 denotes a convolution encoding unit, 606 denotes a carrier modulating unit, 607 denotes a bit interleave unit, 608 denotes a mapping unit, and 609 denotes an output and the carrier modulating unit 606 includes the bit interleave unit 607 and the mapping unit 608.

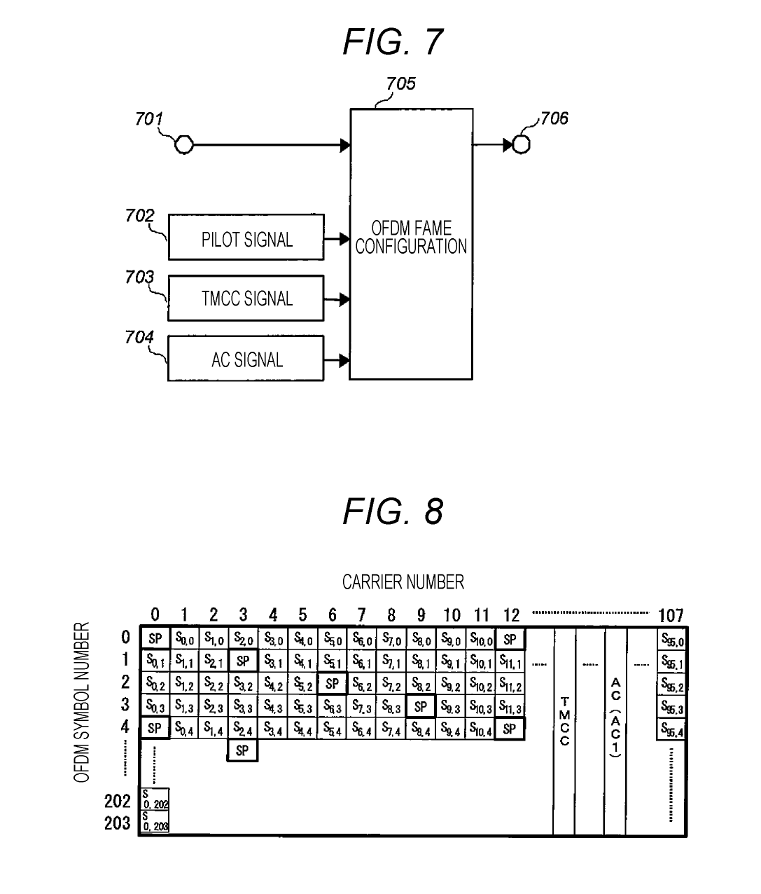

A detailed configuration of the frame configuring units 214 and 224 is illustrated in FIG. 7.

701 denotes an input from a previous step, 702 denotes a pilot signal configuring unit, 703 denotes a transmission and multiplexing configuration control (TMCC) signal configuring unit, 704 denotes an auxiliary channel (AC) signal configuring unit, 705 denotes an OFDM frame configuring unit, and 706 denotes an output.

In the multimedia signal generating unit 201, a video signal, an audio signal, and data are encoded and a TS output to each of the 13-segment format encoding unit 202 and the 1-segment format encoding unit 203 is generated.

First, an operation of the 13-segment format encoding unit 202 will be described.

Each TS is converted into a burst signal format of a 188 byte unit by a clock to be 4 times as large as an IFFT sample clock and a Reed-Solomon external code is added by the RS encoding unit 211. Then, when hierarchical transmission is performed, hierarchical division is performed by the hierarchical division unit 215 according to the designation of hierarchical information and the signal is input to the modulating/encoding units 212a, 212b, and 212c of a maximum of three systems (in FIG. 6, the input 601). Explanation is given using FIG. 6. In the modulating/encoding units 212a, 212b, and 212c, the signal input from the input 601 is subjected to energy diffusion by the energy diffusing unit 602, byte interleave by the byte interleave unit 604, convolution encoding by the convolution encoding unit 605, bit interleave by the bit interleave unit 607, and mapping by the mapping unit 608, is subjected to carrier modulation by the carrier modulating unit 606, and is output from the output 609. In addition, delay correction is previously performed on an inter-hierarchy delay time difference generated by a time axis operation of the byte interleave and the bit interleave by the delay correcting unit 603 and timing adjustment is performed. A code rate of the convolution code, an interleave length, and a carrier modulation method are set independently at each hierarchy. After a parallel process in the modulating/encoding units 212a, 212b, and 212c, a signal hierarchically synthesized by the hierarchical synthesis unit 216 is input to the interleave unit 213 to show the ability of error correcting encoding effectively for an electric field change in movement reception or multipath interference. In the interleave unit 213, time interleave and frequency interleave are performed. A type of the time interleave is convolution interleave to suppress a memory capacity of a receiver by shortening a delay time in transmission and reception. In addition, the frequency interleave is configured by combining interleave between segments and interleave in the segments, such that a sufficient interleave effect is shown while a segment structure is secured.

An output of the interleave unit 213 is input to the frame configuring unit 214 (in FIG. 7, an input 701). An operation of the frame configuring unit 214 will be described using FIG. 7.

In order to assist demodulation/decoding of the receiver with respect to the hierarchical transmission in which a plurality of transmission parameters is mixed, a transmission and multiplexing configuration control (TMCC) signal is transmitted as control information to smoothly perform a demodulation operation of the receiver, such as system identification, a transmission parameter switching index, a start flag for emergency warning broadcast, and a transmission parameter of each hierarchy, using a specific carrier. In addition, in order to transmit added information regarding the broadcast, an auxiliary channel (AC) signal to be an expansion signal to transmit added information regarding transmission control of a modulation wave allocated to the specific carrier or earthquake motion warning information is used.

In the OFDM frame configuring unit 705, an OFDM frame is configured by information data from the interleave unit 213, a pilot signal for synchronous reproduction from the pilot signal configuring unit 702, a TMCC signal from the TMCC signal configuring unit 703, and an AC signal from the AC signal configuring unit 704 and is output from the output 706. A frame configuration is illustrated in FIG. 8.

Si,j shows a carrier symbol in a data segment after the interleave. A scattered pilot (SP) is a reference pilot symbol to allow the receiver to perform quasi-synchronous detection. As illustrated in FIG. 8, the SP is inserted once for 12 carries in a carrier direction and is inserted once for 4 symbols in a symbol direction. When the SP is interpolated in the symbol direction at the reception side, the SP of a 3 (12/4) carrier interval can be obtained. Because a maximum value of a guard interval length is ¼ of an effective symbol length, it is possible to correspond to a multipath to a maximum delay time in which inter-symbol interference does not occur, by an interpolation process (transmission path characteristic estimation) by the SP of the 3 carrier interval. When a guard interval ratio is ¼, in principle, the SP may be an SP of a 4 carrier interval. However, the SP is inserted once for 4 symbols in the symbol direction, by considering a characteristic of an interpolation filter.

In an example of FIG. 8, a mode 1 is illustrated. Carrier numbers of the mode 1 are 0 to 107, whereas carrier numbers of modes 2 and 3 are 0 to 215 and 0 to 431, respectively.

An AC signal is arranged as illustrated in FIG. 8 and has a data amount of 204 bits in one carrier. In addition, two AC signals, four AC signals, and eight AC signals are arranged in the mode 1, the mode 2, and the mode 3, respectively, for each segment.

A TMCC signal is arranged as illustrated in FIG. 8 and has a data amount of 204 bits in one carrier. In addition, one TMCC signal, two TMCC signals, and four TMCC signals are arranged in the mode 1, the mode 2, and the mode 3, respectively, for each segment.

All signals in which a frame configuration is finished are output from the output 706 and are input to the reconnection frame configuring unit 205. In the embodiment of FIG. 2, the two 13-segment format encoding units 202a and 202b exist and the signals are input to the reconnection frame configuring unit 205.

Next, an operation of the 1-segment format encoding unit 203 will be described.

Each TS is converted into a burst signal format of a 188 byte unit by a clock to be 4 times as large as an IFFT sample clock and a Reed-Solomon external code is added by the RS encoding unit 221. Then, the signal is input to the modulating/encoding unit 222 (in FIG. 6, the input 601). An operation of the modulating/encoding unit 222 is as described using FIG. 6 in the case of the 13-segment format encoding unit 202. The code rate of the convolution code, the interleave length, and the carrier modulation method that are set are used. After a process in the modulating/encoding unit 222, a signal is input to the interleave unit 223 to show the ability of error correcting encoding effectively for an electric field change in movement reception or multipath interference. In the interleave unit 223, time interleave and frequency interleave are performed. A type of the time interleave is convolution interleave to suppress a memory capacity of a receiver by shortening a delay time in transmission and reception. In addition, the frequency interleave is configured by combining interleave between segments and interleave in the segments, such that a sufficient interleave effect is shown while a segment structure is secured.

An output of the interleave unit 223 is input to the frame configuring unit 224 (in FIG. 7, the input 701). An operation of the frame configuring unit 224 is as described using FIG. 7 in the case of the 13-segment format encoding unit 202.

All signals in which a frame configuration is finished are input to the connection frame configuring unit 204. In the embodiment of FIG. 2, the seven 1-segment format encoding units 203a, 203b, 203c, 203d, 203e, 203f, and 203g exist and the signals are input to the connection frame configuring unit 204.

Here, as compared with the segment configurations of FIGS. 4(a) and 4(b), in FIG. 4(a), the segments of the super segment 1: type B (five 1-segments) are allocated to blocks of 203a [TS2], b [TS3], c [TS4], d [TS5], and e [TS6], respectively, are connected by the connection frame configuring unit 204, and are output to the reconnection frame configuring unit 205.

The segment of the super segment 2: type B (one 1-segment) is allocated to a block of 203f [TS7], is input to the connection frame configuring unit 204, and is output to the reconnection frame configuring unit 205.

The 13-segment of the super segment 3: type A (one 13-segment) is allocated to a block of 202a [TS1] and is output to the reconnection frame configuring unit 205.

The segment of the super segment 4: type B (one 1-segment) is allocated to a block of 203g [TS8], is input to the connection frame configuring unit 204, and is output to the reconnection frame configuring unit 205.

The 13-segment of the super segment 5: type A (one 13-segment) is allocated to a block of 202b [TS9] and is output to the reconnection frame configuring unit 205.

In FIG. 4(b), the 13-segment of the super segment 1: type A (one 13-segment) is allocated to a block of 202a [TS1] and is output to the reconnection frame configuring unit 205.

The segments of the super segment 2: type B (seven 1-segments) are allocated to blocks of 203a [TS2], b [TS3], c [TS4], d [TS5], e [TS6], f [TS7], and g [TS8], respectively, are connected by the connection frame configuring unit 204, and are output to the reconnection frame configuring unit 205.

The 13-segment of the super segment 3: type A (one 13-segment) is allocated to a block of 202b [TS9] and is output to the reconnection frame configuring unit 205.

A portion described in [ ] denotes a number of the TS input to each of the 13-segment format encoding unit 202 and the 1-segment format encoding unit 203. In addition, in the case of the 1-segment format, a subchannel and a TS number can be associated with each other.

In the example of FIG. 4(a), the connection frame configuring unit 204 configures the super segment 1 by connecting five outputs of the OFDM segments 203a, 203b, 203c, 203d, and 203e of the 1-segment format, configures the super segment 2 by one output of the OFDM segment 203f of the 1-segment format, and configures the super segment 4 by one output of the OFDM segment 203g of the 1-segment format. The connection frame configuring unit 204 outputs the super segments as the super segments of the type B, respectively, to the reconnection frame configuring unit 205.

In the example of FIG. 4(b), the connection frame configuring unit 204 configures the super segment 2 by connecting seven outputs of the OFDM segments 203a, 203b, 203c, 203d, 203e, 203f, and 203g of the 1-segment format and outputs the super segment as the super segment of the type B to the reconnection frame configuring unit 205.

The outputs of the 13-segment format encoding units 202a and 202b are the super segments of the type A and are output to the reconnection frame configuring unit 205, respectively.

The reconnection frame configuring unit 205 receives the super segment of the type A and the super segment of the type B, connects the super segments, and forms a connected OFDM segment. When the reconnection frame configuring unit 205 connects the super segments, the reconnection frame configuring unit 205 performs phase compensation for a center frequency difference and phase correction for mismatching of pilot modulation phases.

In the IFFT/guard interval adding unit 206, the connected OFDM segment to be an output signal of the reconnection frame configuring unit 205 is converted into an OFDM signal by an IFFT operation, a guard interval is added to the OFDM signal, and the OFDM signal is converted into an OFDM transmission signal. In addition, the OFDM transmission signal is converted into a digital broadcast transmission signal of a frequency determined by the up-converter unit 207, the digital broadcast transmission signal is power-amplified by the transmission amplifier unit 208, and the digital broadcast transmission signal is transmitted by an antenna 209.

The digital broadcast transmission signal is generated by collectively performing the IFFT/guard interval addition process on the connected OFDM segment. Here, a 13-segment format portion can be divided to a maximum of three hierarchies (one segment can be partially received) and a code rate of a convolution code, an interleave length, and a carrier modulation method can be set independently for each hierarchy. In addition, for a 1-segment format portion, a code rate of a convolution code, an interleave length, and a carrier modulation method can be set independently for each segment. The digital broadcast transmitting device corresponding to the super segment configuration of the case of the example of FIG. 2 performs transmission path encoding processes of nine systems in parallel.

The connection transmission of the digital broadcast transmission method means transmitting a plurality of segments (the 13-segment format and the 1-segment format) from the same transmission point without a guard band. Restriction items of parameters at the time of the connection transmission are described below.

### (1) Equalizing a Mode

In the connection transmission, because OFDM symbol synchronization needs to be taken, modes having different symbol lengths cannot be mixed.

### (2) Equalizing a Guard Interval Length

From the same reason as the above (1), when different guard intervals are used, the OFDM symbol lengths become different. Therefore, the modes cannot be mixed.

### (3) Setting the Number of Type a Super Segments to One or More

In the digital broadcast transmission method, a carrier configuration of the OFDM segments is structured to enable connection of the plurality of segments, so that it is possible to correspond to a bandwidth and a transmission characteristic suitable for a service flexibly and interoperability with the terrestrial digital television method and the terrestrial digital audio method and commoditizing of hardware and software resources are enabled.

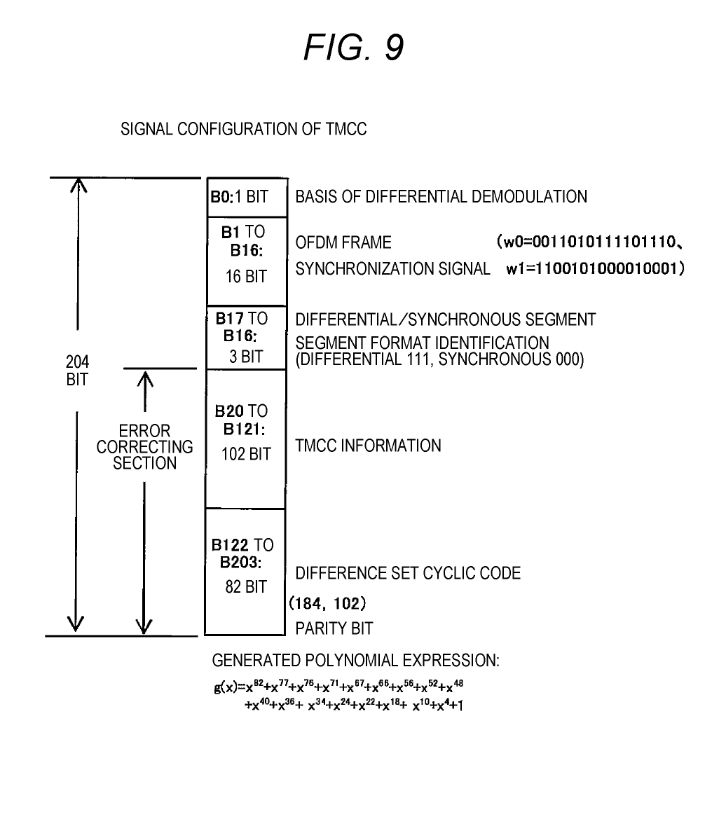

Next, a configuration of the TMCC signal configured by the TMCC signal configuring unit 703 will be described using FIGS. 9 to 15.

FIG. 9 illustrates a signal configuration of the TMCC (bit allocation of a TMCC carrier). The TMCC signal is used to transmit information regarding a demodulation operation of the receiver, such as a hierarchy organization or a transmission parameter of each OFDM segment. Bit allocation of the TMCC signal is the same as the terrestrial digital television broadcast and the terrestrial digital audio broadcast. This is to facilitate a decoding process of the TMCC signal and alleviate a load of the receiver.

A basis of the differential demodulation is one bit and amplitude and phase bases are prescribed.

A synchronization signal is configured by a word of bits. In the synchronization signal, two kinds of synchronization signals of w0=0011010111101110 and w1=1100101000010001 obtained by inverting bits of w0 exist and w0 and w1 are alternately transmitted for each frame. The synchronization signal is used to establish synchronization of the TMCC signal and frame synchronization of the OFDM. In order to prevent the pseudo-synchronous pull-in phenomenon from occurring when a bit pattern of TMCC information is matched with a synchronization signal, polarity reversion of the synchronization signal is performed for each frame. Because the TMCC information is not reversed for each frame, the pseudo-synchronous pull-in can be avoided by the reversal for each frame.

The segment format identification is a signal to identify whether a segment thereof is a differential modulation unit or a synchronous modulation unit. When the segment is configured by a word of 3 bits and is the differential modulation unit, ‘111’ is allocated and when the segment is the synchronous modulation unit, ‘000’ is allocated. A TMCC carrier number is different depending on a segment format and when a partial reception segment belongs to the synchronous modulation unit, the TMCC carrier number is one. In this case, in order to enable sure decoding, 3 bits are allocated to an identification signal and an inversion signal in which an inter-code distance is maximized is configured.

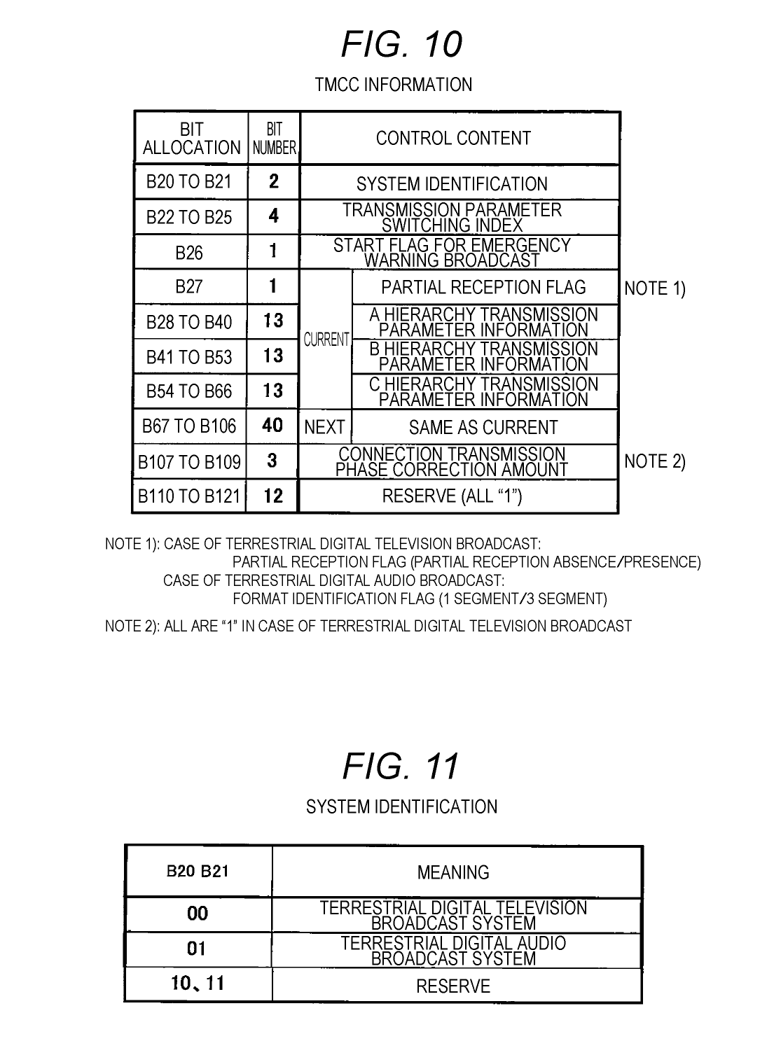

The bit allocation of the TMCC information is illustrated in FIG. 10.

The TMCC information is information to assist decoding and demodulation operations of the receiver, such as system identification, a transmission parameter switching index, a start flag for emergency warning broadcast, current information, and next information. In the TMCC information of 102 bits, 90 bits are defined at the present time. However, the remaining 12 bits are reserved for future expansion. In all of the reserve bits, “1” is stuffed. With respect to a B hierarchy and a C hierarchy of the 1-segment format, bit allocation is secured to maintain compatibility with the 13-segment format. However, as described below, information that means unused hierarchies is allocated.

The system identification is illustrated in FIG. 11.

Two bits are allocated to the signal for the system identification. It is assumed that the 13-segment format compatible with the terrestrial digital television broadcast system is ‘00’ and the 1-segment format compatible with the terrestrial digital audio broadcast system is ‘01’. The remaining values are reserved.

Current information shows a current hierarchy organization and a current transmission parameter and next information shows a transmission parameter after switching and the current information and the next information are transmitted at the same time. This is to improve a response of the receiver by using the current information, on the assumption that power is supplied to the receiver or a channel is switched during the countdown.

When at least one of transmission parameter information and flags (a partial reception flag, a carrier modulation method, a convolution code rate, an interleave length, and a segment number) included in the current information and the next information and described below is switched, a transmission parameter switching index of 4 bits is counted down. When only a start flag for emergency warning broadcast or a connection transmission phase correction amount to be described below is switched, the countdown of the transmission parameter switching index is not performed. By counting down the transmission parameter switching index, switching is reported to the receiver and timing is taken. The index normally takes a value of “111”. However, when the transmission parameter is switched, the value is subtracted by one for every frame before 15 frames to be switched. After ‘0000’, the value returns to ‘1111’. The switching timing is used to synchronize a next frame to transmit ‘0000’. That is, a new transmission parameter is applied from a frame returned to ‘1111’. The next information can be set or changed at any time before the switching countdown. However, the next information cannot be changed during the countdown.

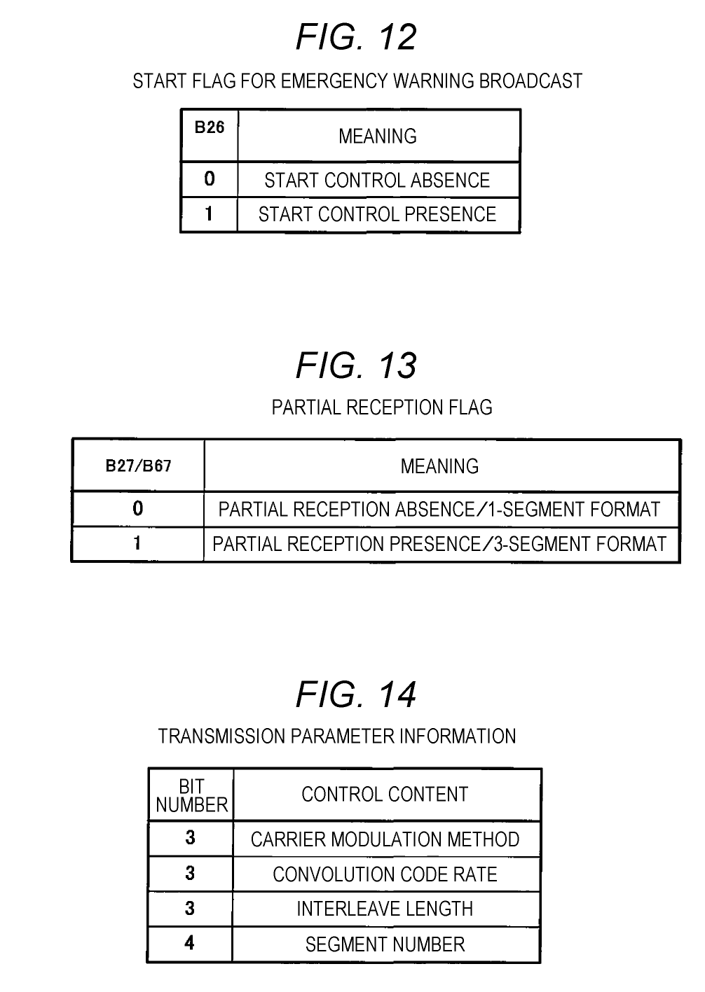

The allocation of the start flag for emergency warning broadcast is illustrated in FIG. 12. In the emergency warning broadcast, the start flag is set as ‘1’ when start control is performed with respect to the receiver and the start flag is set as ‘0’ when the start control is not performed.

The partial reception flag is illustrated in FIG. 13.

The partial reception flag is set to ‘1’ when a segment (segment No. 0) of a transmission band center is set for partial reception in the 13-segment format and is set to ‘0’ when the segment is not set for the partial reception. When the segment No. 0 is set for the partial reception, a hierarchy thereof is prescribed as an A hierarchy of FIG. 10. In the case of the 1-segment format, a flag is set to ‘0’. This is matched with that the terrestrial digital audio method sets the flag as the format identification flag, sets the flag as ‘0’ in the case of the 1-segment format, and sets the flag as ‘1’ in the case of the 3-segment format. In addition, when the next information does not exist, the flag is set to ‘1’.

The transmission parameter information included in the current/next information is illustrated in FIG. 14. In the transmission parameter information, a bit is set as ‘1’ in the case of an unused hierarchy or in the case in which the next information does not exist.

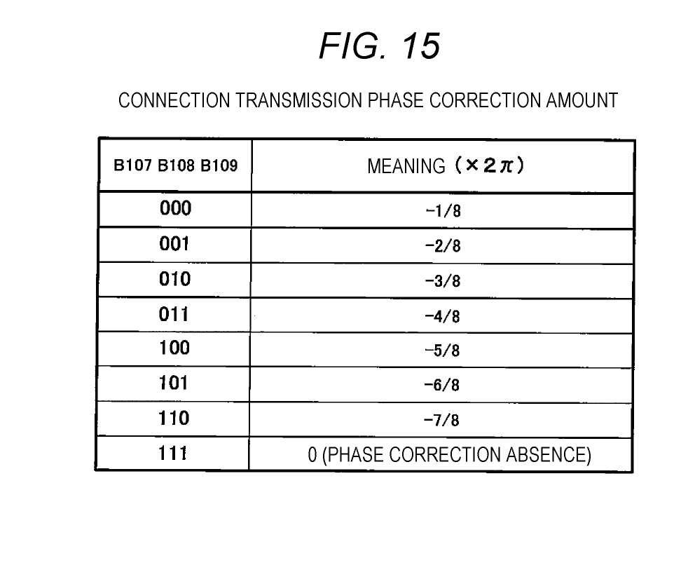

The connection transmission phase correction amount is illustrated in FIG. 15.

In the connection transmission, when a received segment uses a lower end carrier of an upper adjacent segment as a reference signal, the connection transmission phase correction amount is used to correct a phase of the carrier for each symbol. In the case in which the phase correction is not performed, including the case in which the connection transmission is not performed, ‘111’ is set.

TMCC information B20 to B121 are subjected to error correcting encoding by a shortened code (184,102) of a difference set cyclic code (273,191). The TMCC information needs to have transmission reliability higher than transmission reliability of a data signal to designate the transmission parameter or control the receiver. By considering that it is difficult to use a decoding circuit of a connected code in common with the receiver and that a block code is advantageous from the viewpoint of process delay, an error correcting code of the TMCC is the shortened code (184,102) of the difference set cyclic code (273,191). In addition, because the TMCC signal is transmitted by a plurality of carriers, required C/N can be decreased by performing analog addition on the signal and reception performance can be improved. By the error correcting technology and the addition process, the TMCC signal can be received with C/N smaller than C/N of a data signal. In order to equalize parity bits in all of the TMCC information, the synchronization signal and the information of the segment format identification are excluded from error correcting targets, all bits of the plurality of TMCC carriers are equalized, and decision by majority for each of bits including the parity bits is enabled.

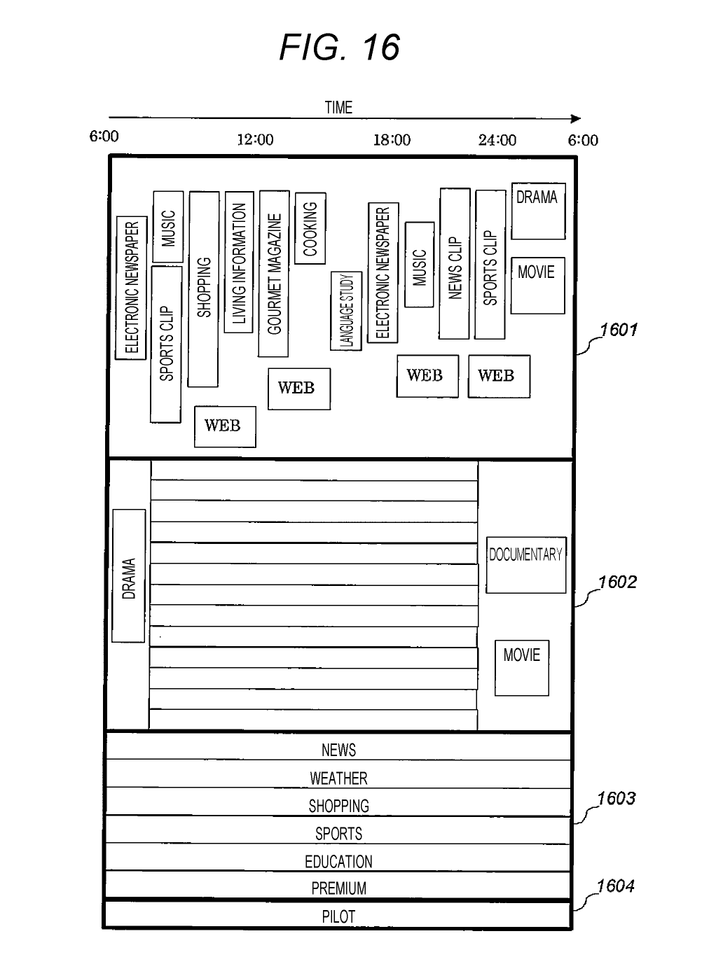

FIG. 16 illustrates an embodiment of a service of a digital broadcast transmission signal transmitted by the digital broadcast transmitting device of FIG. 2.

1601 denotes push-cast broadcast, 1602 denotes mixed broadcast of push-cast broadcast and real-time broadcast, 1603 denotes real-time broadcast, and 1604 denotes pilot broadcast.

The push-cast broadcast 1601 is a service in which time independent file type content is automatically downloaded. For example, an electronic newspaper, music, a sports clip, a news clip, shopping, living information, a gourmet magazine, cooking information, language study, a drama, and a movie, or the like are considered. In addition, a menu (described as a WEB in FIG. 16) linked with information addresses enabling a variety of information to be searched is considered. In the push-cast broadcast, content is distributed in advance and a user can view the content at a desired time.

In the real-time broadcast 1603 to be stream type broadcast, programs in which “viewing now” is important are provided. For example, the programs are news, weather forecast, and sports. Shopping, education, and premium programs may be broadcasted in real time.

The mixed broadcast 1602 is broadcast in which the real-time broadcast and the push-cast broadcast are mixed according to a time.

The pilot broadcast 1604 navigates entire services of the push-cast broadcast 1601, the mixed broadcast 1602, and the real-time broadcast 1603. In addition, the pilot broadcast 1604 shows which service is transmitted with which subchannel of which super segment or which TS. Therefore, it is necessary to previously determine which frequency arrangement the pilot broadcast 1604 is transmitted with.

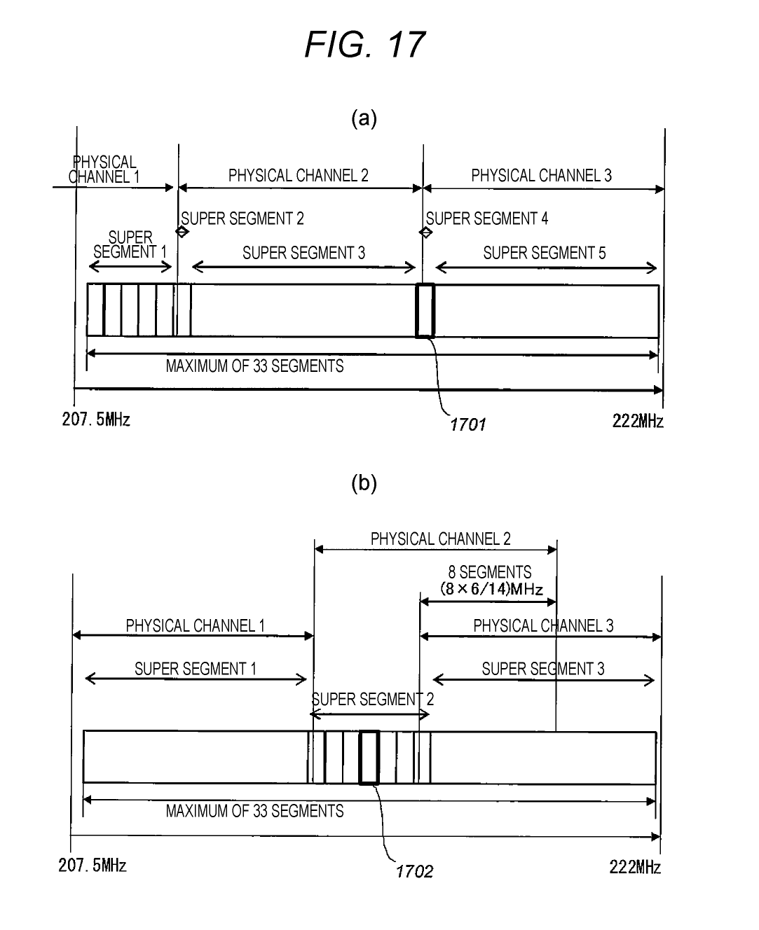

FIGS. 17(a) and 17(b) are diagrams illustrating an embodiment of a segment configuration of a digital broadcast transmission signal transmitted by a digital broadcast transmitting device according to the present invention. FIGS. 17(a) and 17(b) illustrate the segment configuration example illustrated in FIGS. 4(a) and 4(b). In FIG. 17(a), 1701 denotes a pilot segment and in FIG. 17(b), 1702 denotes a pilot segment.

The pilot segment is a segment to transmit the pilot broadcast and is configured as a segment of the 1-segment format or a partial reception segment of the 13-segment format. In an example of FIG. 17(a), the pilot segment is a segment of “super segment 4 and center subchannel number 1” and has a center frequency of (216+ 1/7) MHz. In an example of FIG. 17(b), the pilot segment is a segment of “super segment 2 and center subchannel number 10” and has a center frequency of (214+ 6/7) MHz. The frequency arrangement is determined at the corresponding position in the examples of FIGS. 17(a) and 17(b).

As an example of the case in which a service of FIG. 16 is allocated to a super segment, the case of FIG. 17(a) is as follows.

Five programs of the real-time broadcast 1603 are allocated to a super segment 1: type B (five 1-segments) in the 1-segment format and TS2 is set as news, TS3 is set as a weather, TS4 is set as shopping, TS5 is set as sports, and TS6 is set as education.

One program of the real-time broadcast 1603 is allocated to a super segment 2: type B (one 1-segment) in the 1-segment format and TS7 is set as a premium.

The push-cast broadcast 1601 is allocated to a super segment 3: type A (one 13-segment) and is set as TS1.

The pilot broadcast 1604 is allocated as a pilot segment to a super segment 4: type B (one 1-segment) and is set as TS8.

The mixed broadcast 1602 is allocated to a super segment 5: type A (one 13-segment) and is set as TS9.

In addition, the case of FIG. 17(b) is as follows.

The mixed broadcast 1602 is allocated to a super segment 1: type A (one 13-segment) and is set as TS1.

Six programs of the real-time broadcast 1603 and the pilot broadcast 1604 to be a pilot segment are allocated to a super segment 2: type B (seven 1-segments) in the 1-segment format and TS2 is set as news, TS3 is set as a weather, TS4 is set as shopping, TS5 is set as the pilot broadcast 1604, TS6 is set as sports, TS7 is set as education, and TS8 is set as a premium.

The push-cast broadcast 1601 is allocated to a super segment 3: type A (one 13-segment) and is set as TS9.

The allocation is performed by the multimedia signal generating unit 201 of FIG. 2.

In the example of FIG. 17(a), one type B super segment of the 1-segment format is set as a pilot segment and in the example of FIG. 17(b), one segment of seven connected type B super segments of the 1-segment format is set as a pilot segment. Therefore, the example of FIG. 17(a) is suitable for the case in which a process is performed in a super segment unit and the example of FIG. 17(b) is suitable for the case in which a process is performed in a TS unit.

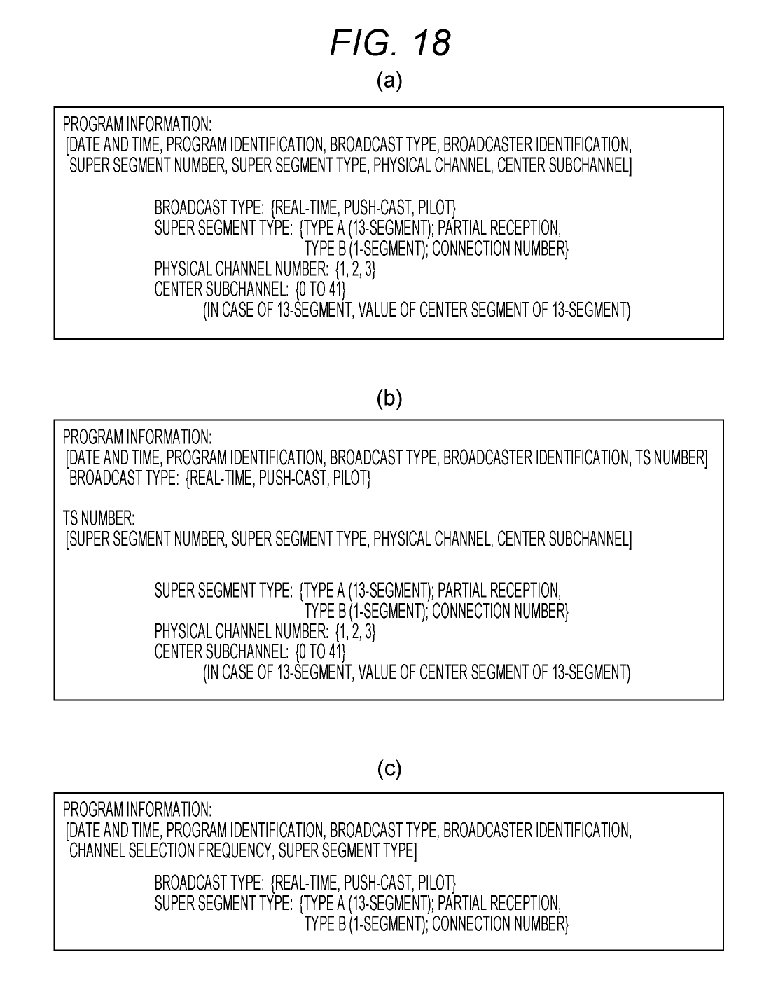

FIGS. 18(a) to 18(c) illustrate a configuration example of program information to be an example of pilot information transmitted by the pilot broadcast. The program information includes program identification showing a program, a broadcast type showing whether the program is the real-time broadcast, the push-cast broadcast, or the pilot broadcast, a date and time when the program is broadcasted, and broadcaster identification showing a broadcaster who broadcasts the program. In order to select a channel to view the program at the reception side, information showing which segment the program is transmitted with is necessary. As illustrated in the [expression 1], when the start frequency and the center subchannel number of the physical channel in which the super segment is arranged are known, the center frequency of the transmitted segment is fixed. In addition, at the reception side, information of the super segment type showing whether the segment is of the 13-segment format or the 1-segment format is necessary.

In FIG. 18(a), the program information is set as “a date and time, program identification, broadcast type, broadcaster identification, super segment number, super segment type, physical channel, and center subchannel”. If the physical channel is previously determined as illustrated in FIG. 17(a) or 17(b), only a physical channel number may be illustrated. Of course, only a frequency of the physical channel or a start frequency or an end frequency of the physical channel may be illustrated. This is because a bandwidth of the physical channel is determined as 6 MHz.

FIGS. 18(a) to 18(c) illustrate types A and B as the super segment types and are provided with a partial reception flag showing whether the program enters a partial reception hierarchy in the case of the type A, and illustrate a connection number of the 1-segment format in the case of the type B.

By viewing the partial reception flag, there is an effect that it can be determined whether the program can be received by the receiver of the 1-segment format to be described below, even though the TMCC information is not viewed by channel selection.

In addition, there is an effect that in the case of the type B, a super segment configuration of the 1-segment format can be confirmed by showing a connection number of the 1-segment format and the super segment configuration can be fixed by a super segment number.

In addition, by including “pilot” in the broadcast type, in addition to the pilot segment, pilot broadcast such as program propaganda can be performed.

In the example of FIG. 18(a), there is an effect that the center frequency of the segment in which the program is transmitted or the super segment configuration can be acquired by only extracting the program information.

In FIG. 18(b), instead of the super segment number, the super segment type, the physical channel, and the subchannel of FIG. 18(a), a TS number is transmitted as the program information. As described in FIG. 2, the TS number can be represented by the super segment number, the super segment type, and the subchannel and the center frequency can be fixed by the start frequency and the center subchannel number of the physical channel. As other information, TS information is transmitted as pilot information.

In the example of FIG. 18(b), the TS number, the program identification, and the broadcaster identification are easily associated and this example is convenient for the case in which a broadcaster is allocated to each TS, in particular.

In FIG. 18(c), a channel selection frequency at the reception side is directly illustrated in the program information. If the channel selection frequency and the super segment type are known, it can be determined whether the program information can be received by the receiver to be described below.

In the example of FIG. 18(c), there is an effect that by only viewing the program information, the receiver can directly select a channel to view the program and a channel selection operation becomes easy.

According to a transmission method of the pilot information of FIGS. 18(a) to 18(c), even though the super segment configuration changes at a certain date and time, if setting of program information from the certain date and time is changed according to change content of the super segment configuration, there is an effect that the receiver side can receive the program without considering the change in the super segment configuration. However, a position (frequency arrangement) of the pilot segment should not be changed.

### Second Embodiment

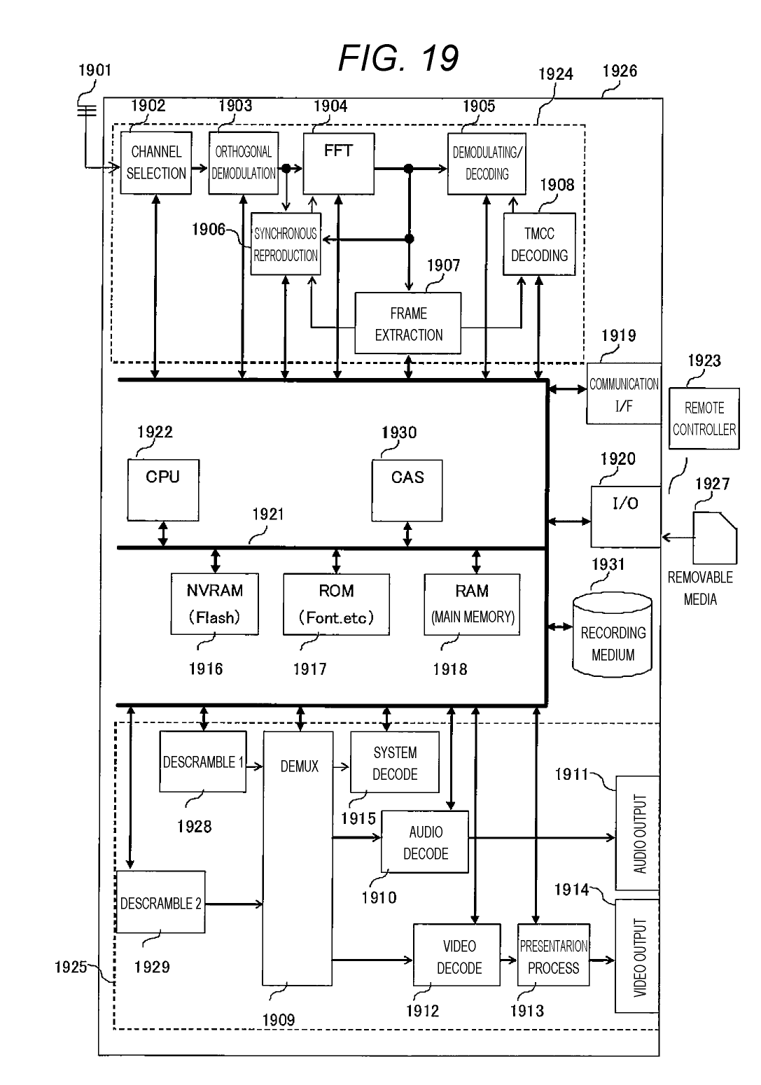

FIG. 19 is a block diagram illustrating a configuration of a digital broadcast receiving device according to a second embodiment of the present invention. The digital broadcast receiving device of FIG. 19 receives the digital broadcast transmission signal transmitted from the digital broadcast transmitting device of FIG. 2.

1926 denotes a digital broadcast receiving device.

1901 denotes an antenna, 1902 denotes a channel selecting unit, 1903 denotes an orthogonal demodulation unit, 1904 denotes a fast Fourier transform (hereinafter, referred to as the FFT) unit, 1905 denotes demodulating/decoding unit that performs a demodulating/decoding operation of a digital broadcast transmission signal to a TS output after the FFT unit 1904, 1906 denotes a synchronous reproduction unit, 1907 denotes a frame extracting unit, and 1908 denotes a TMCC decoding unit that performs synchronous signal reproduction to perform an operation of the demodulating/decoding unit 1905 or obtaining of information such as a transmission parameter.

The channel selecting unit 1902 to the TMCC decoding unit 1908 configure a front/end (hereinafter, referred to as F/E) unit 1924. 1928 denotes a descramble 1 unit, 1929 denotes a descramble 2 unit, 1909 denotes a DEMUX unit, 1910 denotes a decoding unit to decode a compressed broadcast audio signal, 1911 denotes an audio output unit to output the decoded broadcast audio signal, 1912 denotes a decoding unit to decode a compressed broadcast video signal, 1913 denotes a presentation processing unit to configure a display screen, 1914 denotes a video output unit to display the decoded broadcast video signal, and 1915 denotes a system decoding unit to handle system information such as program specific information (PSI)/service information (SI).

The descramble 1 unit 1928, the descramble 2 unit 1929, and the DEMUX unit 1909 to the system decoding unit 1915 configure a back/end (hereinafter, referred to as B/E) unit 1925.

1916 denotes a rewritable non-volatile memory (hereinafter, referred to as the NVRAM), 1917 denotes a read only memory (ROM) to store a font or the like, 1918 denotes a random access memory (RAM) to be a main memory, 1919 denotes a communication line interface (hereinafter, referred to as I/F), 1920 denotes an input/output unit (hereinafter, referred to as I/O), 1921 denotes a system bus, 1922 denotes a central processing unit (hereinafter, referred to as CPU), 1923 denotes a remote controller, 1930 denotes a conditional access system (CAS) to manage license information, 1931 denotes a recording medium, and 1927 denotes removable media.

In the case of the real-time broadcast, a digital broadcast transmission signal input to the digital broadcast receiving device 1926 by the antenna 1901 is converted into a transport stream (TS) by the F/E unit 1924. In the demodulated TS, encrypted data is selectively decoded by the descramble 1 unit 1928 using license information stored in the CAS 1930. The license information may be supplied by the communication I/F 1919 through a network or may be supplied by the removable media 1927. The decoded TS is separated into video, audio, and other data by the DEMUX unit 1909, and a video stream is output to the video decoding unit 1912 and an audio stream is output to the audio decoding unit 1910. The decoded video signal configures a display screen by the presentation processing unit 1913 and is output by the video output 1914. The decoded audio signal is output by the audio output 1911.

In the case of the push-cast broadcast, a digital broadcast transmission signal input to the digital broadcast receiving device 1926 by the antenna 1901 is converted into a transport stream (TS) by the F/E unit. The demodulated TS is input to the descramble 1 unit 1928, but decoding is not performed herein. Next, only data regarding accumulated content is separated from the input digital broadcast transmission signal by the DEMUX unit 1909 and is accumulated in the recording medium 1931.

When access control common information and access control individual information are distributed through a broadcast wave, the access control common information and the access control individual information are separated by the DEMUX unit 1909 and are accumulated in the recording medium 1931. When the access control common information and the access control individual information are distributed through the network, the access control common information and the access control individual information are acquired through the communication I/F 1919 before reproduction or at the time of the reproduction and are accumulated in the recording medium 1931. When the access control common information and the access control individual information are distributed through the network, the access control common information and the access control individual information are acquired through the I/O 1920 before the reproduction or at the time of the reproduction and are accumulated in the recording medium 1931.

At the time of the reproduction, data regarding reproduced content is read from the recording medium 1931, the data is input to the descramble 2 unit 1929, and encrypted data is selectively decoded using the access control common information and the access control individual information accumulated in the recording medium 1931. The decoded TS is separated into video, audio, and other data by the DEMUX unit 1909, and a video stream is output to the video decoding unit 1912 and an audio stream is output to the audio decoding unit 1910. The decoded video signal configures a display screen by the presentation processing unit 1913 and is output by the video output 1914. The decoded audio signal is output by the audio output 1911.

In the above operation, the CPU 1922 performs control on each block of the F/E unit 1924 or the B/E unit 1925 through the system bus 1921 and the digital broadcast receiving device 1926 performs normal video and audio reproduction.

At the time of data broadcast reception, data is temporarily transmitted to the RAM 1918, the NVRAM 1916, or the like and a process by the CPU 1922 is performed. In addition to a normal video and audio reproduction process, various processes for transmitting the data on the RAM 1918 to the video and audio decoders at the same time as presentation of characters and figures and reproducing video and audio are performed. In addition, information is exchanged with the outside of the digital broadcast receiving device 1926 using the communication I/F 1919.

The operation of the digital broadcast receiving device can be performed by the remote controller 1923 through the I/O 1920.

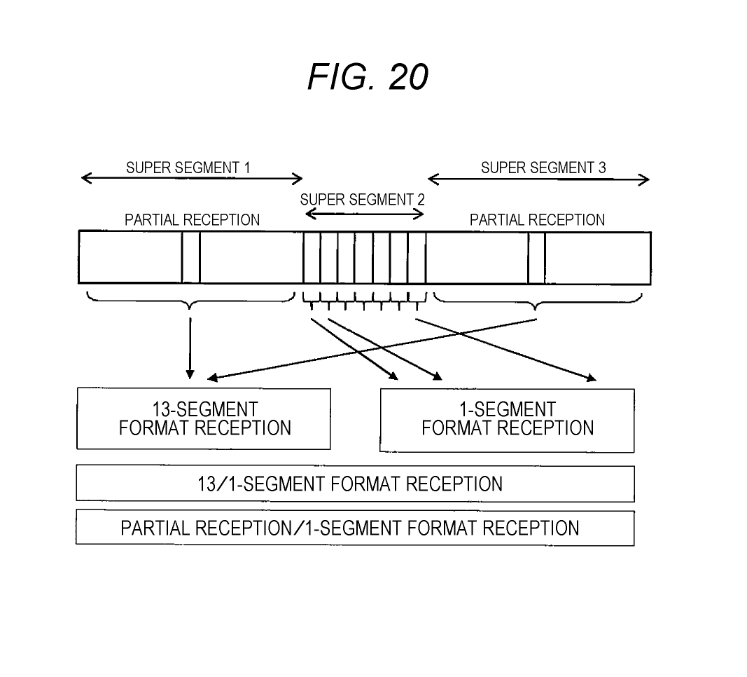

FIG. 20 illustrates a type of the digital broadcast receiving device.

In the digital broadcast transmission signal from the digital broadcast transmitting device of FIG. 2, a super segment of the 13-segment format and a super segment of the 1-segment format exist. Receivers that can receive these super segments can be defined. In addition, 13/1-segment format reception that enables reception of both the 13-segment format and the 1-segment format and partial reception/1-segment format reception that enables reception of a partial reception hierarchy of the 13-segment format in addition to the 1-segment format can be defined. The digital broadcast receiving device 1926 of FIG. 19 realizes either the 13/1-segment format reception or the partial reception/1-segment format reception.

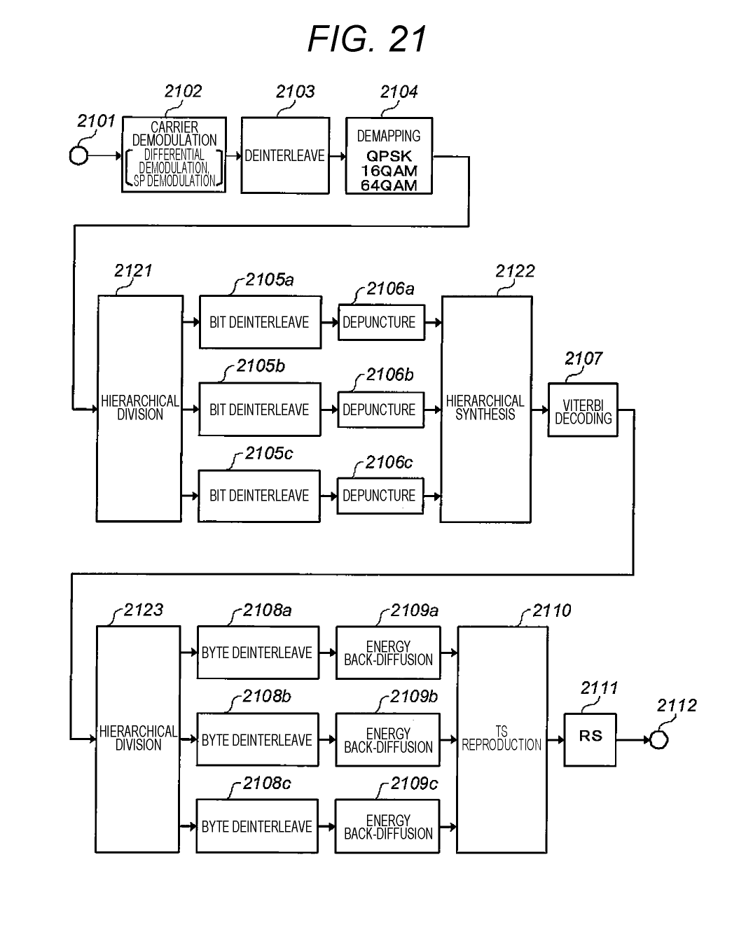

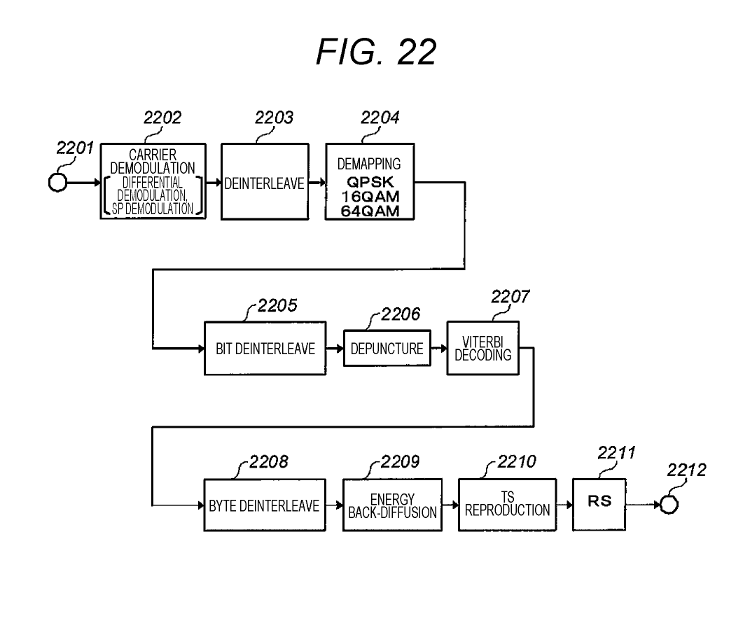

FIG. 21 illustrates a configuration the demodulating/decoding unit 1905 in the case of the 13/1-segment format reception and FIG. 22 illustrates a configuration of the demodulating/decoding unit 1905 in the case of the partial reception/1-segment format reception.

2101 and 2201 denote inputs of output signals from the FFT unit 1904, 2102 and 2202 denote carrier demodulating units, 2103 and 2203 denote deinterleave units, 2104 and 2204 denote demapping units, 2105 and 2205 denote bit deinterleave units, 2106 and 2206 denote depuncture units, 2107 and 2207 denote Viterbi decoding units, 2108 and 2208 denote byte deinterleave units, 2109 and 2209 denote energy back-diffusion units, 2110 and 2210 denote TS reproducing units, 2111 and 2211 denote Reed-Solomon (RS) decoding units, 2112 and 2212 denote outputs of the demodulating/decoding unit 1905. Each of the bit deinterleave unit 2105, the depuncture unit 2106, the byte deinterleave unit 2108, and the energy back-diffusion unit 2109 has three hierarchies of a, b, and c and 2121 and 2123 denote hierarchical division units to perform hierarchical division into three hierarchies and 2122 denotes a hierarchical synthesis unit to perform hierarchical synthesis.

First, an operation of the case of the 13/1-segment format reception will be described using FIGS. 21 and 19.

A channel frequency band to be received by the channel selecting unit 1902 is extracted from the digital broadcast transmission signal received by the antenna 1901, a signal channel-selected by the orthogonal demodulation unit 1903 is orthogonally demodulated and becomes a baseband signal, the baseband signal is subjected to a frequency axis process by the FFT unit 1904, and the FFT is executed for a period corresponding to an effective symbol among the OFDM symbols. At this time, a situation of a multipath of a received signal is considered and the FFT process is executed in an appropriate period. After the signal is received, in the demodulating/decoding unit 1905, a demodulation process is executed on each carrier on a frequency axis by the carrier demodulating unit 2102 (for example, synchronous demodulation is performed using a scattered pilot (SP) for QPSK, 16QAM, and 64QAM and amplitude and phase information are detected), the signal is subjected to deinterleaving of the frequency axis and a time axis by the deinterleave unit 2103, is subjected to demapping by the demapping unit 2104, is divided into each hierarchy by the hierarchical division unit 2121, is subjected to bit deinterleaving by the bit deinterleave units 2105a, 2105b, and 2105c, is subjected to depuncturing by the depuncture units 2106a, 2106b, and 2106c, is synthesized by the hierarchical division unit 2122, is subjected to Viterbi decoding by the Viterbi decoding unit 2107, is divided into each hierarchy by the hierarchical division unit 2121, is subjected to byte deinterleaving by the byte deinterleave unit 2108, is subjected to energy back-diffusion by the energy back-diffusion unit 2109, is subjected to TS reproduction by the TS reproducing unit 2110, and is subjected to error correcting by the RS decoding unit 2111, a digital broadcast signal is demodulated, and a transport stream (TS) signal prescribed in an MPEG2 system is output to the descramble 1 unit 1928 and the DEMUX unit 1909. Here, both when a signal of the 1-segment format is received and when reception of the 13-segment format is performed, a system of the TMCC signal decoded by the TMCC decoding unit 1908 is identified by the system identification illustrated in FIG. 11. In the case of the terrestrial digital audio broadcast system, a process of the reception of the 1-segment format is performed and in the case of the terrestrial digital television broadcast system, a process of the reception of the 13-segment format is performed (a partial reception flag illustrated in FIG. 13 is mainly handled). When the signal of the 1-segment format is received, the hierarchical division is not performed by the hierarchical divisions 2121 and 2123 and the process is performed using the block of the system. Because the hierarchical division is not performed, the hierarchical synthesis by the hierarchical synthesis 2122 is not necessary. When the partial reception hierarchy is received, the process may be performed using only the system, similar to the case of the 1-segment format, and the hierarchy may be divided into three hierarchies and one system thereof may be processed as the partial reception hierarchy. In the case of the 1-segment format reception and the partial reception, the channel frequency band of the channel selecting unit 1902 may be extracted as one segment.

Next, an operation of the case of the partial reception/1-segment format reception will be described using FIGS. 22 and 19.

A channel frequency band to be received by the channel selecting unit 1902, in this case, a frequency band corresponding to one segment is extracted from the digital broadcast transmission signal received by the antenna 1901, a signal channel-selected by the orthogonal demodulation unit 1903 is orthogonally demodulated and becomes a baseband signal, the signal is subjected to a frequency axis process by the FFT unit 1904, and the FFT is executed for a period corresponding to an effective symbol among the OFDM symbols. At this time, a situation of a multipath of a received signal is considered and the FFT process is executed in an appropriate period. After the signal is received, in the demodulating/decoding unit 1905, a demodulation process is performed on each carrier on a frequency axis by the carrier demodulating unit 2202 (for example, synchronous demodulation is performed using a scattered pilot (SP) for QPSK, 16QAM, and 64QAM and amplitude and phase information are detected), the signal is subjected to deinterleaving of the frequency axis and a time axis by the deinterleave unit 2203, is subjected to demapping by the demapping unit 2204, is subjected to bit deinterleaving by the bit deinterleave unit 2205, is subjected to depuncturing by the depuncture unit 2206, is subjected to Viterbi decoding by the Viterbi decoding unit 2207, is subjected to byte deinterleaving by the byte deinterleave unit 2208, is subjected to energy back-diffusion by the energy back-diffusion unit 2209, is subjected to TS reproduction by the TS reproducing unit 2210, and is subjected to error correcting by the RS decoding unit 2211, a digital broadcast signal is demodulated, and a transport stream (TS) signal prescribed in an MPEG2 system is output to the descramble 1 unit 1928 and the DEMUX unit 1909. Here, both when a signal of the 1-segment format is received and when partial reception of the 13-segment format is performed, a system of the TMCC signal decoded by the TMCC decoding unit 1908 is identified by the system identification illustrated in FIG. 11. In the case of the terrestrial digital audio broadcast system, a process of the reception of the 1-segment format is performed and in the case of the terrestrial digital television broadcast system, a process of the partial reception of the 13-segment format is performed (a partial reception flag illustrated in FIG. 13 is mainly handled).

The other blocks of the F/E unit 1924 of FIG. 19 will be described.

In the synchronous reproduction unit 1906, the baseband signal is received from the orthogonal demodulation unit 1903 and an OFDM symbol synchronization signal and an FFT sample frequency are reproduced according to a mode and a guard interval length. When the mode and the guard interval length are not known, the mode and the guard interval length can be determined by such as a correlation of a guard period of an OFDM signal. In addition, a frequency position of a TMCC signal is detected from an output signal of the FFT unit 1904. In the frame extracting unit 1907, the TMCC signal of the detected frequency position is demodulated and a frame synchronization signal is extracted from the TMCC signal. The frame synchronization signal is output to the synchronous reproduction unit 1906 and phase adjustment with a symbol synchronization signal is performed. In the TMCC decoding unit 1908, error correcting of a difference set cyclic code is performed on the demodulated TMCC signal and TMCC information such as a hierarchical structure and a transmission parameter is extracted. The TMCC information is output to the demodulating/decoding unit 1905 and is used as various control information of a demodulating/decoding process. In a connection transmission signal, because a phase difference exists between segments, a carrier phase of an upper adjacent segment lower end should be corrected for reception of a synchronous modulation segment using a carrier of the upper adjacent segment lower end for demodulation.

When emergency warning broadcast is received, the TMCC decoding unit 1908 is operated at all times and monitors a start flag for emergency warning broadcast illustrated in FIG. 12. At this time, the channel selecting unit 1902, the orthogonal demodulation unit 1903, the FFT unit 1904, the synchronous reproduction unit 1906, and the frame extracting unit 1907 are operated at all times. In the operations of the channel selecting unit 1902, the orthogonal demodulation unit 1903, the FFT unit 1904, the synchronous reproduction unit 1906, and the frame extracting unit 1907, when the emergency warning broadcast is received, the process of only the segment No. 0, that is, the partial reception may be performed in the case of the 13-segment format. Thereby, a low consumption power operation can be performed as compared with the case in which an entire band of the 13-segment band of the digital broadcast is processed. In the case of the 1-segment format, only the 1-segment band may be processed.

The B/E unit 1925 of FIG. 19 will be described.

In the descramble 1 unit 1928 and the DEMUX unit 1909, a TS signal scrambled for copyright protection is descrambled and a digital signal of a desired compressed broadcast video signal or a desired compressed broadcast audio signal is extracted and is output to the decoding units 1910, 1912, and 1915. In the decoding unit 1912, the compressed broadcast video signal is decoded and in the decoding unit 1910, the compressed broadcast audio signal is decoded. The decoded video signal configures the display screen by the presentation processing unit 1913 and is output to the video output unit 1914 and the decoded audio signal is output to the audio output unit 1911.

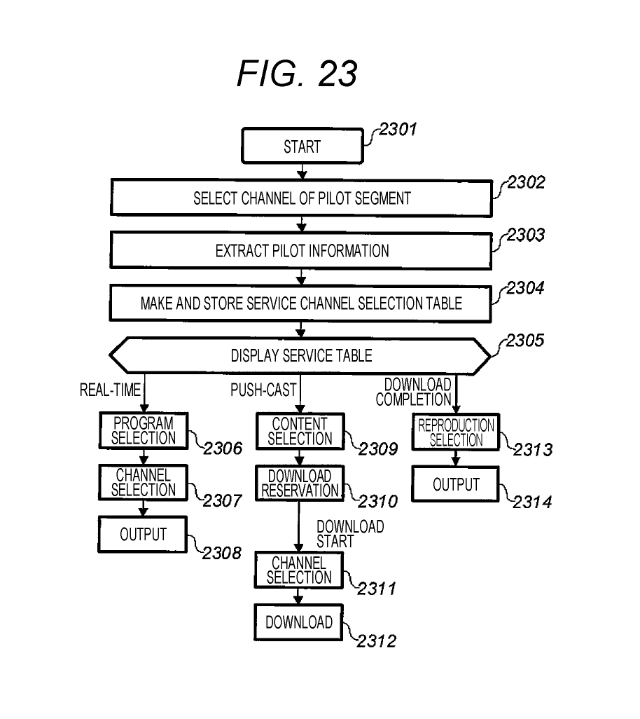

Next, a reception operation in the case of the pilot broadcast, the pilot segment, and the pilot information of FIGS. 16, 17, and 18 will be described using FIGS. 19 and 23.

In step 2301, the reception operation starts. In the reception operation, the CPU 1922 controls each block through the system bus 1921.

In step 2302, first, the channel selecting unit 1902 selects a channel of the pilot segment 1701 or 1702 at a determined frequency position.

In step 2303, the TS is demodulated by the F/E unit 1924, the pilot information of FIGS. 18(a) to 18(c) is extracted by the descramble 1 unit 1928 and the DEMUX unit 1909, and the pilot information is decoded by the system decoding unit 1915.

In step 2304, a service channel selection table is made from the extracted pilot information and the service channel selection table is stored.

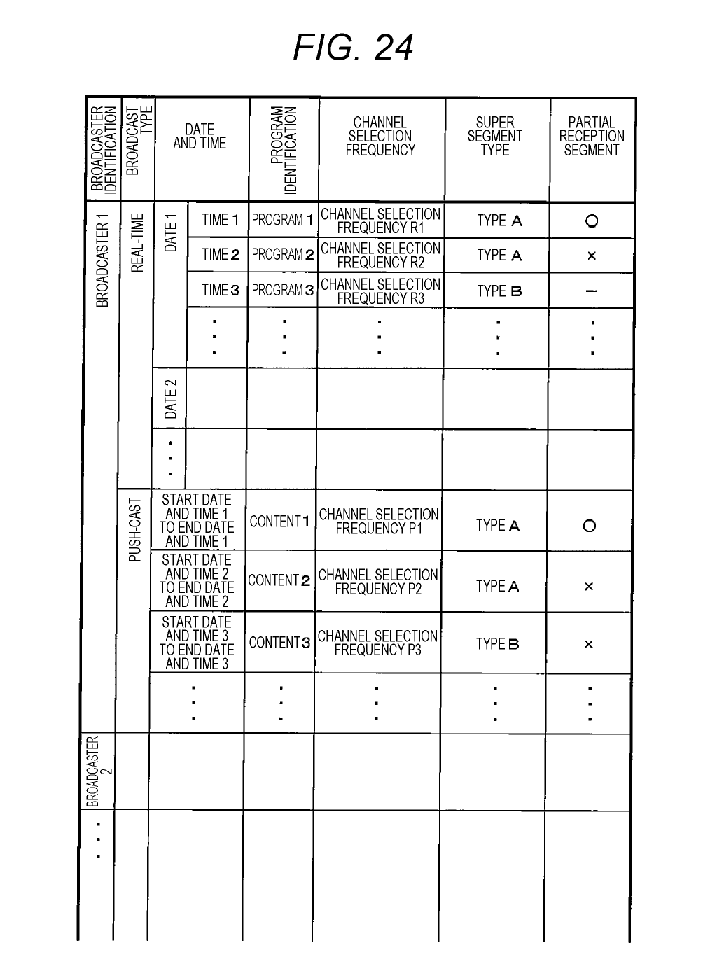

FIG. 24 illustrates an example of the service channel selection table. The service channel selection table is arranged by the broadcaster identification, the broadcast type, the date and time, and the program type and a channel selection frequency and a super segment type are allocated to each program of the real-time broadcast or each content of the push-cast broadcast. The channel selection frequency is the center frequency of the center subchannel. In addition, when the super segment type is a type A (the 13-segment format), it is shown whether the program or the content is at the partial reception hierarchy (“◯”: partial reception hierarchy, “X”: hierarchy other than the partial reception hierarchy).

In step 2305, service tables of the real-time broadcast, the push-cast broadcast, and the download completion are displayed. In general, the service table of the real-time broadcast is preferentially displayed and the service tables of the push-cast broadcast and the download completion are selected by the user on a menu or the like.

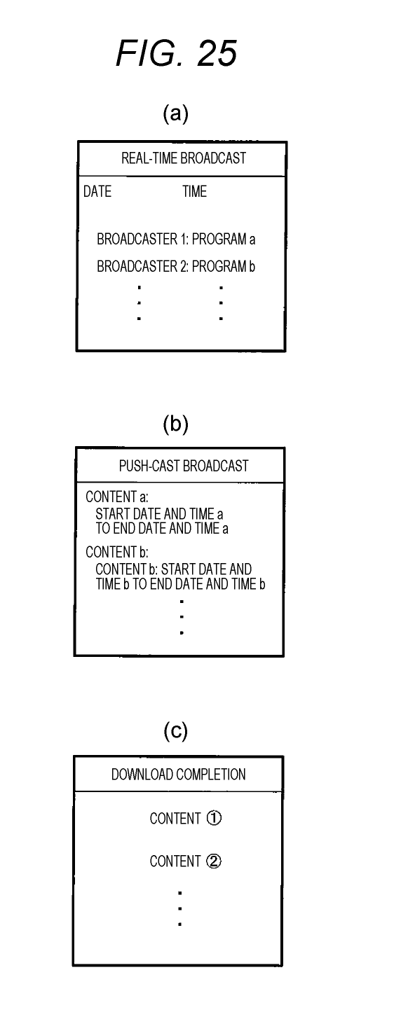

FIGS. 25(a) to 25(c) illustrate an example of the service table. FIG. 25(a) illustrates an example of the case of the real-time broadcast, FIG. 25(b) illustrates an example of the case of the push-cast broadcast, and FIG. 25(c) illustrates an example of the case of the download completion.

In FIG. 25(a), programs broadcasted at a current time are displayed. In the case of the partial reception/1-segment format reception, when the program is transmitted at the hierarchy other than the partial reception segment in the type A (13-segment format), the program cannot be received. Therefore, such a notation is performed such that the program cannot be selected.

In step 2306, a program which the user desires to view is selected. A function of searching a program by a date, a time, and a broadcaster may be provided.

In step 2307, a channel of the selected program is selected. The channel selecting unit 1902 sets the channel selection frequency by the service channel selection table of FIG. 24. When the program is transmitted by reception other than the partial reception in the type A, the channel frequency band is set as the 13-segment band and the F/E unit 1924 performs the 13-segment format demodulation. When the program is transmitted by the partial reception in the type A and when the super segment type is the type B, the channel frequency band is set as the 1-segment band. In the case of the partial reception, the F/E unit 1924 performs the partial reception demodulation and in the case of the type B, the F/E unit 1924 performs the 1-segment format demodulation.

In step 2308, a program is output.

In FIG. 25(b), content downloadable at the present time is displayed. In step 2309, content which the user desires to download is selected. At this time, download completed content is displayed as “download completion”, such that the download completed content cannot be selected.

In step 2310, download reservation is performed. At a download time, in step 2311, the channel selecting unit 1902 sets the content reserved by the service channel selection table of FIG. 24 as the channel selection frequency. When the content is transmitted by reception other than the partial reception in the type A, the channel frequency band is set as the 13-segment band and the F/E unit 1924 performs the 13-segment format demodulation. When the content is transmitted by the partial reception in the type A and when the super segment type is the type B, the channel frequency band is set as the 1-segment band. In the case of the partial reception, the F/E unit 1924 performs the partial reception demodulation and in the case of the type B, the F/E unit 1924 performs the 1-segment format demodulation.

In step 2312, a content is downloaded.

In FIG. 25(c), the download completed content is displayed. In step 2313, reproduction is selected and in step 2314, the content is output. The service table of the download may be selected at the time of the start of step 2301.

According to the digital broadcast reception method of FIGS. 23, 24, and 25(a) to 25(c), there is an effect that the broadcast can be received without considering the segment configuration of the digital broadcast transmission signal.

### Third Embodiment

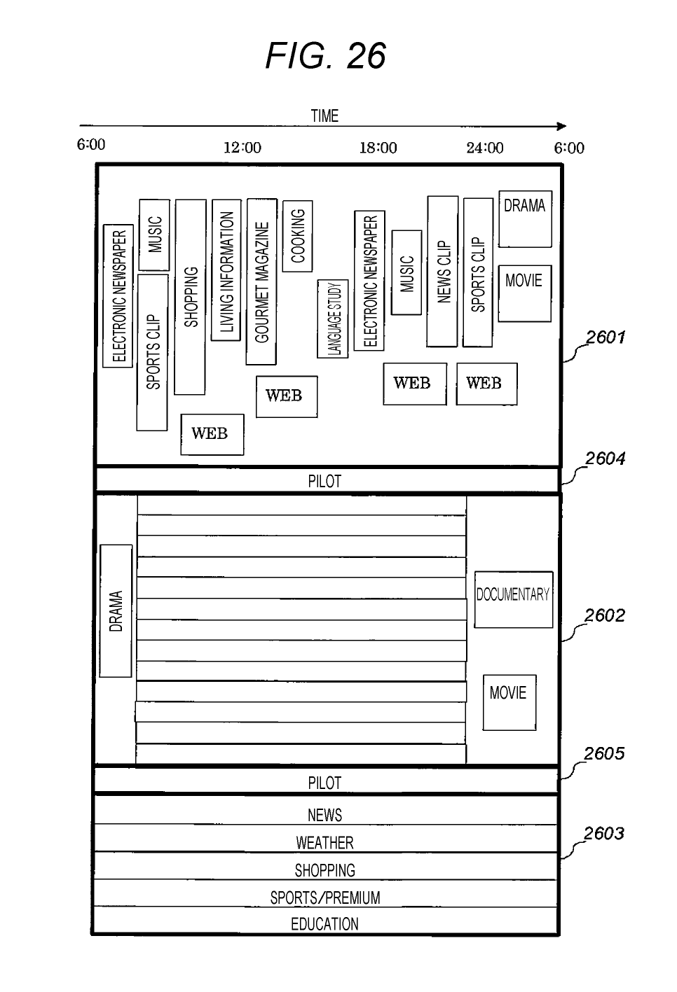

FIG. 26 is a diagram illustrating an embodiment of a service configuration of a digital broadcast transmission signal transmitted by a digital broadcast transmitting device according to a third embodiment of the present invention.

2601 denotes push-cast broadcast, 2602 denotes mixed broadcast of push-cast broadcast and real-time broadcast, 2603 denotes real-time broadcast, 2604 denotes pilot broadcast of the push-cast broadcast, and 2605 denotes pilot broadcast of the real-time broadcast. A difference with FIG. 16 is that the pilot broadcast is provided independently for each of the push-cast broadcast and the real-time broadcast. Similar to FIG. 16, it is necessary to previously determine which frequency arrangement the pilot broadcast 2604 and 2605 are transmitted with.

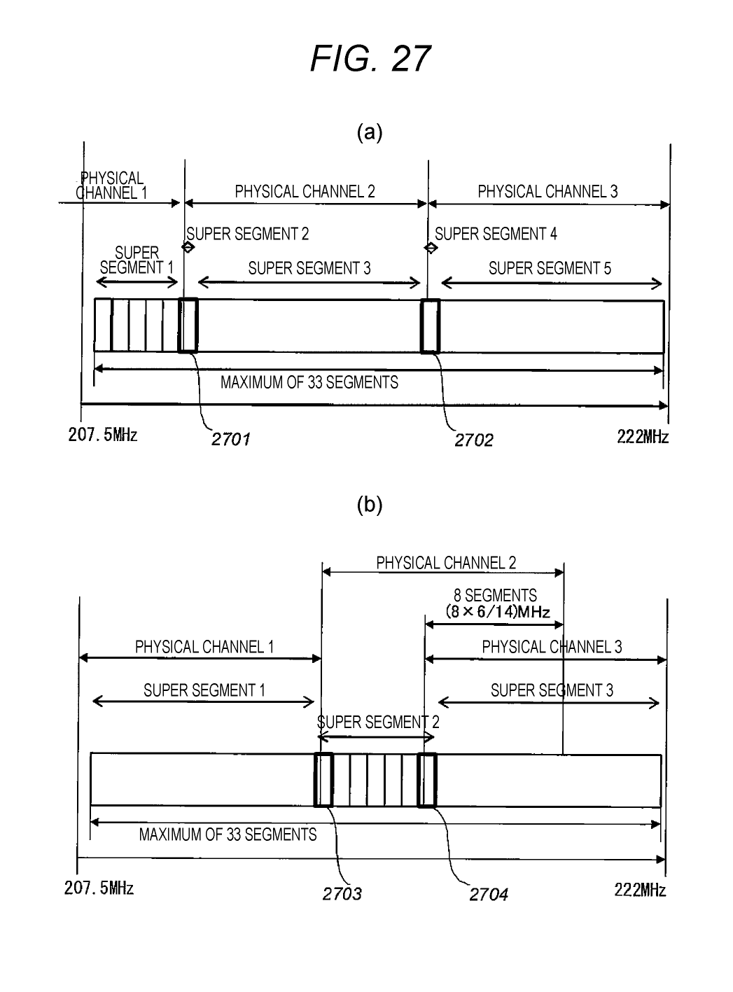

FIGS. 27(a) and 27(b) are diagrams illustrating an embodiment of a segment configuration of a digital broadcast transmission signal transmitted by a digital broadcast transmitting device according to the present invention. FIGS. 27(a) and 27(b) illustrate the segment configuration example described in FIG. 2. In FIG. 27(a), 2701 denotes a pilot segment for the real-time broadcast and 2702 denotes a pilot segment for the push-cast broadcast. In FIG. 27(b), 2703 denotes a pilot segment for the real-time broadcast and 2704 denotes a pilot segment for the push-cast broadcast.

The pilot segment is a segment to transmit the pilot broadcast and is set as a segment of the 1-segment format or a partial reception segment of the 13-segment format. In an example of FIG. 27(a), the pilot segment 2701 for the real-time broadcast is a segment of “super segment 2 and center subchannel number 1” and has a center frequency of (210+ 1/7) MHz and the pilot segment 2702 for the push-cast broadcast is a segment of “super segment 4 and center subchannel number 1” and has a center frequency of (216+ 1/7) MHz. In an example of FIG. 27(b), the pilot segment 2703 for the real-time broadcast is a segment of “super segment 2 and center subchannel number 1” and has a center frequency of (213+ 4/7) MHz and the pilot segment 2704 for the push-cast broadcast is a segment of “super segment 2 and center subchannel number 19” and has a center frequency of (216+ 1/7) MHz. The frequency arrangement is determined at the corresponding position in the examples of FIGS. 27(a) and 27(b).

As an example of the case in which a service of FIG. 26 is allocated to a super segment, the case of FIG. 27(a) is as follows.

Five programs of the real-time broadcast 2603 are allocated to a super segment 1: type B (five 1-segments) in the 1-segment format and TS2 is set as news, TS3 is set as a weather, TS4 is set as shopping, TS5 is set as sports/premium, and TS6 is set as education.

The pilot broadcast 2605 for the real-time broadcast is allocated as the pilot segment for the real-time broadcast is allocated to a super segment 2: type B (one 1-segment) and is set as TS7.

The mixed broadcast 2602 is allocated to a super segment 3: type A (one 13-segment) and is set as TS1.

The pilot broadcast 2604 for the push-cast broadcast is allocated as a pilot segment for the push-cast broadcast to a super segment 4: type B (one 1-segment) and is set as TS8.

The push-cast broadcast 2601 is allocated to a super segment 5: type A (one 13-segment) and is set as TS9.

In addition, the case of FIG. 27(b) is as follows.

The mixed broadcast 2602 is allocated to a super segment 1: type A (one 13-segment) and is set as TS1.

Five programs of the real-time broadcast 2603, the pilot broadcast 2605 for the real-time broadcast, and the pilot broadcast 2604 for the push-cast broadcast are allocated to a super segment 2: type B (seven 1-segments) in the 1-segment format and TS2 is allocated to the pilot broadcast 2605 for the real-time broadcast, TS3 is set as news, TS4 is set as a weather, TS5 is set as shopping, TS6 is set as sports/premium, TS7 is set as education, and TS8 is set as the pilot broadcast 2604 for the push-cast broadcast.

The push-cast broadcast 2601 is allocated to a super segment 3: type A (one 13-segment) and is set as TS9.

The allocation is performed by the multimedia signal generating unit 201 of FIG. 2.

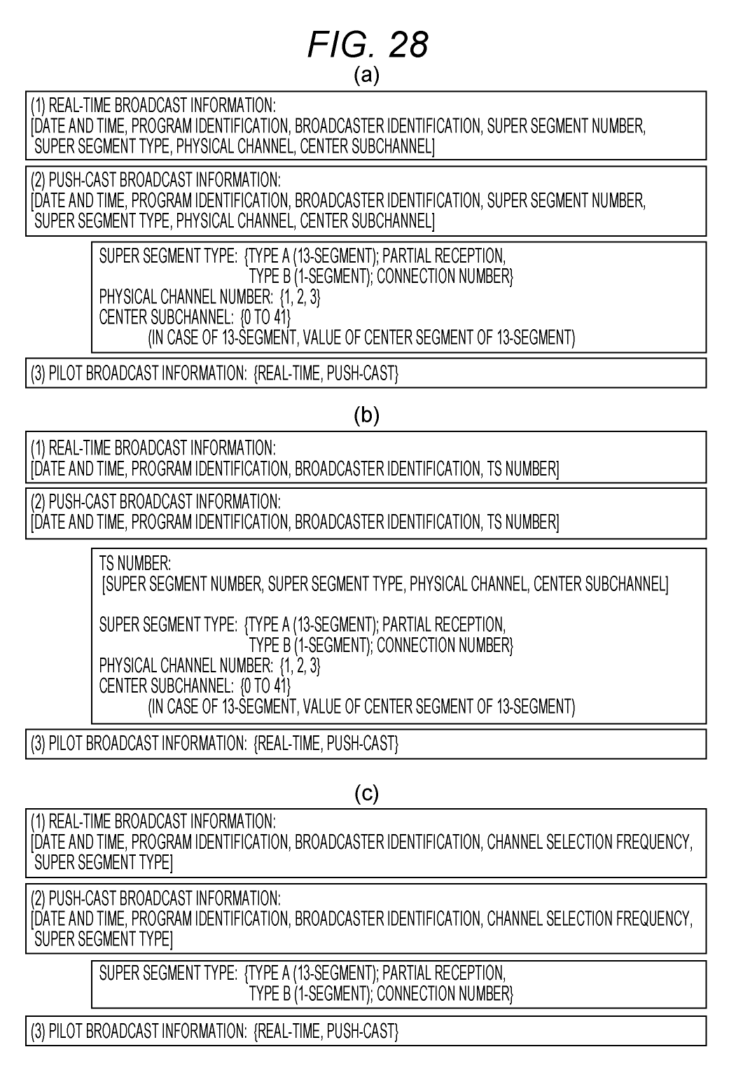

FIGS. 28(a) to 28(c) illustrate a configuration example of program information to be an example of pilot information transmitted by pilot broadcast. A difference with FIGS. 18(a) to 18(c) is that the program information is divided into (1) real-time broadcast information and (2) push-cast broadcast information and the real-time broadcast information and the push-cast broadcast information are transmitted by the pilot broadcast for the real-time broadcast and the pilot broadcast for the push-cast broadcast, respectively. In the example of FIGS. 28(a) to 28(c), (3) pilot broadcast information is provided, the pilot broadcast information is transmitted by the pilot broadcast for the real-time broadcast and the pilot broadcast for the push-cast broadcast, and each information shows whether the broadcast is the pilot broadcast for the real-time broadcast or the pilot broadcast for the push-cast broadcast.

In the examples of FIGS. 27(a) to 28(c), because the program information is divided for the real-time broadcast and the push-cast broadcast, only information of the necessary broadcast selected at that time can be obtained at the reception side and there is an effect that a time necessary until the information is obtained and the service table illustrated in FIGS. 25(a) to 25(c) is built and displayed can be shortened. In addition, the pilot broadcast information is provided, there is an effect that it can be confirmed by the B/E unit 1925 whether the information selected at the present time is for the real-time broadcast or the push-cast broadcast.

In addition, in the segment arrangement of FIGS. 27(a) and (b), the push-cast broadcast and the pilot broadcast for the push-cast broadcast, the mixed broadcast and the pilot broadcast for the real-time broadcast, the real-time broadcast and the pilot broadcast for the real-time broadcast, and the mixed broadcast and the pilot broadcast for the push-cast broadcast in FIG. 27(a) are arranged to be adjacent to each other. Therefore, there is an effect that the broadcast and the pilot broadcast of each service can be collectively received easily at the reception side.

### Fourth Embodiment

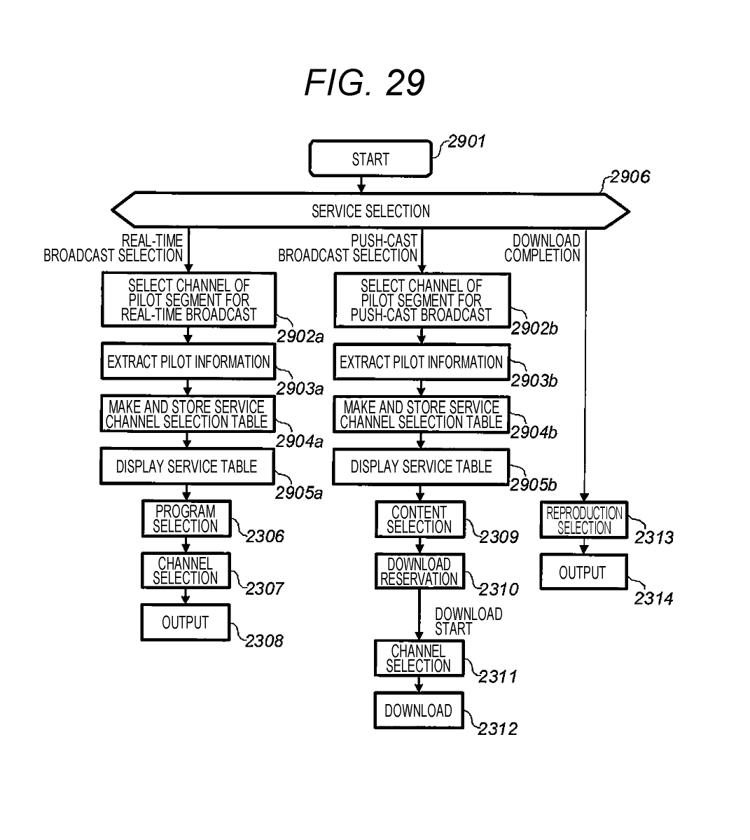

FIG. 29 is a flowchart illustrating a reception operation of the digital broadcast receiving device 1926 according to a fourth embodiment of the present invention.

A reception operation in the case of the pilot broadcast, the pilot segment, and the pilot information of FIGS. 26 to 28(c) will be described using FIGS. 19 and 29. The same reference numerals as FIG. 23 denote the same functions.

In step 2901, the reception operation starts. In the reception operation, the CPU 1922 controls each block through the system bus 1921.

In step 2906, first, the real-time broadcast, the push-cast broadcast, and the download completion are selected.

When the download completion is selected, the downloaded content of FIG. 25(c) is displayed, reproduction is selected in step 2313, and the content is output in step 2314.

When the real-time broadcast or the push-cast broadcast is selected, steps 2902a, 2903a, 2904a, 2905a, 2306, 2307, and 2308 are selected in the case of the real-time broadcast and steps 2902b, 2903b, 2904b, 2905b, 2309, and 2310 are selected in the case of the push-cast broadcast.

First, the case in which the real-time broadcast is selected will be described.

In step 2902a, first, the channel selecting unit 1902 selects a channel of the pilot segment 2701 or 2703 for the real-time broadcast at a determined frequency position. From the pilot broadcast information, it can be confirmed that the pilot segment is the pilot segment for the real-time broadcast.

In step 2903a, the TS is demodulated by the F/E unit 1924, the real-time broadcast information to be the pilot information for the real-time broadcast in FIGS. 28(a) to 28(c) is extracted by the descramble 1 unit 1928 and the DEMUX unit 1909, and the real-time broadcast information is decoded by the system decoding unit 1915.

In step 2904a, a service channel selection table for the real-time broadcast is made from the extracted real-time broadcast information and the service channel selection table is stored.

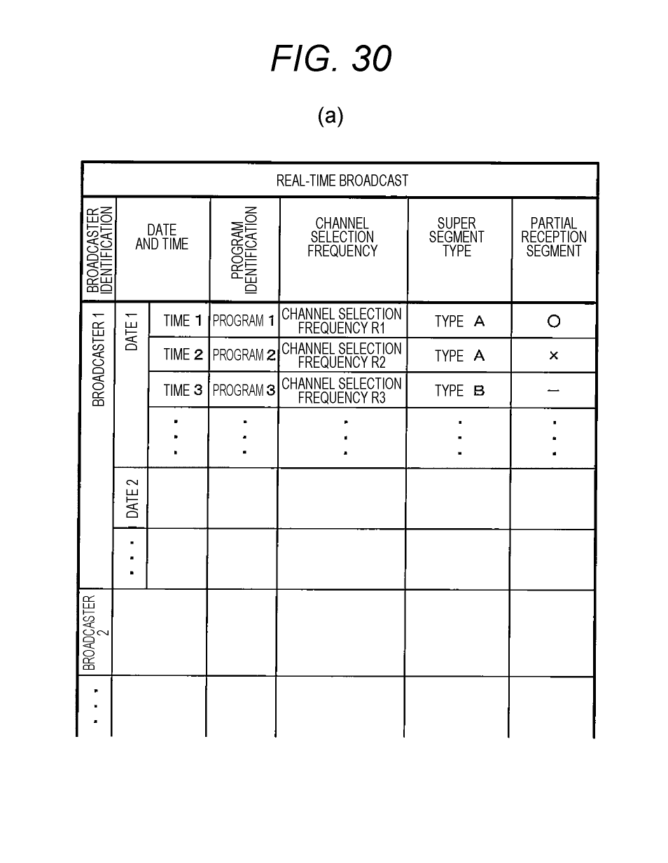

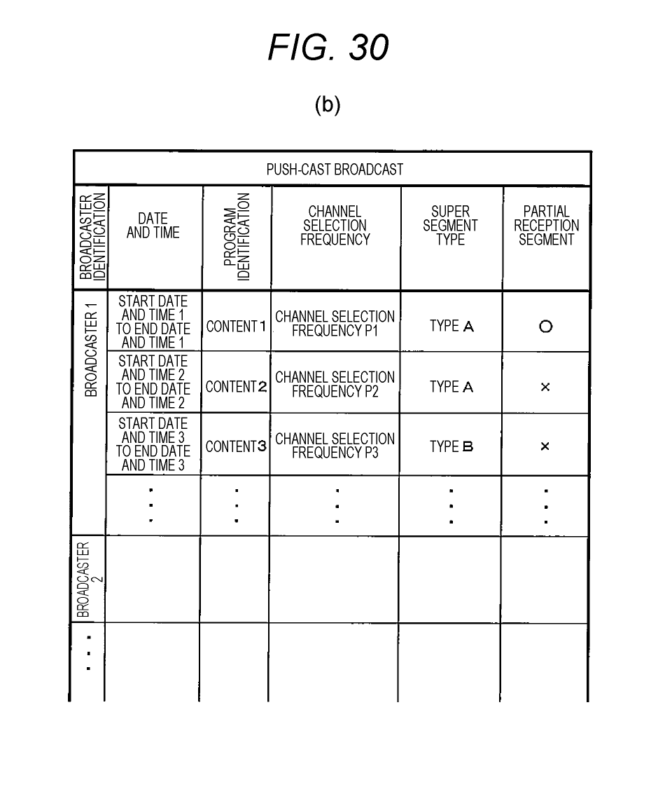

FIG. 30(a) illustrates an example of the service channel selection table for the real-time broadcast. The service channel selection table is arranged by the broadcaster identification, the date and time, and the program type and the program type and a channel selection frequency and a super segment type are allocated to each program of the real-time broadcast. The channel selection frequency is the center frequency of the center subchannel. In addition, when the super segment type is a type A (the 13-segment format), it is shown whether the program or the content is at the partial reception hierarchy (“◯”: partial reception hierarchy, “X”: hierarchy other than the partial reception hierarchy).

In step 2905a, a service table of the real-time broadcast is displayed.

FIG. 25(a) illustrates an example of the service table for the real-time broadcast. The following are as described with reference to FIG. 23.

Next, the case in which the push-cast broadcast is selected will be described.

In step 2902b, first, the channel selecting unit 1902 selects a channel of the pilot segment 2702 or 2704 for the push-cast broadcast at a determined frequency position. From the pilot broadcast information, it can be confirmed that the pilot segment is the pilot segment for the push-cast broadcast.

In step 2903b, the TS is demodulated by the F/E unit 1924, the push-cast broadcast information to be the pilot information for the push-cast broadcast in FIGS. 28(a) to 28(c) is extracted by the descramble 1 unit 1928 and the DEMUX unit 1909, and the push-cast broadcast information is decoded by the system decoding unit 1915.

In step 2904a, a service channel selection table for the push-cast broadcast is made from the extracted push-cast broadcast information and the service channel selection table is stored.

FIG. 30(b) illustrates an example of the service channel selection table for the push-cast broadcast. The service channel selection table is arranged by the broadcaster identification, the date and time, and the program type and the program type and a channel selection frequency and a super segment type are allocated to each program of the push-cast broadcast. The channel selection frequency is the center frequency of the center subchannel. In addition, when the super segment type is a type A (the 13-segment format), it is shown whether the program or the content is at the partial reception hierarchy (“◯”: partial reception hierarchy, “X”: hierarchy other than the partial reception hierarchy).

In step 2905b, a service table of the push-cast broadcast is displayed.

FIG. 25(b) illustrates an example of the service table for the push-cast broadcast. The following are as described with reference to FIG. 23.

According to the digital broadcast reception method of FIGS. 29 to 30(b), there is an effect that the broadcast can be received without considering the segment configuration of the digital broadcast transmission signal. In addition, because the program information is divided for the real-time broadcast and the push-cast broadcast, only information of the necessary broadcast selected at that time can be obtained at the reception side and there is an effect that a time necessary until the information is obtained and the service table illustrated in FIGS. 25(a) to 25(c) is built and displayed can be shortened. In addition, the pilot broadcast information is provided, there is an effect that it can be confirmed by the B/E unit 1925 whether the information selected at the present time is for the real-time broadcast or the push-cast broadcast.

In addition, when the channel of the pilot segment is selected by steps 2902a and 2902b, the push-cast broadcast and the pilot broadcast for the push-cast broadcast, the mixed broadcast and the pilot broadcast for the real-time broadcast, the real-time broadcast and the pilot broadcast for the real-time broadcast, and the mixed broadcast and the pilot broadcast for the push-cast broadcast in FIG. 27(a) are arranged to be adjacent to each other. Therefore, when the broadcast and the pilot broadcast of each service can be collectively received easily at the reception side, there is an effect that a time of channel selection in step 2307 or channel selection at the time of download can be shortened.

### Fifth Embodiment

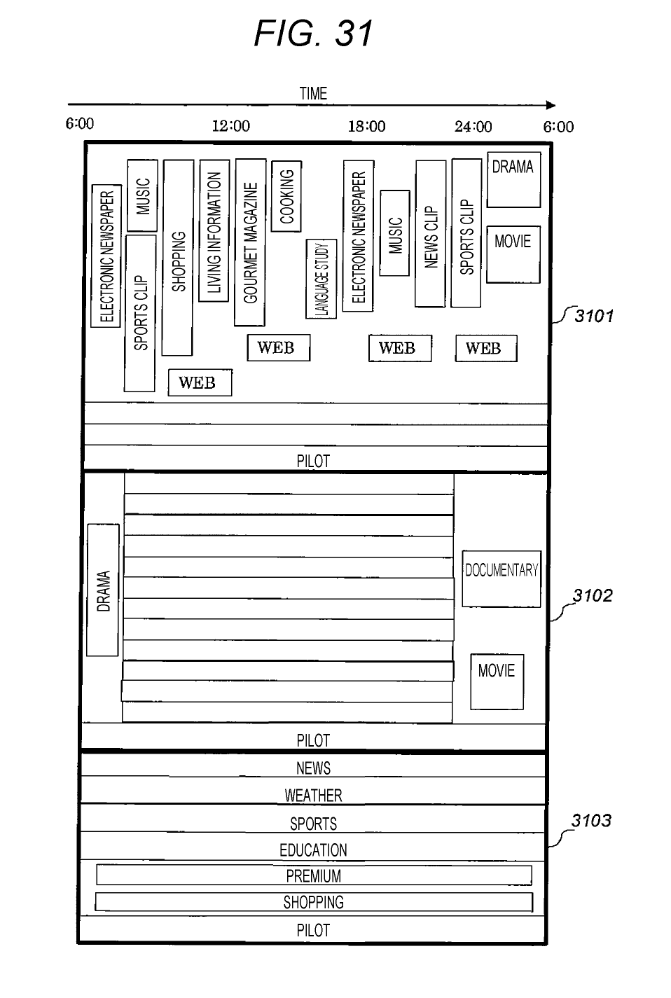

FIG. 31 is a diagram illustrating an embodiment of a service configuration of a digital broadcast transmission signal transmitted by a digital broadcast transmitting device according to a fifth embodiment of the present invention.

3101, 3102, and 3103 denote broadcast service groups that include push-cast broadcast, real-time broadcast, and pilot broadcast having pilot information of the broadcast. A difference with FIG. 16 is that a broadcast service group to perform mixed broadcast basically is configured without dividing the broadcast into the push-cast broadcast, the mixed broadcast, and the real-time broadcast is provided, the pilot broadcast is included in the broadcast service group, and the pilot broadcast has the pilot information of the broadcast in the service group thereof.

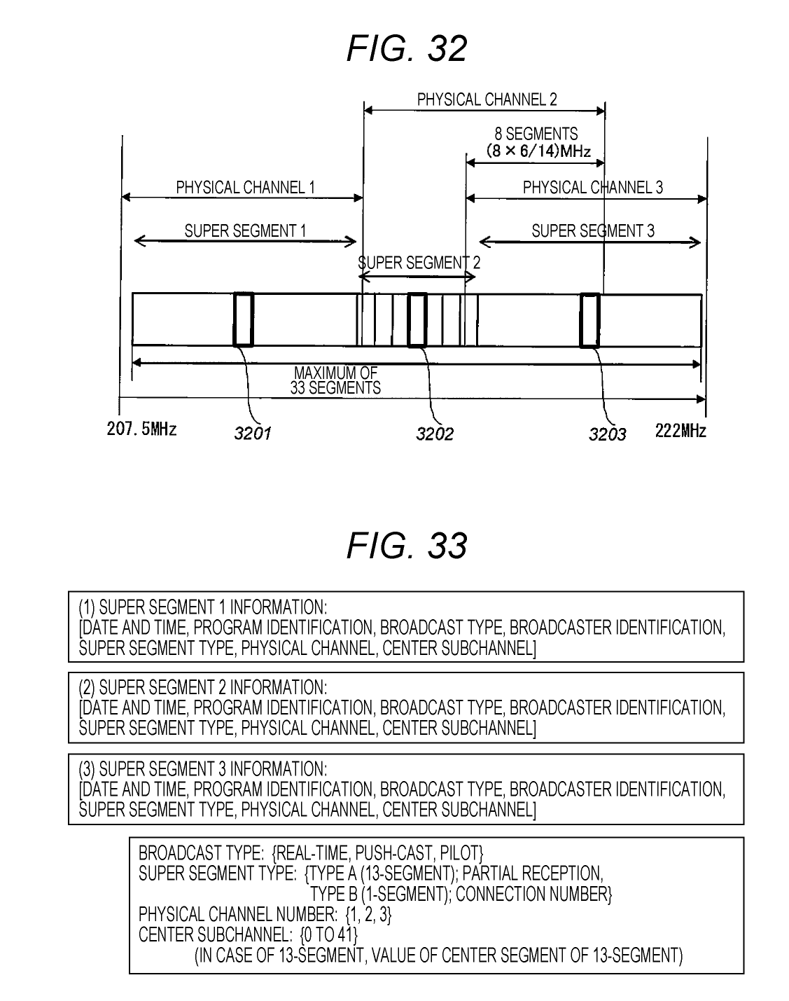

FIG. 32 is a diagram illustrating an embodiment of a segment configuration of a digital broadcast transmission signal transmitted by a digital broadcast transmitting device according to the present invention. FIGS. 27(a) and 27(b) illustrate the segment configuration example described in FIGS. 4(b) and 3201 denotes a pilot segment of the broadcast service group 3101, 3202 denotes a pilot segment of the broadcast service group 3103, and 3203 denotes a pilot segment of the broadcast service group 3102.

The pilot segment is a segment to transmit the pilot broadcast and is set as a segment of the 1-segment format or a partial reception segment of the 13-segment format. In an example of FIG. 32, the pilot segment 3201 of the broadcast service group 3101 is a partial reception segment of the 13-segment format of “super segment 1 and center subchannel number 22” and has a center frequency of (210+ 4/7) MHz, the pilot segment 3202 of the broadcast service group 3103 is a segment of “super segment 2 and center subchannel number 10” and has a center frequency of (214+ 6/7) MHz, and the pilot segment 3203 of the broadcast service group 3102 is a partial reception segment of the 13-segment format of “super segment 3 and center subchannel number 22” and has a center frequency of (219+ 1/7) MHz. The frequency arrangement is determined at the corresponding position in the example of FIG. 32.

An example of the case in which a service of FIG. 31 is allocated to a super segment of FIG. 32 is as follows.

The broadcast service group 3101 is allocated to a super segment 1: type A (one 13-segment) and is set as TS1.

The broadcast service group 3103 is allocated to a super segment 2: type B (seven 1-segments) in the 1-segment format and TS2 is set as news (real-time broadcast), TS3 is set as a weather (real-time broadcast), TS4 is set as sports (real-time broadcast), TS5 is set as the pilot broadcast, TS6 is set as education (real-time broadcast), TS7 is set as shopping (push-cast broadcast), and TS8 is set as a premium (push-cast broadcast).

The broadcast service group 3102 is allocated to a super segment 3: type A (one 13-segment) and is set as TS9.

That is, each broadcast service group is allocated to a super segment. The allocation is performed by the multimedia signal generating unit 201 of FIG. 2.

FIG. 33 illustrates a configuration example of program information to be an example of pilot information transmitted by pilot broadcast. A difference with FIGS. 18(a) to 18(c) is that the program information is divided into (1) super segment 1 information, (2) super segment 2 information, and (3) super segment 3 information and broadcast information in each super segment is transmitted by pilot broadcast in each super segment.

In the examples of FIGS. 32 and 33, the broadcast service group is allocated to the super segment, a pilot segment to perform the pilot broadcast is provided for each super segment, and program information is transmitted. As a result, because the program information may be managed in a super segment unit at the reception side, only information of the necessary super segment selected at that time can be obtained and there is an effect that a time necessary until the information is obtained and the service table illustrated in FIGS. 25(a) to 25(c) is built and displayed can be shortened.

In addition, in the segment arrangement of FIG. 32, a receiving device in which reception of the 13-segment format is enabled receives the super segment of the type A of the super segment 1 or the super segment 3 and a receiving device in which reception of the 1-segment format where the segments are connected in a super segment unit is enabled collectively receives the super segment 2, there is an effect that a program can be selected in only the super segment received using the pilot broadcast in the super segment.

In addition, because the pilot broadcast (pilot segment) is arranged at a partial reception hierarchy of the type A (the 13-segment format), there is an effect that the receiving device of the 1-segment format can also receive the pilot broadcast (pilot segment) of the service group of the super segment of the type A.

### Sixth Embodiment

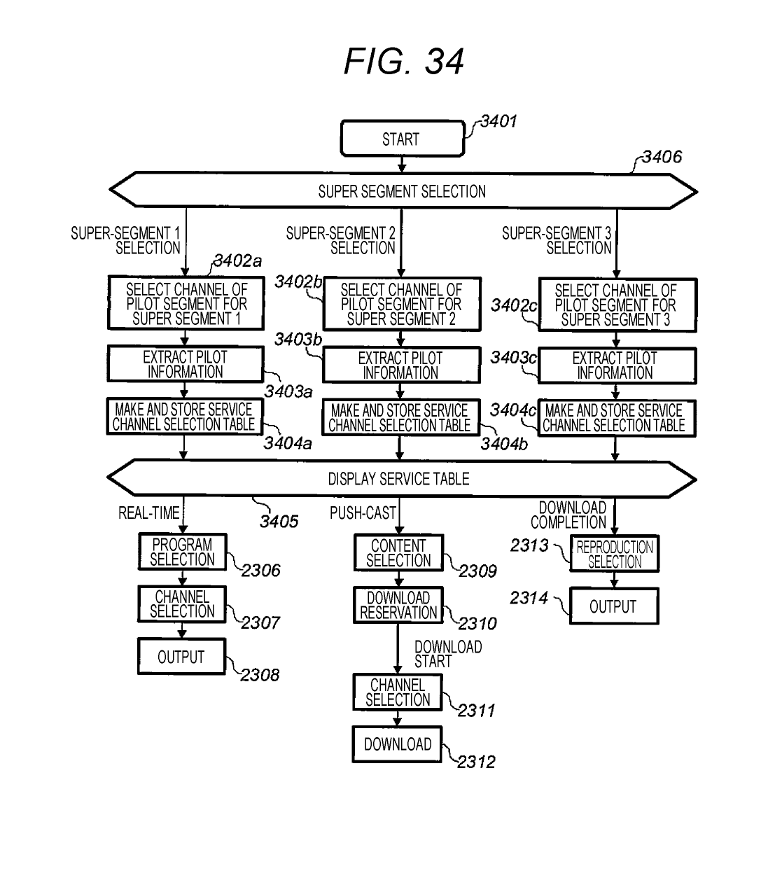

FIG. 34 is a flowchart illustrating a reception operation of a digital broadcast receiving device 1926 according to a sixth embodiment of the present invention.

A reception operation in the case of the pilot broadcast, the pilot segment, and the pilot information of FIGS. 31 to 33 will be described using FIGS. 19 and 34. The same reference numerals as FIG. 23 denote the same functions.

In step 3401, the reception operation starts. In the reception operation, the CPU 1922 controls each block through the system bus 1921.

In step 3406, first, the super segment is selected. In the example of FIG. 32, three super segments exist. Here, the super segments may be allocated to broadcasters and the broadcasters may be selected on a menu.

After any one of super segments 1, 2, and 3 is selected, the super segments are allocated to a, b, and c systems of steps 3402, 3403, and 3404. Because the operation is the same, explanation is given while suffixes of 1, 2, and 3 and a, b, and c are omitted.

After the super segment is selected, in step 3402, first, the channel selecting unit 1902 selects a channel of a pilot segment (the super segment 1 is 3201, the super segment 2 is 3202, and the super segment 3 is 3203) at a determined frequency position of the selected super segment.

In step 3403, the TS is demodulated by the F/E unit 1924, the super segment information to be the pilot information of FIG. 33 is extracted by the descramble 1 unit 1928 and the DEMUX unit 1909, and the super segment information is decoded by the system decoding unit 1915.

In step 3404, a service channel selection table for each super segment is made from the extracted super segment information and the service channel selection table is stored.

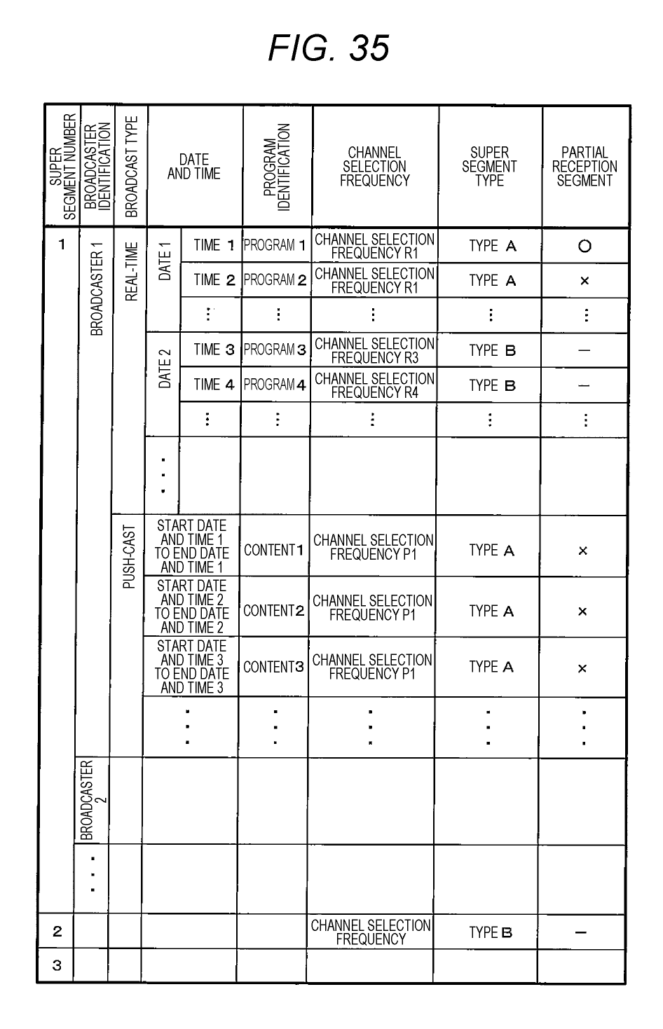

FIG. 35 illustrates an example of the service channel selection table. The service channel selection table is arranged by the broadcaster identification, the broadcast type, the date and time, and the program type for each super segment and a channel selection frequency and a super segment type are allocated to each program. The channel selection frequency is the center frequency of the center subchannel. In addition, when the super segment type is a type A (the 13-segment format), it is shown whether the program or the content is at the partial reception hierarchy (“◯”: partial reception hierarchy, “X”: hierarchy other than the partial reception hierarchy).

In step 3405, service tables of the real-time broadcast, the push-cast broadcast, and the download completion are displayed. In general, the service table of the real-time broadcast is preferentially displayed and a user selects the service tables of the push-cast broadcast and the download completion on a menu.

FIGS. 25(a) to 25(c) illustrate an example of the service table. FIG. 25(a) illustrates an example of the case of the real-time broadcast, FIG. 25(b) illustrates an example of the case of the push-cast broadcast, and FIG. 25(c) illustrates an example of the case of the download completion. The following are as described with reference to FIG. 23.

According to the digital broadcast reception method of FIGS. 34 and 35, there is an effect that the broadcast can be received without considering the segment configuration of the digital broadcast transmission signal. In addition, because the broadcast service group is allocated to a super segment, a pilot segment to perform pilot broadcast is provided for each super segment, and program information is transmitted, the program information may be managed in a super segment unit. Therefore, only information of the necessary super segment selected at that time can be obtained and there is an effect that a time necessary until the information is obtained and the service table illustrated in FIGS. 25(a) to 25(c) is built and displayed can be shortened.

In addition, in the segment arrangement of FIG. 32, a receiving device in which reception of the 13-segment format is enabled receives the super segment of the type A of the super segment 1 or the super segment 3 and a receiving device in which reception of the 1-segment format where the segments are connected in a super segment unit is enabled collectively receives the super segment 2. Therefore, there is an effect that a program can be selected in only the super segment received using the pilot broadcast in the super segment.

In addition, because the pilot broadcast (pilot segment) is arranged at a partial reception hierarchy of the type A (the 13-segment format), there is an effect that the receiving device of the 1-segment format can also receive the pilot broadcast (pilot segment) of the service group of the super segment of the type A.

### Seventh Embodiment

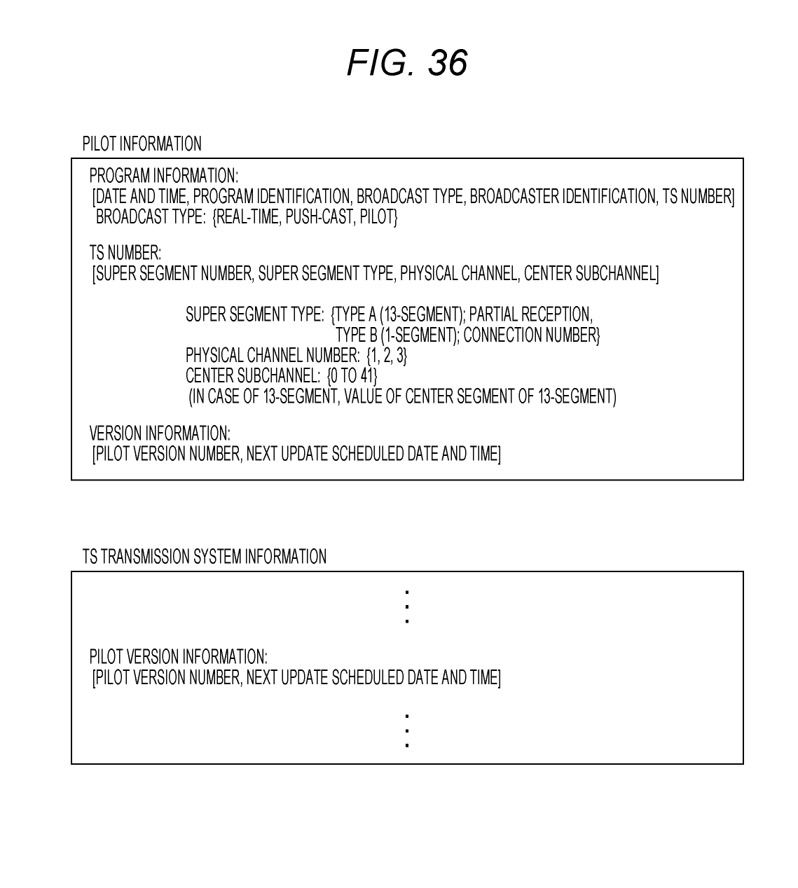

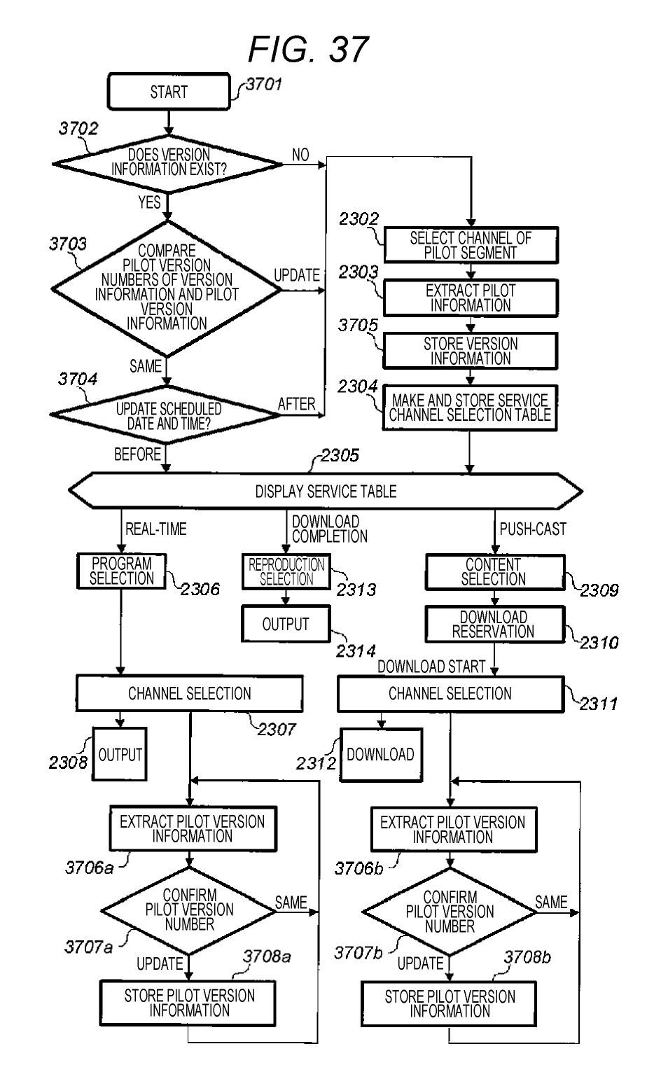

FIG. 36 is a diagram illustrating an embodiment of pilot information of a digital broadcast transmission signal transmitted by a digital broadcast transmitting device according to a seventh embodiment of the present invention.

The pilot information of FIG. 36 includes version information in addition to the program information of FIG. 18(b). The version information is provided with a pilot version number and a next update scheduled date and time.

In the pilot version number, the number is increased by one when the pilot information changes. When the pilot version number reaches a full scale, the pilot version number returns to zero.

The next update scheduled date and time shows a date and time when a change of the pilot information is subsequently scheduled.

Next, TS transmission system information will be described. This information is transmitted by a TS of broadcast other than the pilot broadcast and the pilot version information is provided in the information in the example of FIG. 36. The pilot version information is the same content as the version information of the pilot information.

According to the example of the pilot information of FIG. 36, the version information is provided, there is an effect that a version of the pilot information can be managed at the reception side. In addition, the next update scheduled date and time is provided, there is an effect that a receiver can prepare for the next update. In addition, the pilot version information is provided as TS transmission system information in the TS of the broadcast other than the pilot broadcast. For this reason, when the pilot broadcast is not received and the real-time broadcast or the push-cast broadcast other than the pilot broadcast is received, there is an effect that the version information of the pilot broadcast can be obtained from the received TS.

In this embodiment, the version information is added to the pilot information of FIG. 18(b). However, the version information may be added to the pilot information of FIGS. 18(a) and 18(c), 28(a) to 28(c), and 33.

### Eighth Embodiment

FIG. 37 is a flowchart illustrating a reception operation of a digital broadcast receiving device 1926 according to an eighth embodiment of the present invention.

The reception operation of the case of the pilot information of FIG. 36 will be described using FIGS. 19 and 37. The same reference numerals as FIG. 23 denote the same functions.

In step 3701, a reception operation starts. In the reception operation, the CPU 1922 controls each block through the system bus 1921.

In step 3702, it is confirmed whether the version information of the pilot information is obtained in the digital broadcast receiving device 1926.

When the version information of the pilot information is obtained, in step 3703, pilot version numbers of the version information of the pilot information and the pilot version information of the TS transmission system are compared. When the pilot version numbers are the same, in step 3704, the update scheduled date is confirmed. When the current date is before the update scheduled date, it is determined that the service channel selection table is the same as the previously made service channel selection table and the service table is displayed in step 2305.

In step 3702, when the version information is not obtained, the case in which the digital broadcast receiving device 1926 first starts and the case in which a system reset is applied are considered. In this case, because the service channel selection table is not yet made, the service channel selection table is made after step 2302.

In step 3703, when the pilot version number of the pilot version information of the TS transmission system information is updated earlier than the pilot version number of the version information of the pilot information, the pilot information is updated. For this reason, the service channel selection table also needs to be updated and the service channel selection table is updated after step 2302.

In step 3704, when the current date is after the update scheduled date, the pilot information is updated. For this reason, the service channel selection table also needs to be updated and the service channel selection table is updated after step 2302.

The operations of steps 2302 and 2303 are as described in FIG. 23. In step 2303, the version information is also extracted as the pilot information and in step 3705, the version information is stored. Then, in step 2304, the service channel selection table is made or updated and is stored. In addition, in step 2305, the service table is displayed.

Operations of steps 2306, 2307, and 2308 when the real-time broadcast is selected in step 2305, operations of steps 2309, 2310, 2311, and 2312 when the push-cast broadcast is selected in step 2305, and operations of steps 2313 and 2314 when the download completion is selected in step 2305 are as described in FIG. 23.

In FIG. 37, after the channel selection and the demodulation of the real-time broadcast and the push-cast broadcast are performed by steps 2307 and 2311, respectively, a process for extracting the pilot version information and storing the pilot version information is performed. The real-time broadcast is processed by steps 3706a, 3707a, and 3708a and the push-cast broadcast is processed by steps 3706b, 3707b, and 3708b. Because the individual operations are the same, the operations are described while suffixes a and b are omitted.

In step 3706, the pilot version information is extracted is extracted from the TS transmission system information of FIG. 36 in the TS demodulated by step 2307 by the descramble 1 unit 1928 and the DEMUX unit 1909 and the pilot version information is decoded by the system decoding unit 1915.

In step 3707, the pilot version number of the pilot version information is confirmed. When the pilot version number is updated as compared with the previously stored pilot version number or the previously stored pilot version number does not exist, the process proceeds to step 3708.

In step 3708, the pilot version number of the pilot version information is stored and the process returns to step 3706.

As the confirmation result of the pilot version number of the pilot version information in step 3707, when the pilot version number is the same as the previously stored pilot version number, the process returns to step 3706.

In this way, steps 3706, 3707, and 3708 are repeated and the pilot version information is updated with the latest pilot version information at all times.

According to the digital broadcast reception method of FIG. 37, there is an effect that the broadcast can be received without considering the segment configuration of the digital broadcast transmission signal. In addition, the version of the pilot information is managed using the version information, there is an effect that the service table can be quickly displayed, when the pilot version number is the same (the pilot version number is not updated) and the current date is the update scheduled date. In addition, the pilot version information is provided as the TS transmission system information in the TS of the broadcast other than the pilot broadcast. For this reason, when the pilot broadcast is not received and the real-time broadcast or the push-cast broadcast other than the pilot broadcast is received, there is an effect that the pilot version information can be obtained from the received TS and the update confirmation of the pilot information can be performed.

### Ninth Embodiment

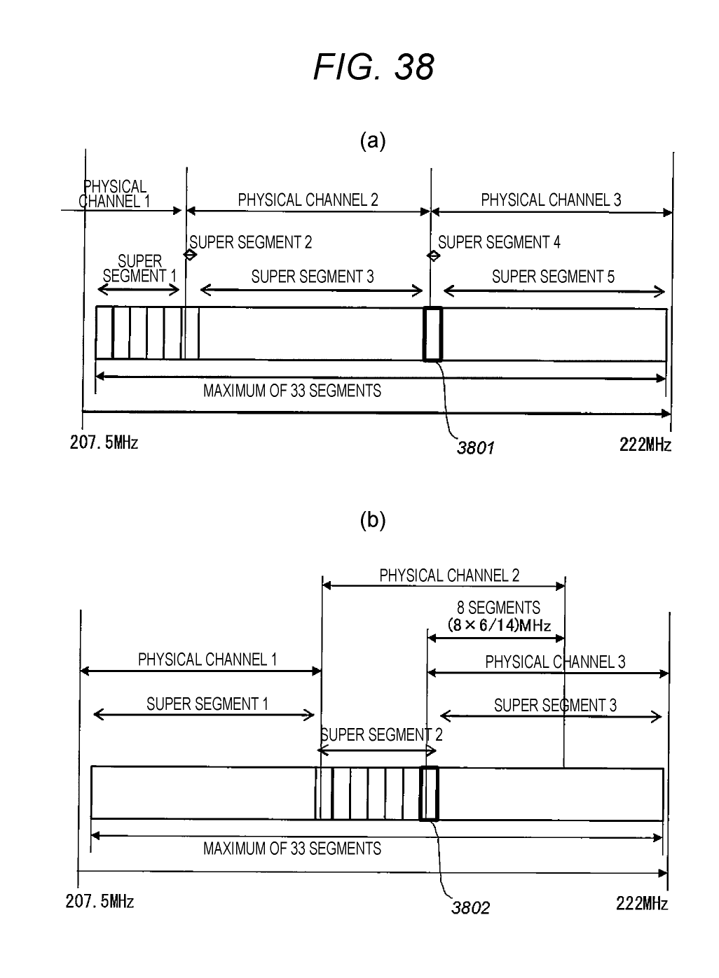

FIGS. 38(a) and 38(b) are diagrams illustrating an embodiment of a segment configuration of a digital broadcast transmission signal transmitted by a digital broadcast transmitting device according to a ninth embodiment of the present invention. FIGS. 38(a) and 38(b) illustrate the segment configuration example descried in FIGS. 4(a) and 4(b). In FIGS. 38(a) and 38(b), 3801 and 3802 denote pilot segments in the segment configuration examples.

The pilot segment is a segment to transmit pilot broadcast and is set as a segment of the 1-segment format or a partial reception segment of the 13-segment format. A difference of FIGS. 38(a) and 38(b) with the segment configuration example of FIGS. 17(a) and 17(b) is that the frequency arrangement of the pilot segment is matched in FIGS. 38(a) and 38(b).

In the example of FIG. 38(a), the pilot segment 3801 is a segment of “super segment 4 and center subchannel number 1” and has a center frequency of (216+ 1/7) MHz. In the example of FIG. 38(b), the pilot segment 3802 is a segment of “super segment 2 and center subchannel number 19” and has a center frequency of (216+ 1/7) MHz. In FIGS. 38(a) and 38(b), the frequency arrangement of the pilot segment is the same. The frequency arrangement is determined at the corresponding position in the examples of FIGS. 38(a) and 38(b).

As an example of the case in which a service of FIG. 16 is allocated to a super segment, the case of FIG. 38(a) is as follows.

Five programs of the real-time broadcast 1603 are allocated to a super segment 1: type B (five 1-segments) in the 1-segment format and TS2 is set as news, TS3 is set as a weather, TS4 is set as shopping, TS5 is set as sports, and TS6 is set as education.

One program of the real-time broadcast 1603 is allocated to a super segment 2: type B (one 1-segment) in the 1-segment format and TS7 is set as a premium.

The push-cast broadcast 1601 is allocated to a super segment 3: type A (one 13-segment) and is set as TS1.

The pilot broadcast 1604 is allocated as a pilot segment to a super segment 4: type B (one 1-segment) and is set as TS8.

The mixed broadcast 1602 is allocated to a super segment 5: type A (one 13-segment) and is set as TS9.

In addition, the case of FIG. 38(b) is as follows.

The push-cast broadcast 1601 is allocated to a super segment 1: type A (one 13-segment) and is set as TS1.

Six programs of the real-time broadcast 1603 and the pilot broadcast 1604 to be a pilot segment are allocated to a super segment 2: type B (seven 1-segments) in the 1-segment format and TS2 is set as news, TS3 is set as a weather, TS4 is set as shopping, TS5 is set as sports, TS6 is set as education, TS7 is set as a premium, and TS8 is set as the pilot broadcast 1604.

The mixed broadcast 1602 is allocated to a super segment 3: type A (one 13-segment) and is set as TS9.

As described above, in the cases of FIGS. 38(a) and 38(b), the broadcast at the TS level is the same. In addition, the allocation is performed by the multimedia signal generating unit 201 of FIG. 2.

In the example of FIG. 38(a), one type B super segment of the 1-segment format is set as a pilot segment and in the example of FIG. 17(b), one segment of seven connected type B super segments of the 1-segment format is set as a pilot segment. Therefore, the example of FIG. 38(a) is suitable for the case in which a process is performed in a super segment unit and the example of FIG. 38(b) is suitable for the case in which a process is performed in a TS unit.

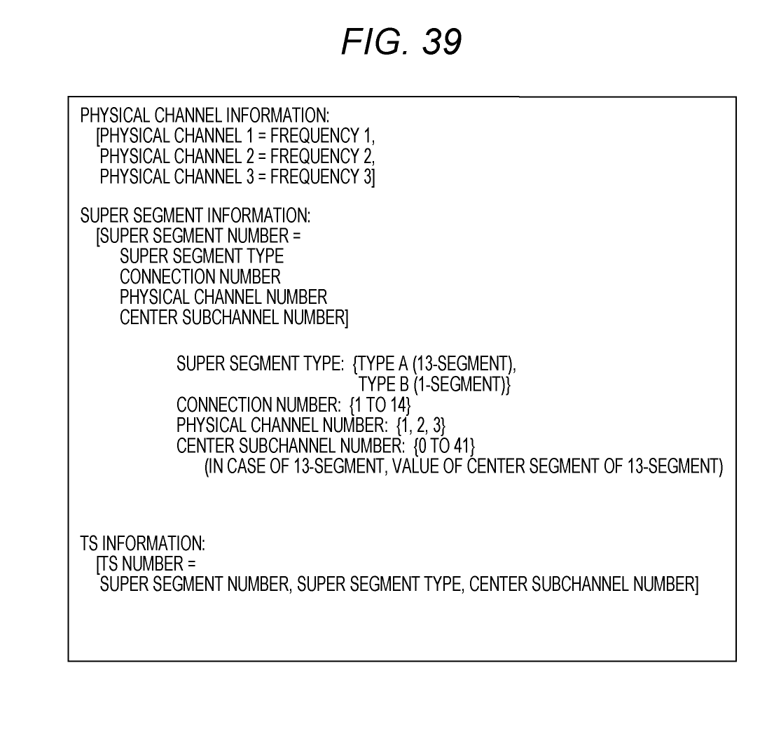

FIG. 39 illustrates an example of the pilot information transmitted by the pilot broadcast.

Physical channel information defines frequencies of three physical channels of physical channels 1, 2, and 3. The frequencies of the physical channels may be shown by a start frequency to an end frequency. Because a physical channel bandwidth is determined as 6 MHz, the frequencies of the physical channels may be defined by start, end, and center frequencies. In addition, frequency positions of the physical channels may be defined by overlapping a partial band. In this case, a frequency bandwidth of the overlapped portion becomes an integral multiple of 6/14 MHz.

In the super segment information, a super segment number and a super segment configuration are connected. The super segment information shows a super segment type {type A (13-segment) and type B (1-segment)}, a connection number, a physical channel number {1, 2, 3}, and a center subchannel number {0 to 41} (a value of a center segment of the 13-segment in the case of the 13-segment) and the super segment configuration and a frequency arrangement thereof are determined.

In TS information, a TS number (refer to FIG. 2) and the super segment configuration are connected. When the super segment number, the super segment type, and the center subchannel number are known, a transmission segment of the TS number can be fixed. As a result, a transmission frequency arrangement is known.

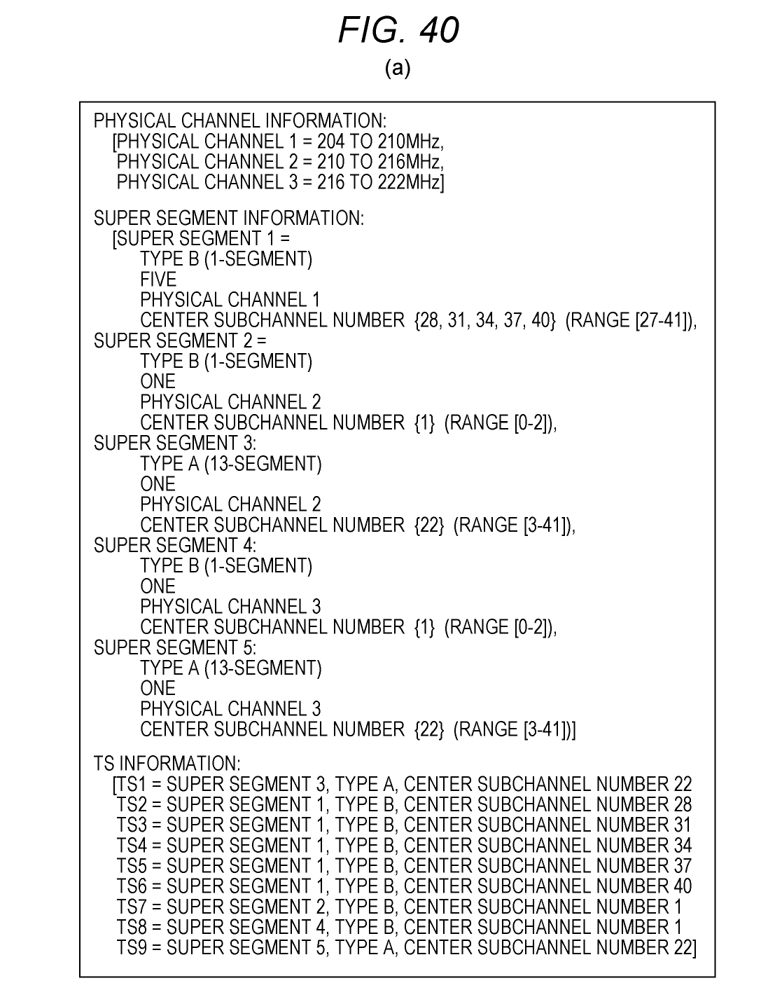

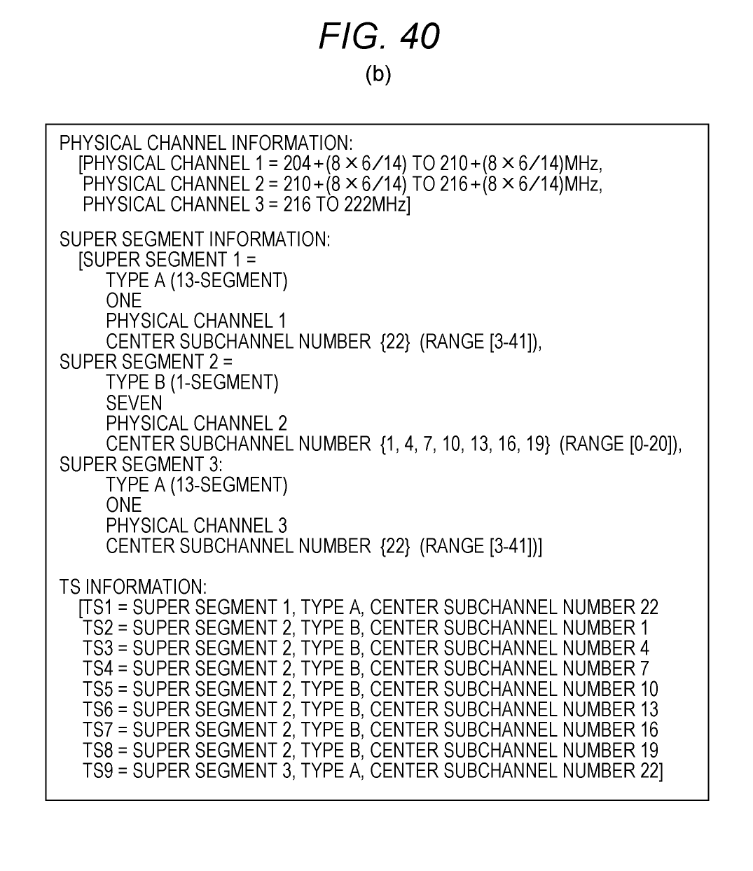

FIG. 40(a) illustrates the physical channel information, the super segment information, and the TS information of FIG. 38(a) and FIG. 40(b) illustrates the physical channel information, the super segment information, and the TS information of FIG. 38(b).

When the frequency arrangement of the pilot segment to be the pilot broadcast of FIGS. 38(a) and 38(b) and the pilot information transmitted by the pilot broadcast of FIG. 39 are configured, the frequency arrangement of the pilot segment is the same in FIGS. 38(a) and 38(b). Therefore, the channel of the pilot segment of the determined frequency arrangement is first selected and the pilot segment is demodulated, there is an effect that the super segment configuration can be recognized by the pilot information of FIG. 39. For this reason, the change can be made from the super segment configuration of FIG. 38(a) suitable for the case in which the process is performed in the super segment unit to the super segment configuration of FIG. 38(b) suitable for the case in which the process is performed in the TS unit or from the super segment configuration of FIG. 38(b) suitable for the case in which the process is performed in the TS unit to the super segment configuration of FIG. 38(a) suitable for the case in which the process is performed in the super segment unit, at all times.

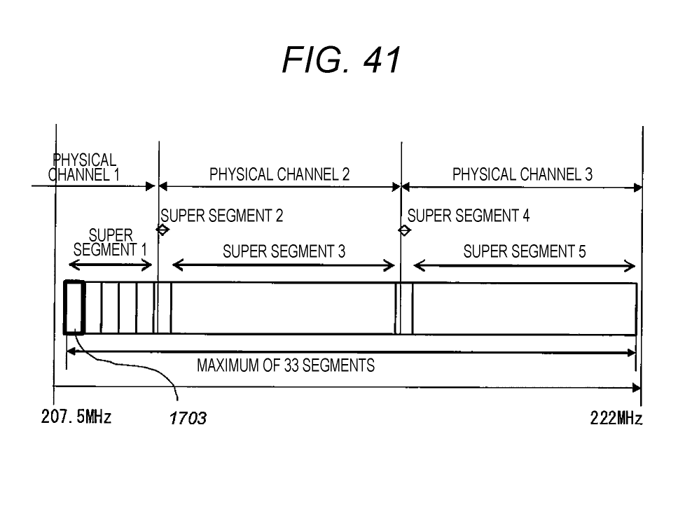

FIG. 41 is a diagram illustrating another example of a segment configuration of a digital broadcast transmission signal transmitted by a digital broadcast transmitting device according to a ninth embodiment of the present invention.

FIG. 41 is obtained by applying the segment configuration example described in FIG. 4(a) to this embodiment. In FIG. 41, 1703 denotes a pilot segment.

The pilot segment is a segment to transmit the pilot broadcast and in this example, the pilot segment is set as a segment of the 1-segment format. In the example of FIG. 41, the pilot segment is a segment of “super segment 1 and center subchannel number 1”.

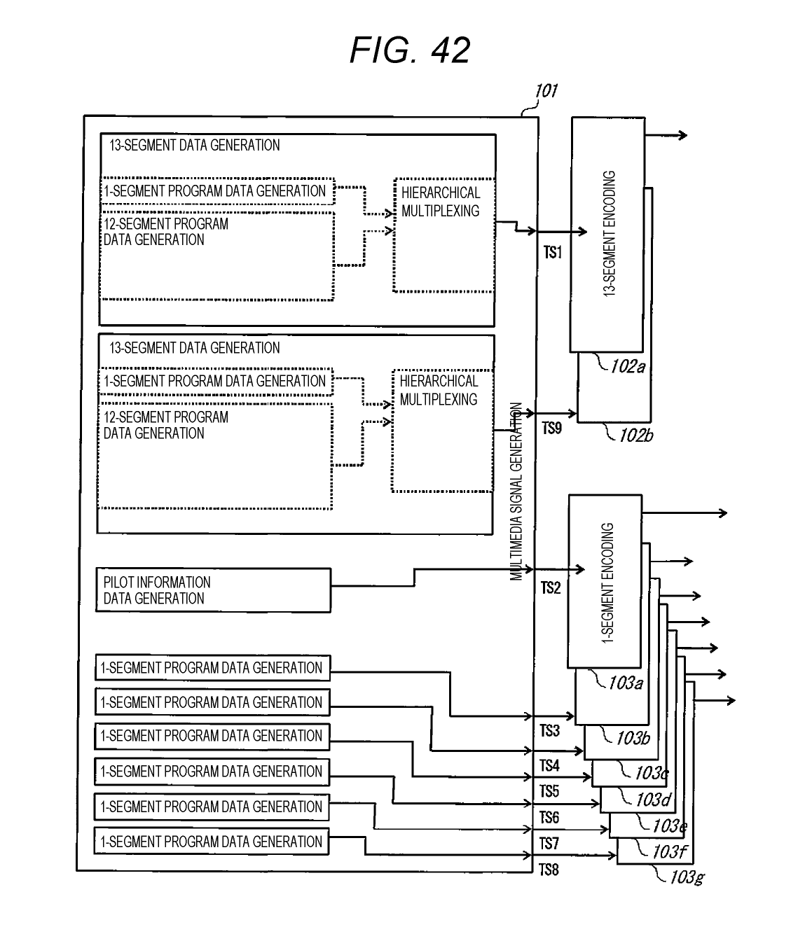

FIG. 42 illustrates a situation where data for each 13-segment and data for the 1-segment are stored as an internal process of a multimedia signal generator 101 with respect to the super segment configuration illustrated in FIG. 41 and a situation where 12-segment data and 1-segment data are hierarchically multiplexed with respect to the data for the 13-segment.

In the process configuration, the data for the 13-segment, the data for the 1-segment, or the data for the pilot segment is stored with respect to each super segment illustrated in FIG. 41.

By a multiplex structure, in each super segment, information for transmission services in the super segment is collected. With respect to a collection of information for transmission services at a plurality of super segments, information corresponding to pilot information can be stored in the pilot segment. As a process after selecting and specifying the super segment, a process framework for the conventional digital broadcast can be used.

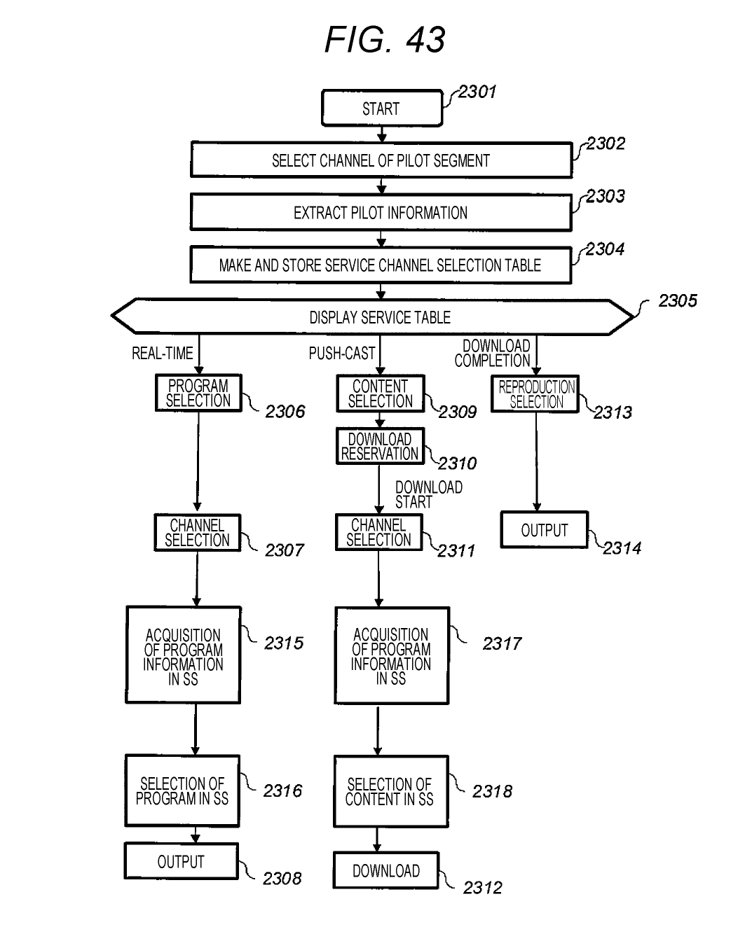

Next, an example of a reception operation of the pilot broadcast, the pilot segment, and the pilot information of FIGS. 16, 41, and 18(a) to 18(c) will be described using FIG. 43.

This example is an example of the case in which, after channel selection is switched to a super segment which a program or content selected as a reception target belongs to, program information in the super segment is retook, and uniqueness of a desired process is secured.

In step 2301, a reception operation starts.

In step 2302, first, a channel of the pilot segment 1703 at the determined frequency position is selected.

In step 2303, the TS is demodulated, the pilot information of FIGS. 18(a) to 18(c) is extracted, and the pilot information is decoded.

In step 2304, a service channel selection table (an entire scheduled program information list) is made from the extracted pilot information and the service channel selection table is stored.

In step 2305, service tables of the real-time broadcast, the push-cast (file-cast) broadcast, and the download completion are displayed.

In the case of the real-time broadcast, in step 2306, a program which a user desires to view is selected.

In step 2307, a channel of the selected program is selected. The channel selecting unit 1902 sets the channel selection frequency by the service channel selection table of FIG. 24. When the program is transmitted by reception other than the partial reception in the type A, the channel frequency band is set as the 13-segment band and the 13-segment format demodulation is performed. When the program is transmitted by the partial reception in the type A and when the super segment type is the type B, the channel frequency band is set as the 1-segment band. In the case of the partial reception, the partial reception demodulation is performed and in the case of the type B, the 1-segment format demodulation is performed.

In step 2315, transmitting program information (and following transmission scheduled program information) in a super segment (SS) through which the real-time broadcast is transmitted is acquired. The transmitting program information is detailed information such as program content or performers in a program viewed at the present time and the following transmission scheduled program information is detailed information such as program content or performers for a program scheduled for broadcast after the program viewed at the present time ends.

In step 2316, a selection process of a reception target program in the super segment (SS) is performed.

In step 2308, the program is output.

In the case of the push-cast (file-cast) broadcast, in step 2309, content which the user desires to download is selected. At this time, download completed content is displayed as “download completion”, such that the download completed content cannot be selected.

In step 2310, download reservation is performed. At a download time, in step 2311, the channel selecting unit 1902 sets the content reserved by the service channel selection table of FIG. 24 as the channel selection frequency. When the content is transmitted by reception other than the partial reception in the type A, the channel frequency band is set as the 13-segment band and the 13-segment format demodulation is performed. When the content is transmitted by the partial reception in the type A and when the super segment type is the type B, the channel frequency band is set as the 1-segment band. In the case of the partial reception, the partial reception demodulation is performed and in the case of the type B, the 1-segment format demodulation is performed.

In step 2317, transmitting program information (and following transmission scheduled program information) in a super segment (SS) through which the push-cast (file-cast) broadcast is transmitted is acquired.

In step 2318, a selection process of download acquisition target content in the super segment (SS) is performed.

In step 2312, the content is downloaded.

In the case of the download completion, in step 2313, reproduction is selected and in step 2314, the content is output.

According to the digital broadcast reception method of FIG. 43, even when the entire scheduled program information and the transmitting program information (and the following transmission scheduled program information) are arranged in the different super segments for the segment configuration of the digital broadcast transmission signal and are transmitted, there is an effect that the program information can be surely received without considering the segment configuration of the digital broadcast transmission signal.

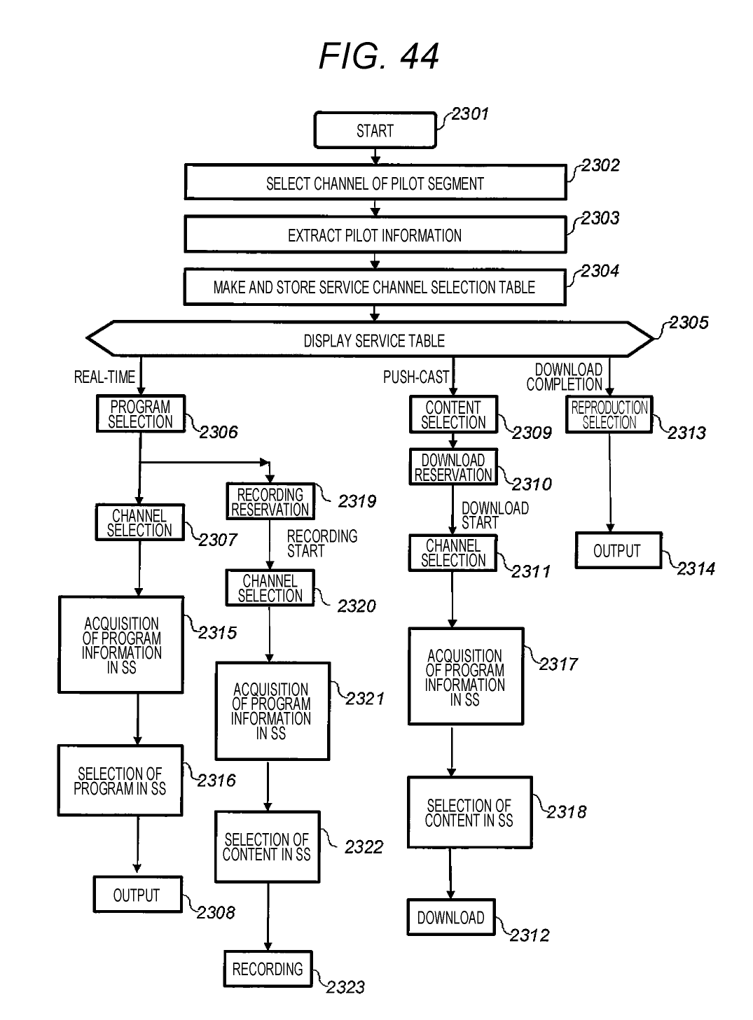

FIG. 44 illustrates an example of the case in which an operation when reservation recording of the real-time broadcast is performed is added to the example of FIG. 43 and a recording reservation process of step 2319 and the following process are added. In the case of the reservation recording, similar to the download reservation, a program to be acquired is previously designated and an actual recording operation starts at a time of the designated program.

In step 2306, a program about which the user desires to perform the reservation recording is selected.

At this time, a recording completed program is displayed as “recording completion”, such that the recording completed program cannot be selected.

In step 2319, the recording reservation is registered.

At a recording start time, in step 2320, the channel selecting unit 1902 sets the content reserved by the service channel selection table of FIG. 24 as the channel selection frequency. When the program is transmitted by reception other than the partial reception in the type A, the channel frequency band is set as the 13-segment band and the 13-segment format demodulation is performed. When the program is transmitted by the partial reception in the type A and when the super segment type is the type B, the channel frequency band is set as the 1-segment band. In the case of the partial reception, the partial reception demodulation is performed and in the case of the type B, the 1-segment format demodulation is performed.

In step 2321, transmitting program information (and following transmission scheduled program information) in a super segment (SS) through which the real-time broadcast is transmitted is acquired.

In step 2322, a selection process of a recording target program in the super segment (SS) is performed.

In step 2323, a recording process is executed.

According to the digital broadcast reception and the reservation recording method of FIG. 44, even when the entire scheduled program information and the transmitting program information (and the following transmission scheduled program information) are arranged in the different super segments for the segment configuration of the digital broadcast transmission signal and are transmitted, there is an effect that the recording reservation can be surely performed without considering the segment configuration of the digital broadcast transmission signal.

### Tenth Embodiment

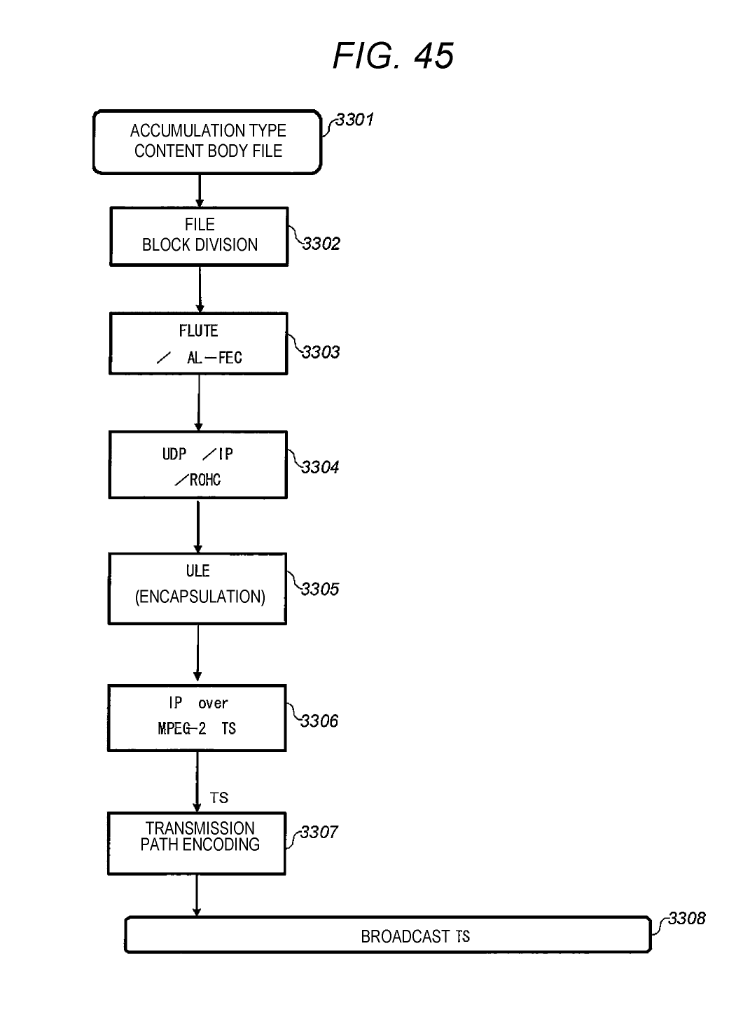

FIG. 45 illustrates a process flow when an accumulation type content file in a digital broadcast transmission signal transmitted by a digital broadcast transmitting device according to a tenth embodiment of the present invention is transmitted. The accumulation type content file is a file distributed by push-cast (file-cast) broadcast and can be reproduced at any timing after reception.

An accumulation type content body file 3301 is divided in a unit of a block size prescribed by the predetermined FLUTE and AL-FEC in file block division step 3302 and is subjected to FLUTE packetization and addition of an error correcting code in FLUTE/AL-FEC process step 3303. In addition, after packetization of UDP/IP and header compression are performed in UDP/IP/ROHC process step 3304, encapsulation is performed in ULE encapsulation process 3305, and embedding in an MPEG-2 TS payload is performed in IP_Over_MPEG-2_TS process 3306. In transmission path encoding step 3307, TS packet multiplexing is performed and broadcast TS 3308 is generated. The broadcast TS 3308 is transmitted as broadcast wave data.

### Eleventh Embodiment

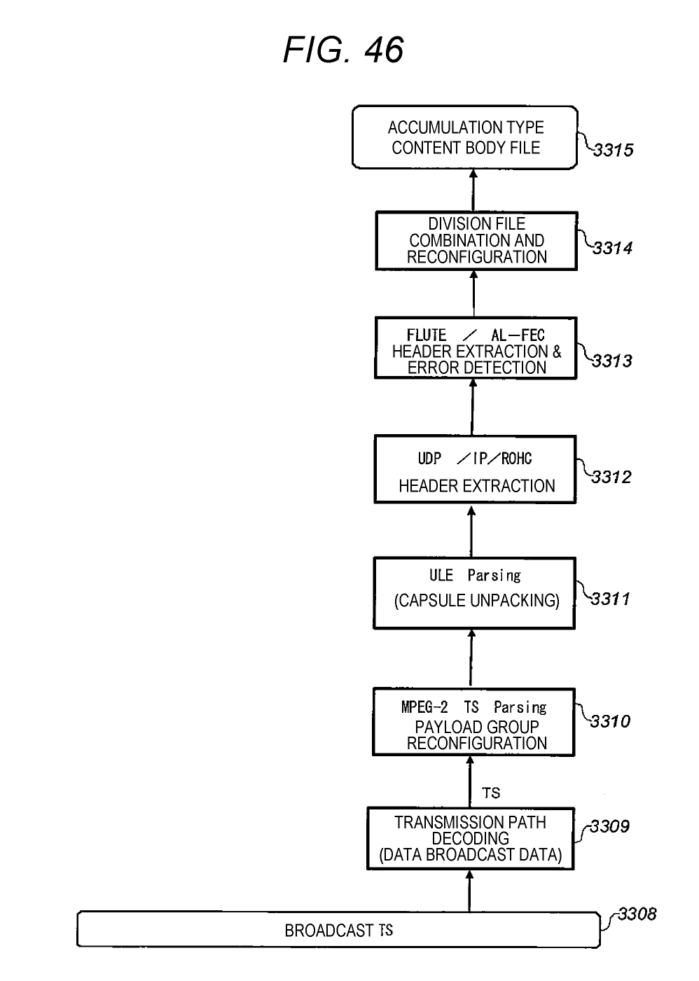

FIG. 46 illustrates a process flow when an accumulation type content file in a digital broadcast transmission signal received by a digital broadcast receiving device according to an eleventh embodiment of the present invention is received.

After the broadcast TS 3308 is received, in transmission path decoding step 3309, a hierarchical separation and a demodulation process are performed and in MPEG-2 TS parsing & payload group reconfiguration 3310, a desired MPEG-2_TS packet designated by a PID is selected/extracted and a header portion and a payload portion are separated.

In ULE capsule unpacking step 3311, a ULE capsule of an MPEG-2_TS payload portion is developed, in UDP/IP/ROHC payload extraction step 3312, a compression header is extended and a packet is developed, in FLUTE/AL-FEC payload extraction/error detection step 3313, error detection, if possible, an error correcting process is performed and a FLUTE session is restored, and in division file combining/reconfiguring step 3314, file content is reconfigured and an accumulation type content body file group 3315 is acquired.

In addition, electronic program guide (EPG) metadata enabling presentation and selection of program information such as a program table with respect to a real-time type broadcast service or electronic contents guide (ECG) metadata enabling presentation and selection of content information with respect to an accumulation type service is also included in the digital broadcast transmission signal and the metadata is also transmitted as accumulation type broadcast content.

### Twelfth Embodiment

In this embodiment, an example of the case in which an accumulation reservation of content of an accumulation type service is automatically performed using searching facial data designated by a user from video will be described. For example, assuming an information association, character facial data corresponding to the ECG metadata is transmitted from the transmission side and at the reception side, the character facial data is acquired from the metadata corresponding to the accumulation type content carried on a broadcast wave. At the reception side, searching facial data is separately generated in advance and an accumulation reservation of content is performed using both the character facial data and the searching facial data. In addition, when the character facial data is added as metadata of a content body, accumulation completed content is searched using the searching facial data.

The searching facial data in the following embodiments is information used for searching the content and is information to specify a face of a person designated by the user. In addition, the character facial data in this embodiment is information to specify a face of a person appearing in the content.

When the searching facial data is generated, first, in the digital broadcast receiving device of FIG. 19, a moving image is temporarily stopped during reproduction of the accumulated content and persons drawn (displayed) on a screen are selected.

The person selection may be performed with respect to persons drawn on a still image and persons drawn on a screen in an Internet connection state, in addition to the persons drawn on the screen in which the moving image is temporarily stopped. At this time, a part of the screen in which the person is drawn may be selected and a region of a person may be determined by an image analysis or a rectangular range in which a person is drawn may be selected and a region of a person may be determined by deleting a background region. In addition, the video output unit of the digital broadcast receiving device of FIG. 19 may be composed of a touch panel and the region selection of the screen may be performed by an operation of the touch panel or the region selection may be performed by an operation of a remote controller. In addition, the image analysis may be performed with respect to the still image and regions of all persons drawn on the screen may be determined.

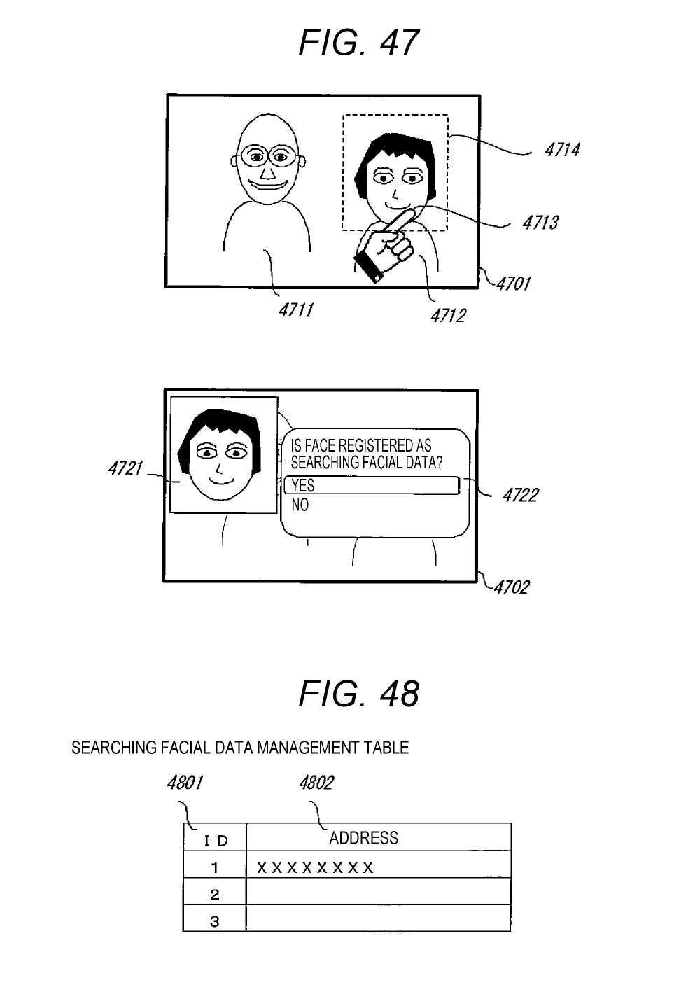

FIG. 47 illustrates a screen display example of the case in which any coordinates in the screen are designated using the touch panel and regions of persons are extracted.

In an image 4701, two persons (a person 4711 and a person 4712) are drawn. When the user selects any point 4713, a region 4714 of a face of a person is extracted by an image process.

Then, the extracted region 4714 of the face is drawn on a region 4721 and a confirmation pop-up menu 4722 on whether or not to register the face in the searching facial data is displayed. When “YES” is selected, image data of the extracted region 4721 of the face is generated and the image data is stored as the searching facial data in the recording medium 1931 of the digital broadcast receiving device of FIG. 19. In addition, feature points of face organs such as eyes, a nose, and a mouth are found as the searching facial data and color strength and directionality of the corresponding portions are stored as feature points.

When different searching facial data is registered after the searching facial data is temporarily registered, the previously stored data is deleted and overwriting is performed. Or, after display of the pop-up menu on whether the data may be overwritten and confirmation of the user, overwriting may be performed. In addition, a plurality of searching facial data may be registered. When the plurality of searching facial data can be registered, new searching facial data can be registered without deleting the previously stored data. In addition, an upper limit of the number of searching facial data to be registered may be set as a predetermined number (16 or the like). In addition, a function of reducing the registered searching facial data and displaying a list on the screen, a function of selecting whether or not to use the data for a search process with the character facial data to be described below, or a function of deleting each searching facial data may be provided.

FIG. 48 illustrates a configuration example of a searching facial data management table stored in a non-volatile memory 1916 of the digital broadcast receiving device of FIG. 19.

The searching facial data management table includes an ID 4801 indicating the searching facial data uniquely and an address 4802 of a storage destination of the generated searching facial data.

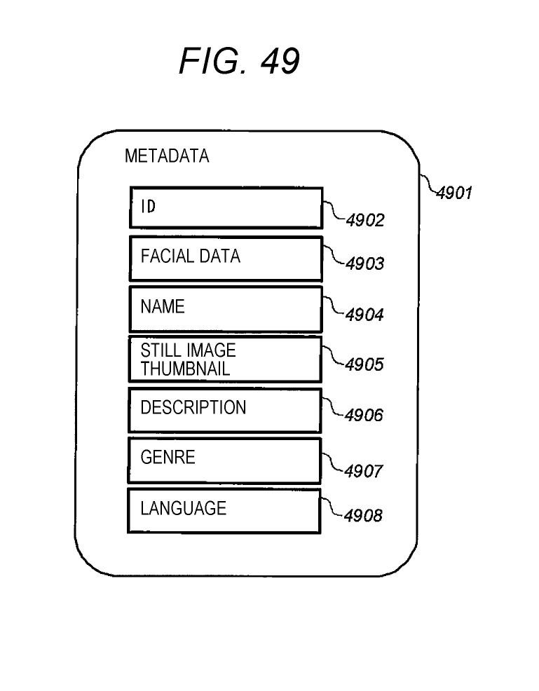

FIG. 49 illustrates an example of components of the EPG metadata and the ECG metadata included in the digital broadcast transmission signal.

The metadata includes an ID 4902 indicating a program or content uniquely, character facial data 4903 of a person appearing in the content, a name 4904 of the program or the content, a still image thumbnail 4905, a description 4906 of the program or the content, a genre 4907, and a language 4908. In the case of the EPG metadata, a broadcast date and time is also included. In the case of the ECG metadata, a moving image preview and a broadcast period are also included. The metadata 4901 is not limited thereto and other information may be included in the metadata.

The character facial data 4903 is still image data from which the face of the character of the content can be known. The character facial data may be one piece of still image data for each character and a plurality of characters may be included in one piece of still image data.

In addition, when the character facial data is distributed already by the EPG metadata or the ECG metadata to decrease a capacity of the metadata, the distribution of the character facial data by the following metadata may not be performed with respect to the same character. In this case, when the character facial data is distributed, an ID indicating character facial data uniquely and a flag referring to the character facial data in the following metadata, which are not illustrated in the drawings, are distributed. Then, a part of character facial data 4903 of new metadata may be described as an ID showing the character facial data uniquely or an ID indicating the previously distributed program or content uniquely.

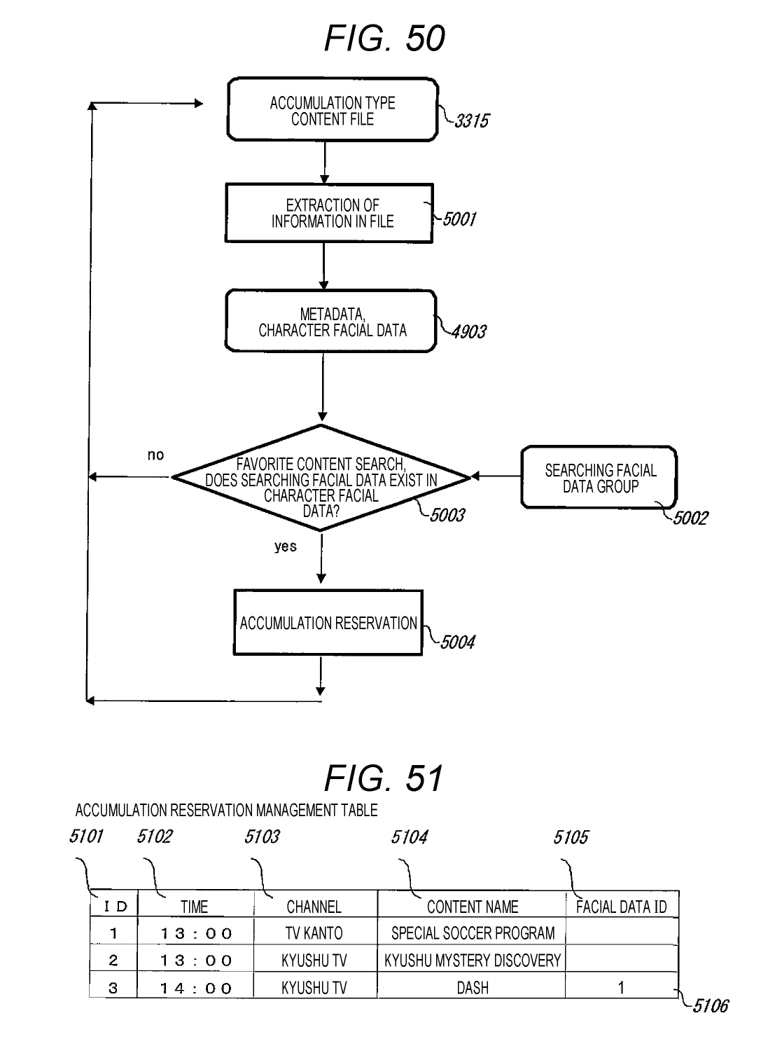

FIG. 50 illustrates a process flow of the case in which the character facial data 4903 corresponding to the metadata is extracted from the accumulation type content file 3315 illustrated in FIG. 46 and an accumulation reservation of content of an accumulation type service is automatically performed using the searching facial data designated by the user.

The character facial data 4903 corresponding to the metadata is extracted from the acquired accumulation type content file 3315 illustrated in FIG. 46 by intra-file information extraction step 5001 and the character facial data is supplied to favorite content searching step 5003. Here, when the metadata is obtained and the flag referring to the previously distributed character facial data is determined, the extracted character facial data and the ID showing the character facial data uniquely are stored in the non-volatile memory 1916. In addition, the address 4802 of the storage destination in the searching facial data management table of FIG. 48 is read, the searching facial data stored in the recording medium 1931 of the digital broadcast receiving device of FIG. 19 is read, the searching facial data group 5002 is generated, and these are input to favorite content searching step 5003.

In favorite content searching step 5003, it is searched whether the searching facial data included in the searching facial data group 5002 is in the character facial data 4903, that is, the face of the searching facial data and the face of the character facial data are matched. When the plurality of searching facial data designated by the user is registered, all of the searching facial data are searched.

When it is searched whether the searching facial data is in the character facial data, first, the face of the character is detected from the character facial data. In addition, with respect to the detected face of each person, the color strength and the directionality of the corresponding portions are extracted as feature points from the features of the face organs. By comparing the feature point of the face of the character and the feature point of the face of the searching facial data, it is searched whether the searching facial data is in the character facial data.

In addition, in step 5004, when the searching facial data exists in the character facial data, an accumulation reservation of the content in which the person appears is performed. When the searching facial data does not exist in the character facial data or after the accumulation reservation is performed, a process is performed again from step 3315 to search metadata of different content. In the metadata of the different content, when the ID showing the previously distributed character facial data uniquely is detected in the character facial data, the character facial data that is stored in the non-volatile memory 1916 and is previously extracted is used.

As such, the searching facial data is registered in advance, so that the content in which the person appears is selected and the automatic accumulation reservation can be performed, and the content which the user desires to view can be automatically obtained.

FIG. 51 illustrates a configuration example of an accumulation reservation management table stored in the non-volatile memory 1916 of the digital broadcast receiving device of FIG. 19. The accumulation reservation management table includes an ID 5101 indicating reservation data uniquely, a distribution time 5102, a channel 5103, a content name 5104, and a management ID 5105 of searched facial data or the like. Here, an example of the case in which an accumulation reservation is performed with respect to three contents is illustrated. For example, because content (ID 3) reserved in step 5004 of FIG. 50 is already subjected to the search process, a management ID 5106 of the searched facial data is registered.

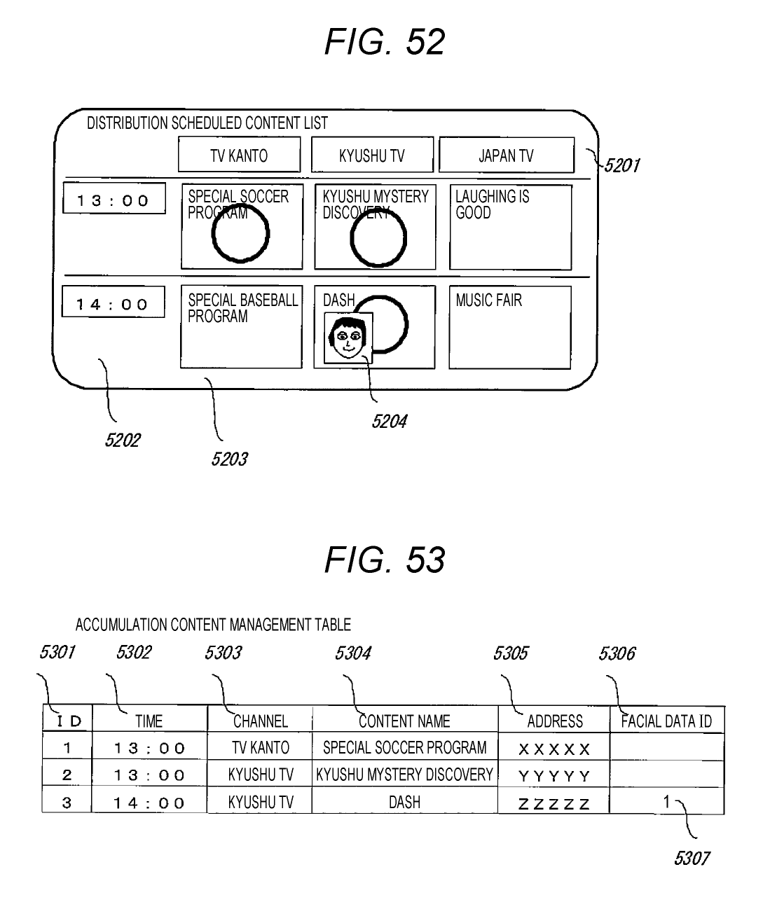

An example of the case in which a distribution scheduled content list is displayed will be described using FIG. 52. This is a display example of a distribution scheduled content list of the case in which an accumulation reservation of content is performed using searching facial data.

The accumulation reservation management table of FIG. 51 is read and a television station 5201 is displayed on an upper portion of a screen, a time zone 5202 is displayed on a left side of the screen, and a content name 5203 is displayed on a right side of the screen. A circle mark is displayed in reservation completed content and searching facial data 5204 used for the search is drawn in content (content reserved in 5004 of FIG. 50) in which the facial data ID 5106 of the accumulation reservation management table of FIG. 51 exists. Because the searching facial data used for the search is drawn, the user can know a reservation situation of the content in which the person registered by the user appears.

FIG. 53 illustrates a configuration example of an accumulation content management table stored in the non-volatile memory 1916 of the digital broadcast receiving device of FIG. 19, after the content is accumulated. The accumulated content is stored in the recording medium 1931 of the digital broadcast receiving device of FIG. 19. The accumulation content management table includes such as an ID 5301 indicating accumulation content uniquely, a distribution time 5302, a channel 5303, a content name 5304, an address 5305 of a storage destination of the accumulated content, and a management ID 5306 of searched facial data. For example, in the content (ID 3) that is reserved in step 5004 of FIG. 50 and is actually accumulated, a management ID 5307 of the searched facial data is registered.

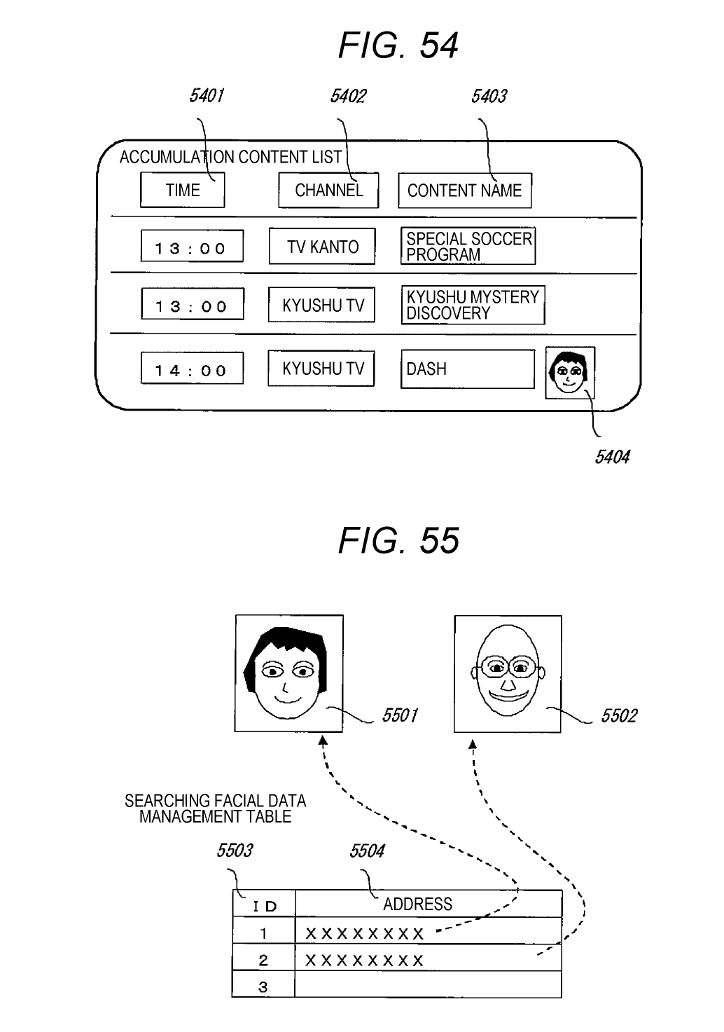

An example of the case in which an accumulation content list is displayed will be described using FIG. 54. This is a display example of an accumulation content list after the content is accumulated using the searching facial data.

The accumulation content management table of FIG. 53 is read and a time 5401, a channel 5402, and a content name 5403 are displayed from a left side of a screen. Searching facial data 5404 used for the search is drawn in content 5307 (content that is reserved in 5004 of FIG. 50 and is actually accumulated) in which the facial data ID of the accumulation content management table of FIG. 53 exists. Because the searching facial data used for the search is drawn, the user can know a reservation situation of the content in which the person registered by the user appears.

According to this embodiment described above, the automatic accumulation reservation of the content in which the person designated by the user appears is enabled by the character facial data as the metadata transmitted and provided from the transmission side and the searching facial data designated by the user in advance and the content which the user desires to view can be obtained. In addition, an accumulation reservation situation of the content in which the person registered by the user appears can be known by the list display. In addition, the content in which the person registered by the user appears can be easily found from the plurality of accumulation contents. In addition, because the character facial data and the searching facial data can be extracted from the different contents, the user can make the automatic accumulation reservation of the content transmitted and provided therefrom, by referring to the previously accumulated content.

### Thirteenth Embodiment

In this embodiment, an example of the case in which desired content is searched from the previously accumulated contents using the searching facial data designated by the user and the content is displayed will be described.

First, as described in FIG. 47 corresponding to the twelfth embodiment, the searching facial data is registered. FIG. 55 illustrates an aspect of the case in which searching facial data of two persons is generated and is registered in a searching facial data management table. In the recording medium 1931 of the digital broadcast receiving device of FIG. 19, the searching facial data 5501 and the searching facial data 5502 are registered and in the address in the searching facial data management table, an address of a storage destination of each facial data is described.

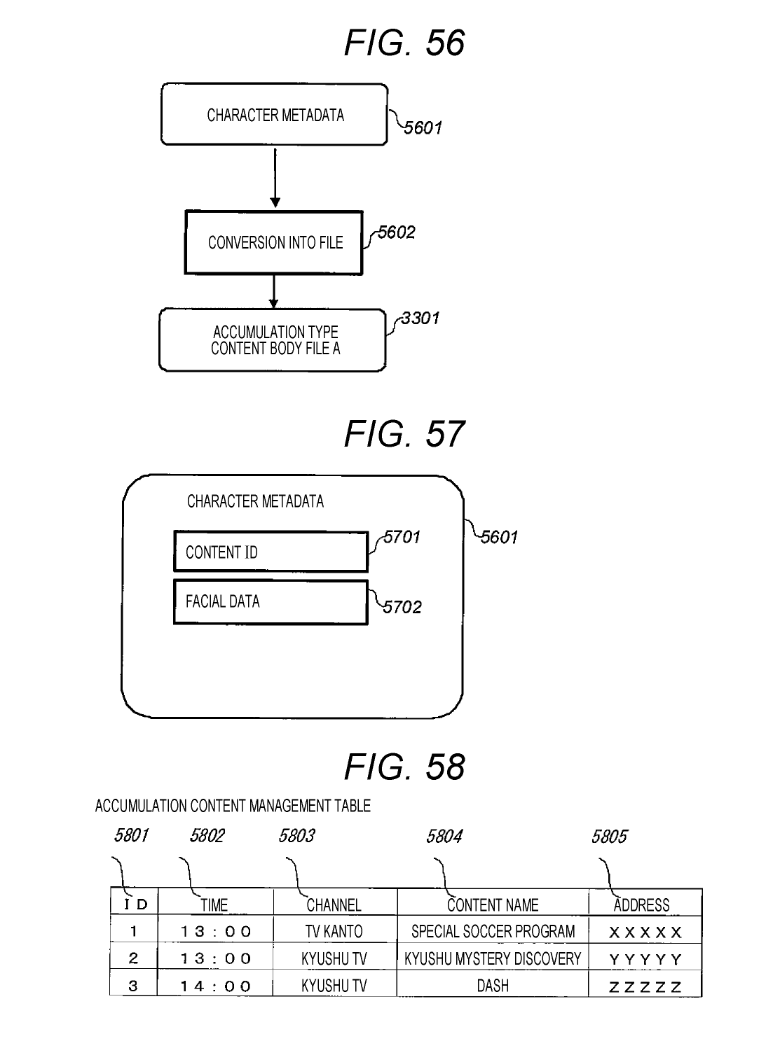

FIG. 56 illustrates a process flow until generating the accumulation type content file in the digital broadcast transmission signal transmitted by the digital broadcast transmitting device at the service provision side, which is illustrated in FIG. 45. In this example, a sequence until character metadata 5601 corresponding to the metadata is stored in a form of an accumulation type content file is illustrated.

FIG. 57 illustrates an example of components of the character metadata 5601. The character metadata 5601 includes a content ID 5701 indicating content uniquely and character facial data 5702 of a person appearing in the content. The character metadata 5601 is not limited thereto and a combination of other parameter values to specify the person appearing in the content is also assumed.

The character facial data 5702 is still image data from which the face of the character of the content can be known. The facial data 5702 may be one piece of still image data for each character and a plurality of characters may be included in one piece of still image data.

FIG. 58 illustrates a configuration example of an accumulation content management table stored in the non-volatile memory 1916 of the digital broadcast receiving device of FIG. 19, after content is accumulated. The accumulated content is stored in the recording medium 1931 of the digital broadcast receiving device of FIG. 19. The accumulation content management table includes such as an ID 5801 indicating accumulation content uniquely, a distribution time 5802, a channel 5803, a content name 5804, and an address 5805 of a storage destination of the accumulated content.

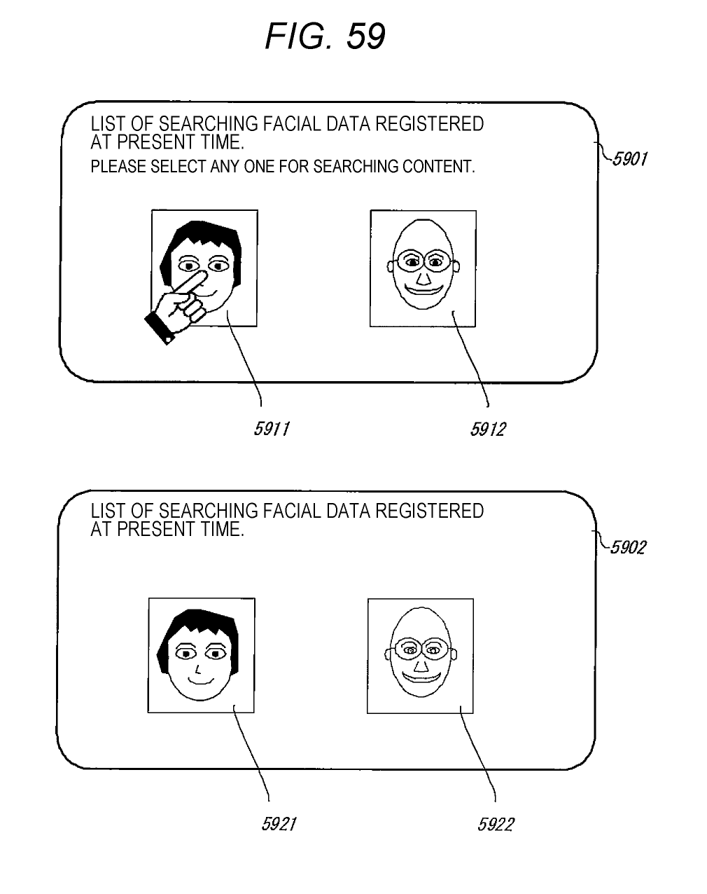

FIG. 59 illustrates a display example when registered searching facial data is selected by the user. By an operation of the user, the searching facial data management table of FIG. 55 is read and an address 5504 on a memory is read. In addition, the searching facial data stored in the recording medium 1931 of the digital broadcast receiving device of FIG. 19 is read and a list 5901 of the searching facial data is drawn. The list 5901 of the searching facial data is an example of the case in which faces of two persons are drawn. The user selects any image and the searching facial data is selected (screen 5902). Here, a display example of the case in which the searching facial data 5921 is selected is illustrated.

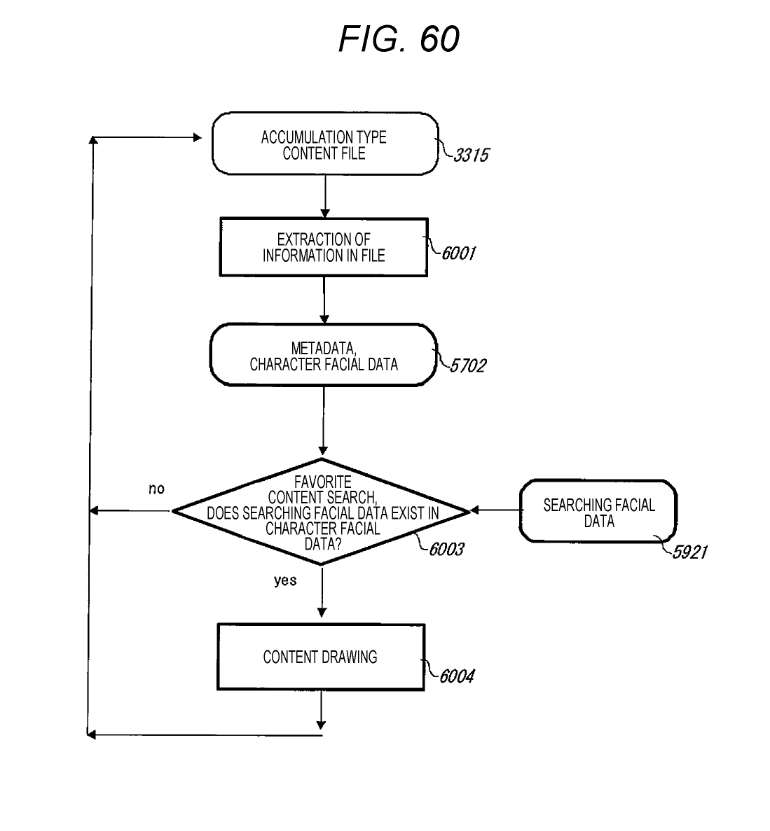

FIG. 60 illustrates an example of a process flow of the case in which the character facial data 5702 corresponding to the metadata is extracted from the accumulation type content file 3315 illustrated in FIG. 46 and specific content is extracted from accumulation completed content using the searching facial data 5921 designated by the user.

The character facial data 5702 corresponding to the metadata is extracted from the acquired accumulation type content file 3315 illustrated in FIG. 46 by intra-file information extraction step 6001 and the character facial data is supplied to favorite content searching step 6003. In addition, the searching facial data 5921 selected in FIG. 60 is input to the favorite content searching step 6003.

In favorite content searching step 6003, it is searched whether the searching facial data 5921 is in the character facial data 5702, that is, the face of the searching facial data 5921 and the face of the character facial data 5702 are matched. When the searching facial data 5921 exists in the character facial data 5702, content thereof is drawn in step 6004. Then, because other accumulation content is searched, a process is performed again from step 3315.

According to this embodiment described above, the user can easily select the content in which the person designated by the user appears, from the plurality of accumulation contents, and can view the content.

The character facial data in the twelfth and thirteenth embodiments may be still image data such as JPEG in which the face of the person appearing in the content is imaged or may be feature data of the face showing color strength and directionality of face organs such as eyes, a nose, and a mouth. When the character facial data is set as the feature data of the face, the searching facial data is also set as the feature data of the face.

In addition, in the twelfth and thirteenth embodiments, the accumulation reservation of the content of the accumulation type service or the content search has been described. However, these embodiments may be applied to not only the accumulation reservation of the content of the accumulation type service or the content search but also the reservation recording of the program of the real-time broadcast service or the search of the recorded program. In this case, the accumulation reservation management table of FIG. 51 becomes a reservation program management table, the distribution scheduled content list of FIG. 52 becomes a program table, the accumulation content management table of FIGS. 53 and 58 becomes a recording program management table, and the accumulation content list of FIG. 54 becomes a recording program list.

The present invention is not limited to the embodiments described above and various modifications are included in the present invention. For example, the embodiments are described in detail to facilitate the description of the present invention and are not limited to embodiments in which all of the described configurations are included. In addition, a part of the configurations of the certain embodiment can be replaced by the configurations of another embodiment or the configurations of another embodiment can be added to the configurations of the certain embodiment. In addition, for a part of the configurations of the individual embodiments, other configurations can be added, deleted, and replaced.

In addition, a part or all of the individual configurations, functions, processing units, and processing mechanisms may be designed by integrated circuits and may be realized by hardware. In addition, the individual configurations and functions may be realized by software by analyzing programs for realizing the functions by a processor and executing the programs by the processor. Information such as the programs for realizing the individual functions, the tables, and the files may be stored in a recording device such as a memory, a hard disk, and a solid state drive (SSD) or a recording medium such as an IC card, an SD card, and a DVD.

In addition, only control lines or information lines that are necessary for explanation are illustrated and do not mean all control lines or information lines necessary for a product. In actuality, almost all configurations may be connected to each other.

### REFERENCE SIGNS LIST

101 content transmitting device
102 lack complementary data transmitting device
103 license managing device
104 payment system/customer managing system
105 removable media
106 receiving device
107 accumulating device
108 metadata transmitting device
201 multimedia signal generating unit
202 13-segment format encoding unit
203 3-segment format encoding unit
204 connection frame configuring unit
205 reconnection frame configuring unit
206 inverse fast Fourier transform (IFFT)/guard interval adding unit
207 up-converter unit
208 transmission amplifier unit
209 antenna
211 RS (Reed-Solomon) encoding unit
212 modulating/encoding unit
213 interleave unit
214 frame configuring unit
215 hierarchical division unit
216 hierarchical synthesis unit
221 RS (Reed-Solomon) encoding unit
222 modulating/encoding unit
223 interleave unit
224 frame configuring unit
301 content/metadata registration function
302 metadata generation function
303 metadata accumulation function
304 content accumulation/reproduction function
305 content encryption function
306 recording medium
307 multimedia signal generating unit
601 input
602 energy diffusing unit
603 delay correcting unit
604 byte interleave unit
605 convolution encoding unit
606 carrier modulating unit
607 bit interleave unit
608 mapping unit
609 output
701 input
702 pilot signal configuring unit
703 TMCC (Transmission and Multiplexing Configuration Control) signal configuring unit
704 AC (auxiliary channel) signal configuring unit
705 OFDM frame configuring unit
706 output
1901 antenna
1902 channel selecting unit
1903 orthogonal demodulation unit
1904 fast Fourier transform (FFT) unit
1905 demodulating/decoding unit
1906 synchronous reproduction unit
1907 frame extracting unit
1908 TMCC decoding unit
1909 DEMUX unit
1910 decoding unit of compressed broadcast audio signal
1911 audio output unit
1912 decoding unit of compressed broadcast video signal
1913 presentation processing unit
1914 video output unit
1915 system decoding unit
1916 rewritable non-volatile memory (NVRAM)
1917 ROM (Read Only Memory)
1918 RAM (Random Access Memory)
1919 communication line interface (I/F)
1920 input/output unit (I/O)
1921 system bus
1922 central processing unit (CPU)
1923 remote controller
1924 front/end (F/E) unit
1925 back/end (B/E) unit
1926 digital broadcast receiving device
1927 removable media
1928 descramble 1 unit
1929 descramble 2 unit
1930 CAS (Conditional Access System)
1931 recording medium
2101 input
2102 carrier demodulating unit
2103 deinterleave unit
2104 demapping unit
2105 bit deinterleave unit
2106 depuncture unit
2107 Viterbi decoding unit
2108 byte deinterleave unit
2109 energy back-diffusion unit
2110 TS reproducing unit
2111 RS (Reed-Solomon) decoding unit
2112 output
2121 hierarchical division unit
2122 hierarchical synthesis unit
2201 input
2202 carrier demodulating unit
2203 deinterleave unit
2204 demapping unit
2205 bit deinterleave unit
2206 depuncture unit
2207 Viterbi decoding unit
2208 byte deinterleave unit
2209 energy back-diffusion unit
2210 TS reproducing unit
2211 RS (Reed-Solomon) decoding unit
2212 output

1. A content receiving device for receiving broadcast waves, comprising:
a receiving unit which receives the broadcast waves;
an input unit which inputs a user input;
a recording unit which records content included in the broadcast waves on a recording medium; and
a control unit,
wherein character facial data to be information enabling identification of faces of characters of the content is included in the broadcast waves, and
the control unit generates searching facial data to be information enabling identification of faces of persons, on the basis of information input to the input unit, and controls recording of the content on the recording medium, on the basis of the searching facial data and the character facial data.

2. The content receiving device according to claim 1, wherein the control unit extracts at least feature data showing features for parts of the faces of the persons from the searching facial data and the character facial data and performs control to select the content recorded on the recording medium, on the basis of the feature data extracted from the searching facial data and the feature data extracted from the character facial data.

3. The content receiving device according to claim 1, further comprising:
an output unit which outputs the recorded content,
wherein the control unit performs control to select the content output from the output unit, on the basis of the searching facial data and the character facial data, when a plurality of contents is recorded on the recording medium.

4. The content receiving device according to claim 1, wherein the character facial data and the searching facial data are still image data enabling recognition of the faces of the persons.

5. A content receiving method in a content receiving device for receiving broadcast waves, comprising:
a reception step of receiving the broadcast waves;
an input step of inputting a user input; and
a recording step of recording content included in the broadcast waves on a recording medium,
wherein character facial data to be information enabling identification of faces of characters of the content is included in the broadcast waves, and
in the recording step, the content is recorded on the recording medium, on the basis of searching facial data to be information enabling identification of faces of persons, which is generated on the basis of information input in the input step, and the character facial data.

6. The content receiving method according to claim 5, further comprising:
an extraction step of extracting at least feature data showing features for parts of the faces of the persons from the searching facial data and the character facial data,
wherein, in the recording step, the content recorded on the recording medium is selected and recorded, on the basis of the feature data extracted from the searching facial data and the feature data extracted from the character facial data.

7. A digital broadcast transmitting and receiving system including a content transmitting device and a content receiving device,
wherein the content transmitting device includes a transmitting unit which transmits broadcast waves,
content and character facial data to be information enabling identification of faces of characters of the content are included in the broadcast waves,
the content receiving device includes a receiving unit which receives the broadcast waves, an input unit which inputs a user input, a recording unit which records the content included in the broadcast waves on a recording medium, and a control unit, and
the control unit generates searching facial data to be information enabling identification of faces of persons, on the basis of information input to the input unit, and controls recording of the content on the recording medium, on the basis of the searching facial data and the character facial data.

8. The digital broadcast transmitting and receiving system according to claim 7, wherein the control unit of the content receiving device extracts at least feature data showing features for parts of the faces of the persons from the searching facial data and the character facial data and performs control to select the content recorded on the recording medium, on the basis of the feature data extracted from the searching facial data and the feature data extracted from the character facial data.
